(19) United States
(12) Patent Application Publication
(10) Pub. No.: US 2025/0362692 A1
(43) Pub. Date: Nov. 27, 2025

(54) UNMANNED AIRCRAFT, MANAGEMENT SYSTEM, PACKAGE SYSTEM, MANAGEMENT METHOD, AND COMPUTER PROGRAM

(71) Applicant: Kubota Corporation, Osaka (JP)

(72) Inventor: Tadahisa MASUMOTO, Sakai-shi (JP)

(21) Appl. No.: 19/291,926

(22) Filed: Aug. 6, 2025

Related U.S. Application Data
(63) Continuation of application No. PCT/JP2023/004970, filed on Feb. 14, 2023.

(51) Int. Cl. G05D 1/698; A01D 90/16; B64U 10/14; B64U 101/64; G05D 105/15; G05D 107/20; G05D 109/25

(52) U.S. Cl. CPC G05D 1/6987; A01D 90/16; B64U 10/14; B64U 2101/64; B64U 2201/20; G05D 2105/15; G05D 2107/21; G05D 2109/254

(57) ABSTRACT

An unmanned aerial vehicle that transports harvested crops harvested from a field, includes a flight device to cause the unmanned aerial vehicle to fly, a controller configured or programmed to control operation of the flight device, a communication device to receive package position information indicating a first position where a target package for transport containing the harvested crops is located, and package weight information, and a support device to support the target package. The controller is configured or programmed to determine, based on the package weight information, whether the target package can be transported to a second position different from the first position, and when doing so, control the flight device to cause the unmanned aerial vehicle to fly to the first position, cause the support device to support the target package, and control the flight device to cause the unmanned aerial vehicle to fly to the second position.

### CROSS REFERENCE TO RELATED APPLICATIONS

This application is a Continuation Application of PCT Application No. PCT/JP2023/004970 filed on Feb. 14, 2023. The entire contents of this application are hereby incorporated herein by reference.

### BACKGROUND OF THE INVENTION

### 1. Field of the Invention

The present disclosure relates to unmanned aerial vehicles, management systems, package systems, management methods, and non-transitory computer-readable media including computer programs.

### 2. Description of the Related Art

An unmanned aerial vehicle (UAV) is an aircraft that cannot carry a person due to its structure and can fly by remote operation or automatic piloting. A rotary-wing type unmanned aerial vehicle is an unmanned aerial vehicle that obtains lift using propellers, i.e., rotary wings, that rotate around an axis. Small unmanned aerial vehicles including multiple rotary wings (Multi-Rotor UAV) are also called “drones,” “multi-rotors,” or “multicopters,” and are widely used for applications such as aerial photography, surveying, logistics, and agricultural chemical spraying. Japanese Patent Application Publication No. 2022-104737 describes an unmanned aerial vehicle (unmanned aircraft) that changes its flight position in conjunction with the operation of an agricultural machine.

### SUMMARY OF THE INVENTION

There is a demand for transporting harvested crops using unmanned aerial vehicles.

A harvest management system according to an example embodiment of the present disclosure is a harvest management system for acquiring harvested crops that a mobile agricultural machine has harvested from a field using an unmanned aerial vehicle, wherein an acquisition device usable to acquire the harvested crops is connected to the unmanned aerial vehicle and is movable together with the unmanned aerial vehicle, the harvest management system including the unmanned aerial vehicle that includes a receiving device to receive position information indicating a position of the agricultural machine in the field or a position where the agricultural machine is scheduled to discharge harvested crops, a flight device to cause the unmanned aerial vehicle to fly, and a controller configured or programmed to control operation of the flight device to cause the unmanned aerial vehicle to fly to a position where first harvested crops stored in the agricultural machine or second harvested crops discharged from the agricultural machine can be acquired, and the first harvested crops or the second harvested crops are acquired using the acquisition device connected to the unmanned aerial vehicle.

An unmanned aerial vehicle according to an example embodiment of the present disclosure is an unmanned aerial vehicle that transports harvested crops harvested from a field, including a flight device to cause the unmanned aerial vehicle to fly, a controller configured or programmed to control operation of the flight device, a communication device to receive package position information indicating a first position where a target package for transport containing the harvested crops is located, and package weight information indicating a weight of the target package, and a support device to support the target package, wherein the controller is configured or programmed to determine, based on the package weight information, whether the target package can be transported to a second position different from the first position, and when determining that the target package can be transported, control the flight device to cause the unmanned aerial vehicle to fly to the first position, cause the support device to support the target package, and control the flight device to cause the unmanned aerial vehicle to fly to the second position.

A management system according to an example embodiment of the present disclosure is a management system that manages transport operations of an unmanned aerial vehicle, including a communication device to receive package position information indicating a first position where a package containing harvested crops harvested in a field is located, and a controller configured or programmed to control operation of an unmanned aerial vehicle supporting a structure, wherein when causing the unmanned aerial vehicle to support the package, the controller is configured or programmed to separate the structure from the unmanned aerial vehicle.

According to an example embodiment of the present disclosure, an unmanned aerial vehicle acquires harvested crops that an agricultural machine has harvested. The unmanned aerial vehicle acquires harvested crops from the agricultural machine, for example, without landing on the ground. Also, for example, the unmanned aerial vehicle acquires harvested crops from a position above the agricultural machine. Since there is no need to secure a ground surface for running a transport vehicle in parallel with the agricultural machine, crop harvesting can be performed easily and efficiently.

According to an example embodiment of the present disclosure, an unmanned aerial vehicle capable of transporting a target package flies to a first position where the target package is located, supports and transports the target package, thus enabling efficient transport of harvested crops.

According to an example embodiment of the present disclosure, by causing an unmanned aerial vehicle that was performing operations to support a structure to transport a package, efficient transport of harvested crops can be achieved. By using an unmanned aerial vehicle from which the structure has been separated, the weight of packages that the unmanned aerial vehicle can transport can be increased.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a block diagram schematically showing some examples of rotary drivers that rotate rotors in an unmanned aerial vehicle including multiple rotors.

FIG. 1B is a plan view schematically showing one of the basic configuration examples of an unmanned aerial vehicle including multiple rotors.

FIG. 1C is a side view schematically showing one of the basic configuration examples of an unmanned aerial vehicle including multiple rotors.

FIG. 1D is a plan view schematically showing another basic configuration example of an unmanned aerial vehicle including multiple rotors.

FIG. 2A is a block diagram showing a basic configuration example of a battery-driven multicopter.

FIG. 2B is a block diagram showing a basic configuration example of a series hybrid-driven multicopter.

FIG. 2C is a block diagram showing a basic configuration example of a parallel hybrid-driven multicopter.

FIG. 3 is a diagram showing an example of a harvest management system.

FIG. 4 is a side view schematically showing an example of a harvester.

FIG. 5 is a block diagram showing a configuration example of a harvester.

FIG. 6 is a block diagram showing a configuration example of an unmanned aerial vehicle.

FIG. 7 is a block diagram showing a configuration example of a management device and a terminal device.

FIG. 8 is a diagram schematically showing an example of an unmanned aerial vehicle to which an acquisition device includes connected.

FIG. 9 is a diagram showing a field where a harvester harvests crops.

FIG. 10 is a flowchart showing an example of an operation for acquiring harvested crops that a harvester has harvested from a field using an unmanned aerial vehicle.

FIG. 11A is a diagram showing an example of an operation for acquiring harvested crops stored in a tank of a harvester using an unmanned aerial vehicle.

FIG. 11B is a diagram showing an example of an operation for acquiring harvested crops stored in a tank of a harvester using an unmanned aerial vehicle.

FIG. 11C is a diagram showing an example of an operation for acquiring harvested crops stored in a tank of a harvester using an unmanned aerial vehicle.

FIG. 12 is a diagram showing an unmanned aerial vehicle moving to a storage facility that stores harvested crops.

FIG. 13 is a diagram schematically showing another example of an unmanned aerial vehicle to which an acquisition device includes connected.

FIG. 14 is a diagram showing a vacuum hose extending from a suction machine placed in a field, and an unmanned aerial vehicle supporting the vacuum hose.

FIG. 15 is a diagram showing an unmanned aerial vehicle flying so that the end of a vacuum hose gripped by a gripper is positioned inside a tank of a harvester.

FIG. 16 is a diagram showing a discharge hose extending from a harvester, and an unmanned aerial vehicle supporting the discharge hose.

FIG. 17A is a diagram showing an example of an operation for acquiring harvested crops stored in a container of a harvester using an unmanned aerial vehicle.

FIG. 17B is a diagram showing an example of an operation for acquiring harvested crops stored in a container of a harvester using an unmanned aerial vehicle.

FIG. 17C is a diagram showing an example of an operation for acquiring harvested crops stored in a container of a harvester using an unmanned aerial vehicle.

FIG. 18A is a diagram showing an example of an operation for acquiring a container in which harvested crops are stored using an unmanned aerial vehicle.

FIG. 18B is a diagram showing an example of an operation for acquiring a container in which harvested crops are stored using an unmanned aerial vehicle.

FIG. 18C is a diagram showing an example of an operation for acquiring a container in which harvested crops are stored using an unmanned aerial vehicle.

FIG. 18D is a diagram showing an example of a small unmanned aerial vehicle that harvests crops.

FIG. 19 is a diagram showing an example of an agricultural machine.

FIG. 20A is a diagram showing an example of an operation for scooping up bales discharged from a baler.

FIG. 20B is a diagram showing an example of an operation for scooping up bales discharged from a baler.

FIG. 20C is a diagram showing an example of an operation for scooping up bales discharged from a baler.

FIG. 21 is a flowchart showing an example of processing for determining an unmanned aerial vehicle that transports packages of harvested crops from among multiple unmanned aerial vehicles.

FIG. 22 is a flowchart showing an example of processing for determining an unmanned aerial vehicle that transports packages of harvested crops from among multiple unmanned aerial vehicles.

FIG. 23 is a flowchart showing an example of processing for determining an unmanned aerial vehicle that transports packages of harvested crops from among multiple unmanned aerial vehicles.

FIG. 24 is a diagram showing an example of a field where an unmanned aerial vehicle performs operations to acquire and transport packages.

FIG. 25 is a flowchart showing an example of processing where an unmanned aerial vehicle itself determines whether it can transport a target package.

FIG. 26 is a diagram showing an example of an unmanned aerial vehicle supporting an implement.

FIG. 27 is a flowchart showing an example of an operation for causing an unmanned aerial vehicle supporting an implement to separate the implement and perform transport of harvested crops.

FIG. 28A is a diagram showing an unmanned aerial vehicle supporting an implement performing work in a field.

FIG. 28B is a diagram showing an unmanned aerial vehicle supporting an implement performing work in a field.

FIG. 28C is a diagram showing an unmanned aerial vehicle that has separated an implement.

### DETAILED DESCRIPTION OF THE EXAMPLE EMBODIMENTS

Hereinafter, example embodiments of the present disclosure will be described. However, unnecessarily detailed descriptions may be omitted. For example, detailed descriptions of already well-known matters and redundant descriptions of substantially identical configurations may be omitted. This is to avoid unnecessary redundancy in the following description and to facilitate understanding by those skilled in the art. Note that the inventors provide the accompanying drawings and the following description for those skilled in the art to fully understand example embodiments of the present disclosure, and do not intend to limit the subject matter described in the claims thus. In the following description, components having the same or similar functions are denoted by the same reference numerals. The reference signs F, Re, L, R, U, D attached to the drawings represent front, rear, left, right, up, and down, respectively.

The following example embodiments are illustrative, and the technologies of the present disclosure are not limited to the following example embodiments. The contents of the following example embodiments are merely examples, and various modifications are possible as long as no technical contradiction arises. Moreover, different elements, features or characteristics of example embodiments of the present disclosure can be combined as long as no technical contradiction arises.

An unmanned aerial vehicle including multiple rotors includes a rotary driver that rotates rotors (hereinafter sometimes referred to as “propellers”). Hereinafter, such an unmanned aerial vehicle is referred to as a “multicopter.”

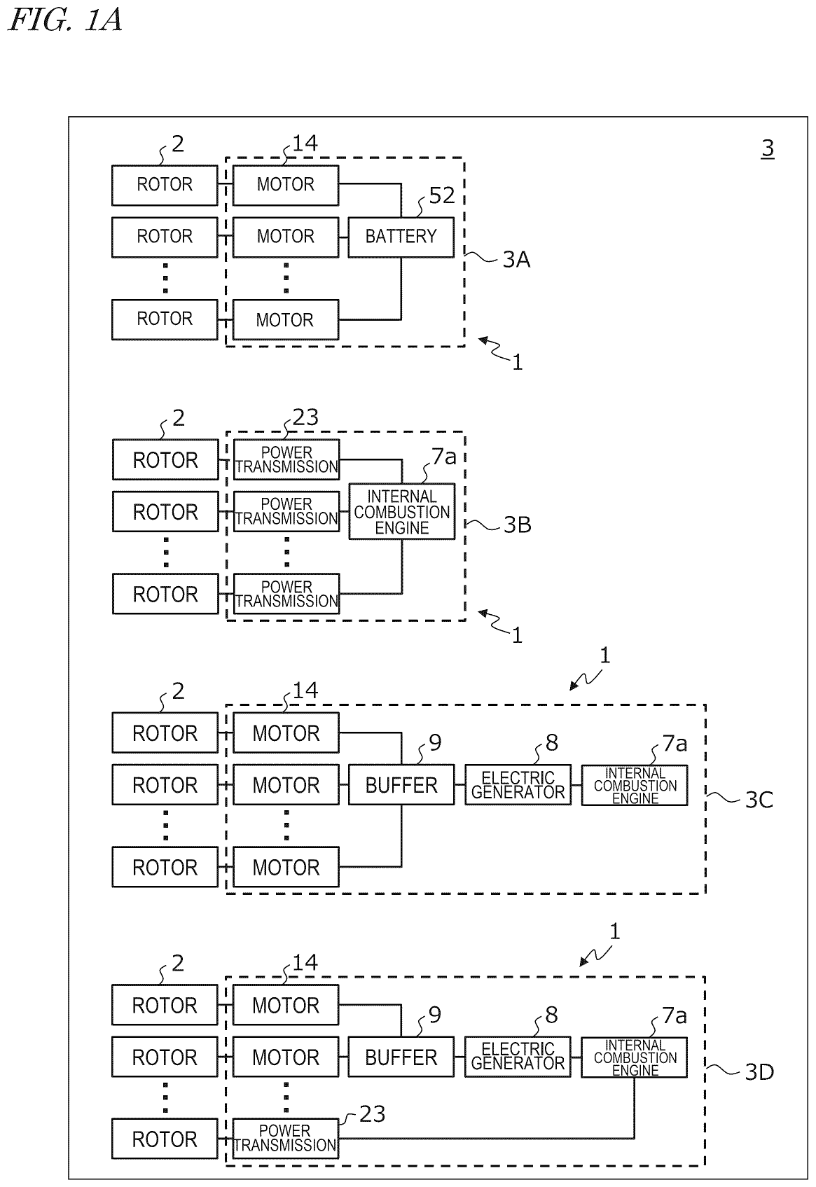

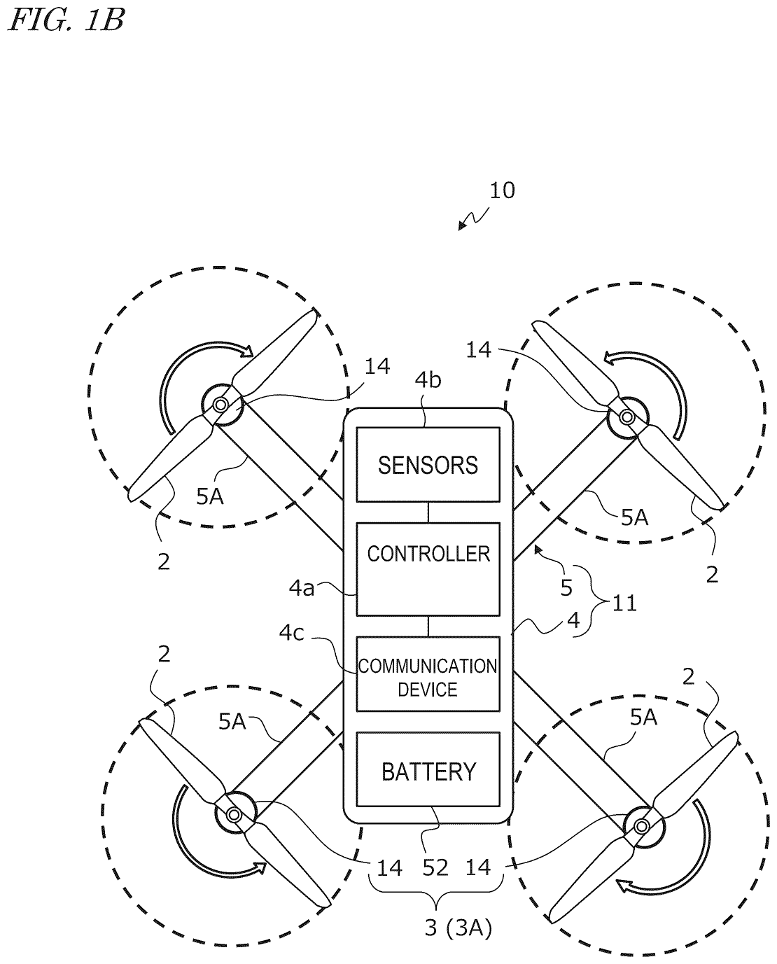

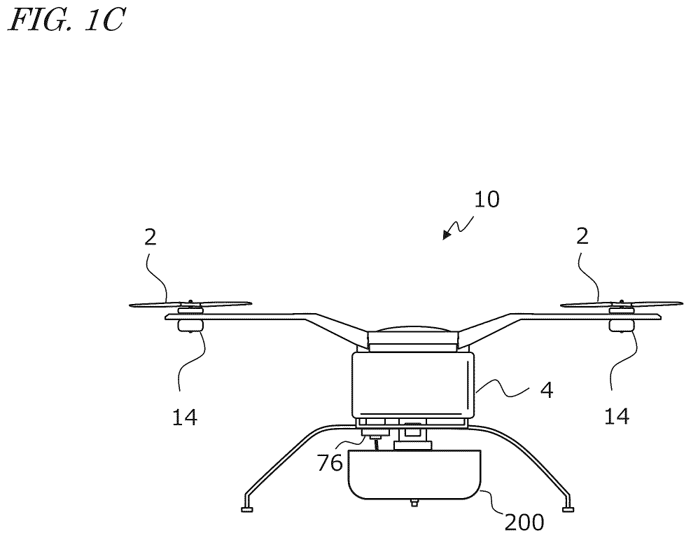

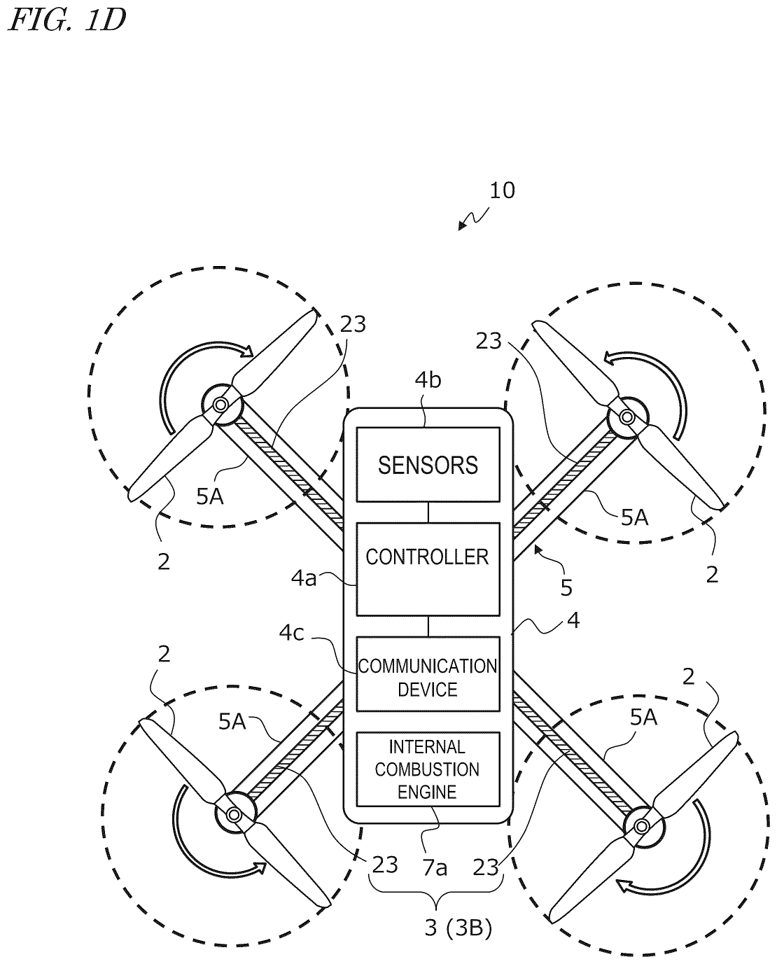

There are various forms of configuration for the rotary driver that a multicopter includes. FIG. 1A is a block diagram schematically showing four examples of the rotary driver 3 in the present disclosure. A flight device 1 that causes a multicopter to fly includes multiple rotors 2 and the rotary driver 3.

A first rotary driver 3A shown in FIG. 1A includes multiple electric motors (hereinafter referred to as “motors”) 14 that rotate the multiple rotors 2, and a battery 52 that stores electric power to be supplied to each motor 14. The battery 52 is, for example, a secondary battery such as a polymer lithium-ion battery. Each rotor 2 is connected to the output shaft of the corresponding motor 14 and is rotated by the motor 14. To increase payload and/or flight time, it is necessary to increase the storage capacity of the battery 52. The storage capacity of the battery 52 can be increased by enlarging the battery 52, but enlarging the battery 52 leads to an increase in weight.

A second rotary driver 3B shown in FIG. 1A includes a power transmission system 23 mechanically connected to the rotor 2, and an internal combustion engine 7a that provides a driving force (torque) to the power transmission system 23. The power transmission system 23 includes mechanical components such as gears or belts, and transmits the torque of the output shaft of the internal combustion engine 7a to the rotor 2. The internal combustion engine 7a can efficiently generate mechanical energy through fuel combustion. Examples of the internal combustion engine 7a may include gasoline engines, diesel engines, and hydrogen engines. Also, the number of internal combustion engines 7a included in the rotary driver 3B is not limited to one.

A third rotary driver 3C shown in FIG. 1A includes multiple motors 14, a power buffer 9 that stores electric power to be supplied to each motor 14, a power generation device 8 such as an alternator that generates electric power, and an internal combustion engine 7a that provides mechanical energy for power generation to the power generation device 8. A typical example of the power buffer 9 is a battery such as a secondary battery, but it may be a capacitor. In the third rotary driver 3C, even when the storage capacity of the power buffer 9 is not large, the power generation device 8 generates electric power using the driving force (mechanical energy) of the internal combustion engine 7a, making it possible to increase payload and/or flight time. This type of drive is called “series hybrid drive.” The power generation device 8 and internal combustion engine 7a in series hybrid drive are called “range extenders” to extend the flight distance of the multicopter.

A fourth rotary driver 3D shown in FIG. 1A includes multiple motors 14, a power buffer 9 that stores electric power to be supplied to each motor 14, a power generation device 8 such as an alternator that generates electric power, an internal combustion engine 7a that provides driving force for power generation to the power generation device 8, and a power transmission system 23 that transmits the driving force generated by the internal combustion engine 7a to the rotor 2 to rotate the rotor 2. At least one rotor 2 among the multiple rotors 2 is rotated by the internal combustion engine 7a, and other rotors 2 are rotated by the motors 14. In the fourth rotary driver 3D, the mechanical energy generated by the internal combustion engine 7a can be used for rotor 2 rotation without being converted to electric power, making it possible to improve energy utilization efficiency. This type of drive is called “parallel hybrid drive.”

FIG. 1B is a plan view schematically showing one of the basic configuration examples of the multicopter 10. The configuration example in FIG. 1B includes the first rotary driver 3A shown in FIG. 1A as the rotary driver 3. That is, the rotary driver 3 (3A) in this example has the motor 14 and the battery 52. FIG. 1C is a side view schematically showing the multicopter 10.

The multicopter 10 shown in FIGS. 1B and 1C includes multiple rotors 2, a main body 4, and a body frame 5 that supports the rotors 2 and the main body 4. The body frame 5 supports the main body 4 at a central portion and rotatably supports the multiple rotors 2 with multiple arms 5A extending outward from the central portion. A motor 14 that rotates the rotor 2 is provided near the tip of each arm 5A. The main body 4 and the body frame 5 are collectively referred to as “body 11” in some cases.

In the example of FIG. 1B, the multicopter 10 is a quad-type multicopter (quadcopter) including four rotors 2, for example. Rotors 2 positioned on one diagonal line rotate in the same direction (clockwise or counterclockwise), but rotors 2 positioned on different diagonal lines rotate in opposite directions.

The main body 4 includes a controller 4a configured or programmed to control the operation of devices and components mounted on the multicopter 10, a sensor group 4b connected to the controller 4a, a communication device 4c connected to the controller 4a, and the battery 52.

The controller 4a may be configured or programmed to include, for example, a flight controller such as a flight controller and an upper-level computer (companion computer). The companion computer can be configured or programmed to execute advanced computational processing such as image processing, obstacle detection, and obstacle avoidance based on sensor data acquired by the sensor group 4b.

The sensor group 4b may include an acceleration sensor, an angular velocity sensor, a geomagnetic sensor, an atmospheric pressure sensor, an altitude sensor, a temperature sensor, a flow sensor, an imaging device, a laser sensor, an ultrasonic sensor, an obstacle contact sensor, and a GNSS (Global Navigation Satellite System) receiver. The acceleration sensor and angular velocity sensor may be mounted on the main body 4 as components of an IMU (Inertial Measurement Unit), for example. Examples of the laser sensor may include a laser range finder used to measure distance to the ground, for example, and two-dimensional or three-dimensional LiDAR (light detection and ranging).

The communication device 4c may include a wireless communication module to transmit and receive signals with a transmitter or ground station (Ground Control Station: GCS) on the ground via an antenna, a mobile communication module using a cellular communication network, etc. The communication device 4c can receive signals such as control commands transmitted from the ground and transmit sensor data such as image data acquired by the sensor group 4b as telemetry information. The communication device 4c may have functions for communication between multicopters and satellite communication functions. The controller 4a can connect to computers on the cloud through the communication device 4c. Some or all of the functions of the companion computer may be executed by computers on the cloud.

The battery 52 is a secondary battery that can store electric power through charging and supply electric power to the motors 14 through discharging. Through the operation of the battery 52 and the multiple motors 14, the multiple rotors 2 are rotationally driven, making it possible to generate desired thrust. Each of the multiple rotors 2 generally includes multiple blades with fixed pitch angles and generates thrust through rotation. The pitch angles may be variable. Not all of the multiple rotors 2 need to have the same diameter (propeller diameter), and one or more rotors 2 may have a larger diameter than other rotors 2. The thrust (static thrust) generated by the rotating rotor 2 is generally proportional to the cube of the diameter of the rotor 2. Therefore, when rotors 2 with different diameters are provided, rotors 2 with relatively large diameters may be referred to as “main rotors,” and rotors 2 with relatively small diameters may be referred to as “sub-rotors.” Note that, regardless of diameter size, rotors 2 capable of generating relatively large thrust and rotors 2 with relatively small thrust may be included depending on the configuration of the rotary driver 3. In that case, rotors 2 capable of generating relatively large thrust may be referred to as “main rotors,” and rotors 2 with relatively small thrust may be referred to as “sub-rotors.” For example, rotors 2 that generate relatively large thrust per rotation may be referred to as “main rotors,” and rotors 2 that generate relatively small thrust per rotation may be referred to as “sub-rotors.” In one example, main rotors may be arranged inward relative to sub-rotors. In other words, each rotor 2 may be arranged such that the distance from the center of the body to the rotation axis of each main rotor is shorter than the distance from the center of the body to the rotation axis of each sub-rotor.

In this example, the rotary driver 3 includes multiple motors 14. As described above, the rotary driver 3 may include the internal combustion engine 7a.

FIG. 1D is a plan view schematically showing a basic configuration example of the multicopter 10 including the second rotary driver 3B as the rotary driver 3. In the example shown in FIG. 1D, the internal combustion engine 7a is supported by the main body 4. In this example, the driving force generated by the internal combustion engine 7a is transmitted to the multiple rotors 2 by multiple power transmission systems 23 to rotate each rotor 2. The controller 4a can change the rotation speed of individual rotors 2 by controlling each power transmission system 23. The rotary driver 3B may include a mechanism that changes the pitch angle of the blades of each of the multiple rotors 2. In that case, the controller 4a may adjust the lift generated by each rotor 2 by controlling the mechanism to change the pitch angle of the blades.

Note that in “parallel hybrid drive” where some of the multiple rotors 2 are rotated by the internal combustion engine 7a and other rotors 2 are rotated by the motors 14, the internal combustion engine 7a and the battery 52 are supported by the main body 4. At least one rotor 2 among the multiple rotors 2 is connected to the internal combustion engine 7a via the power transmission system 23, and other rotors 2 are connected to the motors 14.

In such parallel hybrid drive, the diameter of one or more rotors 2 rotated by the internal combustion engine 7a may be made larger than the diameter of other rotors 2 rotated by the motors 14. In other words, the internal combustion engine 7a may be used for rotation of main rotors, and the motors 14 may be used for rotation of sub-rotors. In such cases, main rotors are mainly used for thrust generation, and sub-rotors are used for thrust generation and attitude control. Main rotors may be called “booster rotors,” and sub-rotors may be called “attitude control rotors.”

In the case of parallel hybrid drive, the internal combustion engine is used for both thrust generation and power generation. It is also possible to achieve thrust generation and power generation in a balanced manner by selectively transmitting the driving force (torque) generated by the internal combustion engine to one or both of the rotor and the power generation device.

When a multicopter includes an internal combustion engine and performs at least one of thrust generation and power generation using the internal combustion engine, this contributes to increasing payload and flight time. Attitude control of a multicopter is preferably performed by rotating propellers using motors that have better response characteristics than internal combustion engines. Therefore, in applications where accurate attitude control of the multicopter is required, it is preferable to adopt parallel hybrid drive or series hybrid drive to increase payload and flight time. Note that when the rotary driver 3 includes a mechanism that changes the pitch angle of the blades of each of the multiple rotors 2, attitude can also be adjusted by changing the pitch angle of each blade.

With increased payload and flight time, the applications of multicopters can be further expanded. For example, in the agricultural field, multicopters are currently being used for agricultural chemical spraying or monitoring crop growth conditions, but by connecting various ground work machines (hereinafter sometimes simply referred to as “work machines”) to multicopters, it becomes possible to execute various agricultural operations from the air. Work machines for agricultural use are sometimes called “implements.” Examples of implements may include sprayers that spray chemicals on crops, mowers (grass cutters), seeders (seeding machines), spreaders (fertilizing machines), rakes, balers (grass collection machines), harvesters, plows, harrows, or rotaries. Work vehicles such as tractors are not included in the “implements”.

In the example shown in FIG. 1C, an implement 200 capable of spraying agricultural chemicals or fertilizers on a field or crops in the field is connected to the multicopter 10. With increased payload and flight time, it becomes possible to realize larger and/or more multifunctional implements 200. For example, by exchanging the implement 200 connected to the multicopter 10, it becomes possible to execute various ground operations (agricultural operations) including liquid application, granular application, fertilization, thinning, weeding, transplanting, direct seeding, and harvesting. The implement 200 may include mechanisms such as robot hands. In that case, one implement 200 can execute various ground operations. If the implement 200 has a space large enough to accommodate materials, such an implement 200 can also transport agricultural materials or harvested crops over a wide range. There are various forms for connecting the implement 200 to the multicopter 10. The multicopter 10 may suspend and tow the implement 200 with a cable. The implement 200 towed by the multicopter 10 can also perform ground operations while being towed while the multicopter 10 is flying or hovering. The implement 200 during work may be in the air or on the ground.

In the example shown in FIG. 1C, the multicopter 10 includes a power supply device 76. The power supply device 76 is a device that supplies electric power to the implement 200 from a driving energy source such as the battery 52 or the power generation device 8 that the multicopter 10 includes. Various functions of the implement 200 can be executed by this electric power. The implement 200 includes actuators such as motors that operate using electric power obtained from the power supply device 76 of the multicopter 10. The implement 200 preferably includes a battery that stores electric power. The ESC 16 described later may be included in the controller 4a.

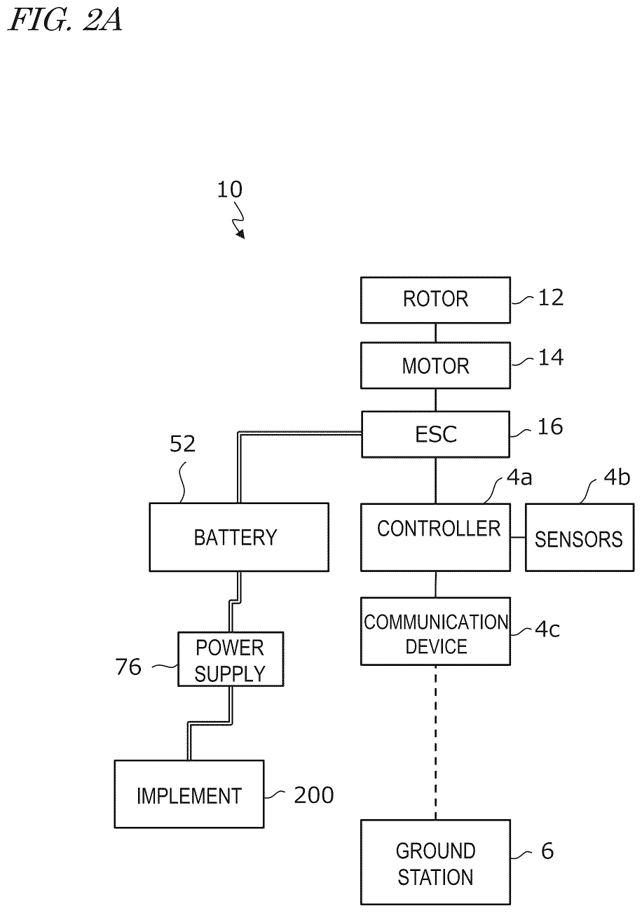

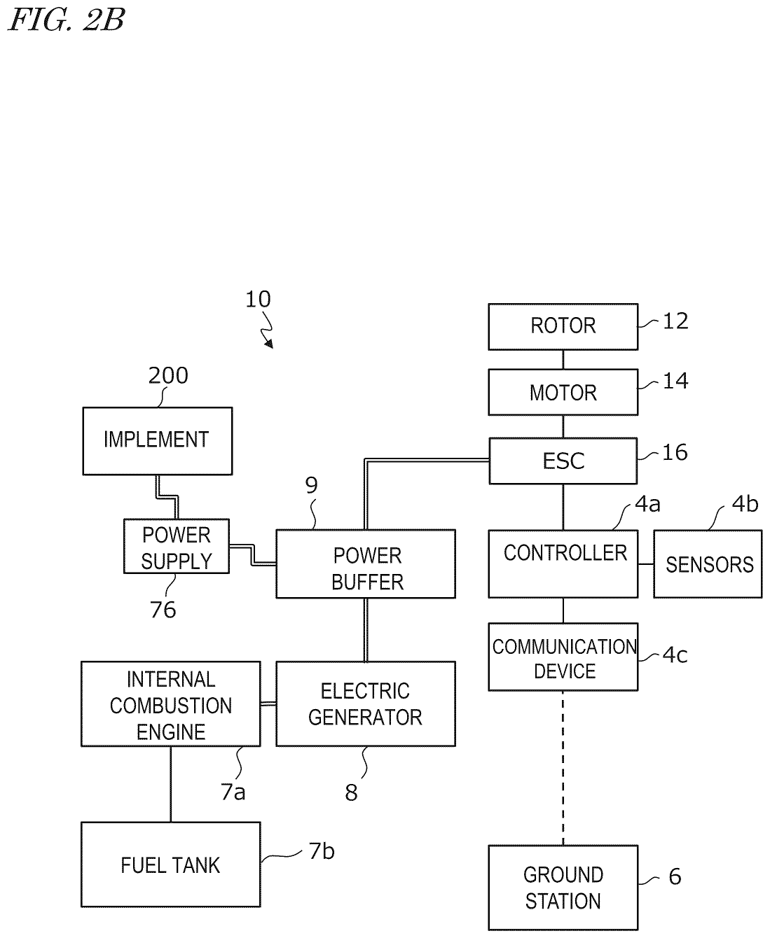

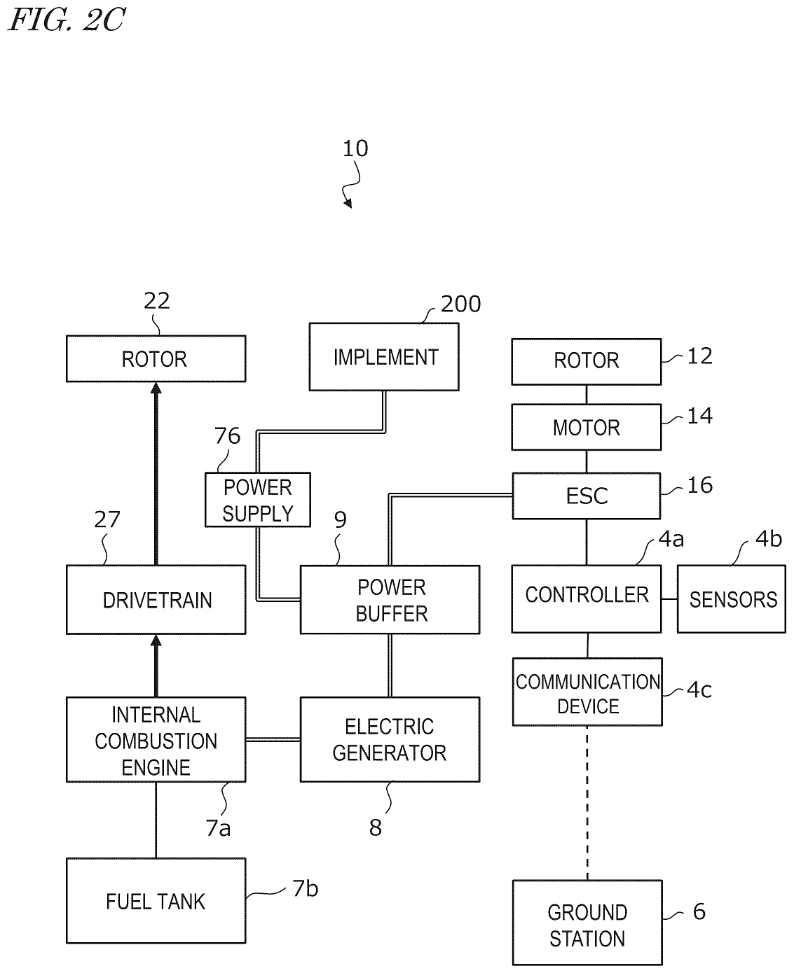

FIG. 2A is a block diagram showing a basic configuration example of a battery-driven multicopter 10. The battery-driven multicopter 10 includes multiple rotors 12, multiple motors 14 that respectively rotate the multiple rotors 12, multiple ESCs (Electric Speed Controllers) 16 having motor drive circuits that respectively drive the multiple motors 14, a battery 52 that supplies electric power to the corresponding motor 14 via each ESC 16, a controller 4a is configured or programmed to control each ESC 16 to perform flight while controlling attitude, a sensor group 4b, a communication device 4c, and a power supply device 76 electrically connected to the battery 52. The rotor 12 is an example of the rotor 2. In FIG. 2A, for simplicity, the rotor 12, motor 14, and ESC 16 are each shown by one block, but the numbers of rotors 12, motors 14, and ESCs 16 are each multiple. This point is the same for FIGS. 2B and 2C.

The controller 4a can wirelessly receive control commands from, for example, a ground station 6 on the ground via the communication device 4c. The number of ground stations 6 is not limited to one and may be distributed in multiple locations. The communication device 4c can also wirelessly receive control commands from a pilot's controller on the ground. The controller 4a may be configured or programmed to automatically or autonomously execute each operation of takeoff, flight, obstacle avoidance, and landing based on sensor data obtained from the sensor group 4b. The controller 4a may be configured or programmed to communicate with the implement 200 connected to the power supply device 76 and acquire signals indicating the state of the implement 200 from the implement 200. Also, the controller 4a may provide signals controlling the operation of the implement 200 to the implement 200. Furthermore, the implement 200 may generate signals instructing the operation of the multicopter 10 and transmit them to the controller 4a. Such communication between the controller 4a and the implement 200 can be performed by wire or wirelessly.

FIG. 2B is a block diagram showing a basic configuration example of a series hybrid-driven multicopter 10. The series hybrid-driven multicopter 10 includes multiple rotors 12, multiple motors 14, multiple ESCs 16, a controller 4a, a sensor group 4b, and a communication device 4c, similar to the battery-driven multicopter 10. The illustrated series hybrid-driven multicopter 10 further includes an internal combustion engine 7a, a fuel tank 7b that stores fuel for the internal combustion engine 7a, a power generation device 8 that is driven by the internal combustion engine 7a to generate electric power, a power buffer 9 that temporarily stores electric power generated by the power generation device 8, and a power supply device 76 electrically connected to the power buffer 9. The power buffer 9 is, for example, a battery such as a secondary battery. Electric power generated by the power generation device 8 is supplied to the motors 14 via the power buffer 9 and the ESCs 16. Also, electric power generated by the power generation device 8 can also be supplied to the implement 200 via the power supply device 76.

FIG. 2C is a block diagram showing a basic configuration example of a parallel hybrid-driven multicopter 10. The parallel hybrid-driven multicopter 10 includes multiple rotors 12, multiple motors 14 that respectively drive the multiple rotors 12, multiple ESCs 16, a controller 4a, a sensor group 4b, a communication device 4c, an internal combustion engine 7a, a fuel tank 7b, a power generation device 8, a power buffer 9, and a power supply device 76, similar to the series hybrid-driven multicopter 10. The parallel hybrid-driven multicopter 10 further includes a drivetrain 27 that transmits the driving force of the internal combustion engine 7a, and a rotor 22 that rotates by receiving the driving force of the internal combustion engine 7a from the drivetrain 27. One of the rotor 12 and the rotor 22 may be called a “first rotor,” and the other may be called a “second rotor” to distinguish them from each other. The rotor 22 connected to and rotated by the drivetrain 27 may be one or two or more.

In the parallel hybrid-driven multicopter 10, the internal combustion engine 7a not only drives the power generation device 8 to perform power generation but also mechanically transmits energy for rotating the rotor 22 to the rotor 22. On the other hand, in the series hybrid-driven multicopter 10, all rotors 12 rotate by electric power generated by the power generation device 8. Therefore, in the series hybrid-driven multicopter 10, if the power generation device 8 is, for example, a fuel cell, the internal combustion engine 7a is not an essential component.

Next, a harvest management system will be described that acquires harvested crops that an agricultural machine has harvested from a field using the unmanned aerial vehicle 10.

The agricultural machine in the present example embodiment may be a mobile agricultural machine (Mobile Agricultural Machine) capable of harvesting crops from a field while moving. The agricultural machine is, for example, a harvester, a tractor, or an agricultural mobile robot. In some cases, an implement attached to or towed by an agricultural machine such as a tractor and the agricultural machine as a whole function as one “agricultural machine.”

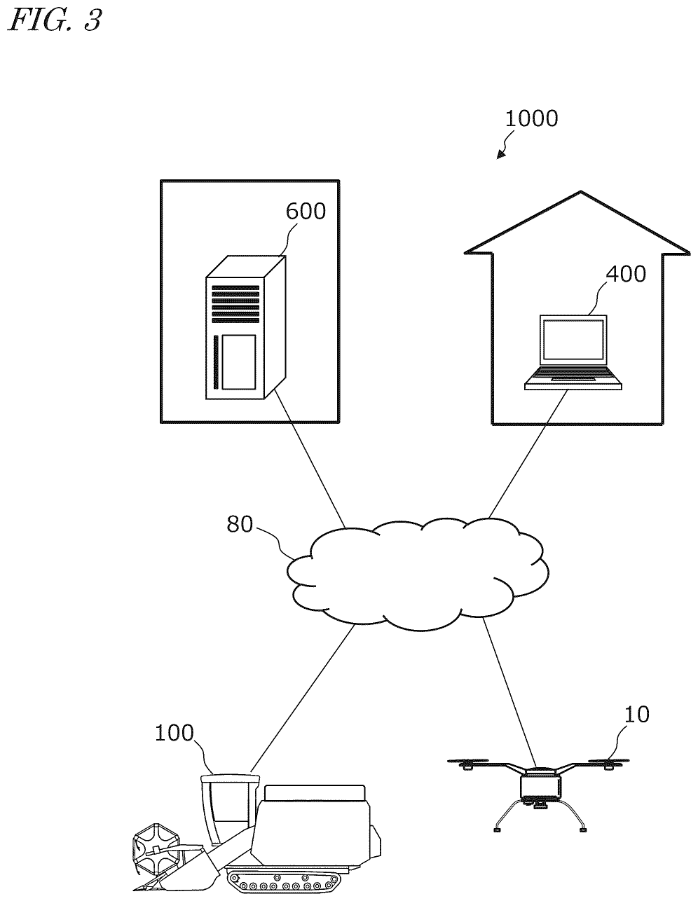

FIG. 3 is a diagram showing an example of a harvest management system 1000 according to the present example embodiment. The harvest management system 1000 includes an agricultural machine 100, an unmanned aerial vehicle 10, a terminal device 400, and a management device 600. FIG. 3 shows a harvester as an example of the agricultural machine 100. The unmanned aerial vehicle 10 is, for example, the multicopter described above.

The harvester 100 may be, for example, a combine harvester. The harvester 100 performs cutting of crops in the field, threshing of the cut crops, storage of harvested crops after threshing, discharge of harvested crops, etc. The crops in the field may be plants from which grains such as rice, wheat, corn, and soybeans can be harvested, but are not limited thereto. The unmanned aerial vehicle 10 acquires and transports harvested crops that the harvester 100 has harvested from the field.

The harvester 100 has an automatic driving function. That is, the harvester 100 can travel not manually but through the operation of a controller. The controller in the present example embodiment is provided inside the harvester 100 and can be configured or programmed to control both the speed and steering of the harvester 100. The harvester 100 may automatically travel not only within the field but also outside the field (for example, on roads). The harvester 100 includes devices used for positioning or self-position estimation, such as a GNSS unit and a LiDAR sensor. The controller of the harvester 100 is configured or programmed to automatically drive the harvester 100 based on the position of the harvester 100 and information about a target route.

The unmanned aerial vehicle 10 has an autonomous flight function and can fly through the operation of a controller. The unmanned aerial vehicle 10 includes devices used for positioning or self-position estimation, such as a GNSS unit and a LiDAR sensor. The controller of the unmanned aerial vehicle 10 automatically flies the unmanned aerial vehicle 10 based on the position of the unmanned aerial vehicle 10 and information about a target flight route.

The terminal device 400 is a computer used by a user who remotely monitors the harvester 100 and the unmanned aerial vehicle 10. The management device 600 is a computer managed by a business operator that operates the harvest management system 1000. The harvester 100, the unmanned aerial vehicle 10, the terminal device 400, and the management device 600 can communicate with each other via a network 80. Although one harvester 100 and one unmanned aerial vehicle 10 are illustrated in FIG. 3, the harvest management system 1000 may include multiple harvesters 100 and/or multiple unmanned aerial vehicles 10. The harvest management system 1000 may include other agricultural machines.

The management device 600 is a computer that manages agricultural work and transport work by the harvester 100 and the unmanned aerial vehicle 10. The management device 600 may be, for example, a server computer that centrally manages information about fields on the cloud and supports agriculture by utilizing data on the cloud. The management device 600, for example, creates work plans for the harvester 100 and the unmanned aerial vehicle 10, and causes the harvester 100 and the unmanned aerial vehicle 10 to execute agricultural work according to those work plans. The management device 600, for example, generates target routes within fields based on information input by a user using the terminal device 400 or other devices. The management device 600 may further generate and edit environment maps based on data collected by sensing devices such as LiDAR sensors used by the harvester 100, the unmanned aerial vehicle 10, other mobile bodies, etc. The management device 600 transmits data of the generated work plans, target routes, and environment maps to the harvester 100 and the unmanned aerial vehicle 10. The harvester 100 and the unmanned aerial vehicle 10 automatically perform movement and various operations based on those data.

The terminal device 400 is a computer used by a user who is at a location away from the harvester 100 and the unmanned aerial vehicle 10. The terminal device 400 shown in FIG. 3 is a laptop computer, but is not limited thereto. The terminal device 400 may be a stationary computer such as a desktop PC (Personal Computer), or may be a mobile terminal such as a smartphone or tablet computer. The terminal device 400 can be used for remotely monitoring the harvester 100 and the unmanned aerial vehicle 10, or for remotely operating the harvester 100 and the unmanned aerial vehicle 10. For example, the terminal device 400 can display on a display video captured by cameras (imaging devices) that the harvester 100 and the unmanned aerial vehicle 10 each include. The terminal device 400 can also display on a display a setting screen for a user to input information necessary for creating work plans for the harvester 100 (for example, schedules for each agricultural work). When the user inputs necessary information on the setting screen and performs a transmission operation, the terminal device 400 transmits the input information to the management device 600. The management device 600 creates work plans based on this information. The terminal device 400 may further have a function to display on a display a setting screen for a user to input information necessary for setting target routes.

The configuration and operation of the system in the present example embodiment will be described in more detail below.

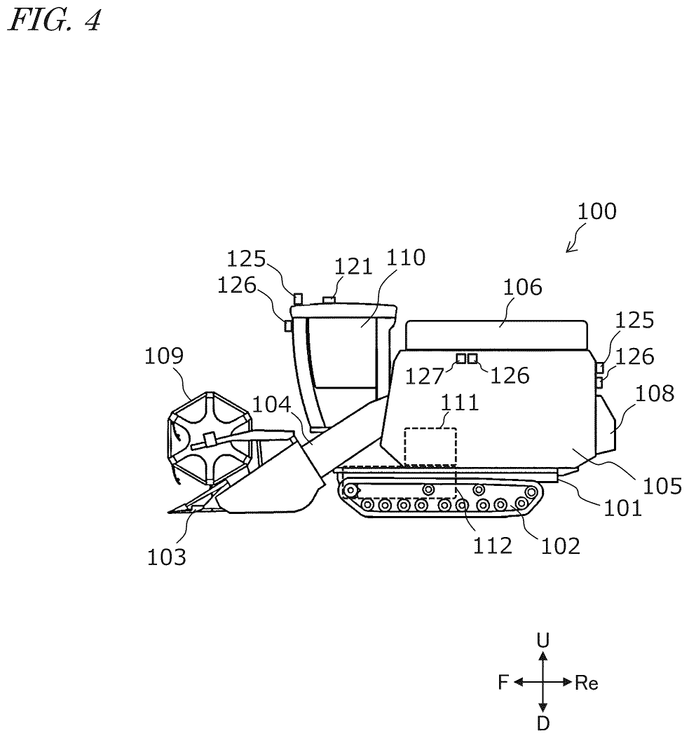

FIG. 4 is a side view schematically showing an example of the harvester 100. The harvester 100 includes a vehicle body 101 and a traveling device 102. The illustrated traveling device 102 is a crawler-type traveling device, but may be a traveling device including wheeled tires. A cabin 110 is provided above the vehicle body 101.

A cutting device 103 for cutting crops is provided in front of the traveling device 102 in a height-adjustable manner. A reel 109 for raising the stem parts of crops is provided above the cutting device 103 in a height-adjustable manner. Behind the cabin 110, a threshing device 105 and a tank 106 for storing harvested crops are arranged side by side in the left-right direction. A conveying device 104 for conveying cut crops is provided between the cutting device 103 and the threshing device 105. The threshing device 105 performs threshing of cut crops. The tank 106 stores harvested crops obtained by threshing grains, etc. A straw processing device 108 is provided behind the threshing device 105. The straw processing device 108 finely cuts stem parts, etc., after grains and other harvested crops have been removed and discharges them to the outside. The tank 106 may be provided with a discharge device that discharges harvested crops from the tank 106.

Since the configurations and operations of various devices that perform harvesting operations, such as the cutting device 103, the conveying device 104, the threshing device 105, the straw processing device 108, the reel 109, and the discharge device, are known, detailed descriptions thereof are omitted here.

The harvester 100 in the present example embodiment can operate in both manual driving mode and automatic driving mode. In automatic driving mode, the harvester 100 can travel unmanned. Also, in automatic driving mode, the harvester 100 can travel unmanned while performing operations to harvest crops in the field.

As shown in FIG. 4, the harvester 100 includes a prime mover (engine) 111 and a transmission 112. Inside the cabin 110, a driver's seat, operating levers, an operating terminal, and a group of switches for operation are provided.

The harvester 100 may include at least one sensing device that senses the environment around the harvester 100 and a controller configured or programmed to process sensing data output from the at least one sensing device. The harvester 100 includes multiple sensing devices. The sensing devices may be a LIDAR sensor 125, a camera 126, and an obstacle sensor 127.

The camera 126 may be provided, for example, at the front, rear, left, and right of the harvester 100. The camera 126 captures the environment around the harvester 100 and generates image data. Images acquired by the camera 126 are output to a controller mounted on the harvester 100 and can be transmitted to the terminal device 400 for remote monitoring. Also, the images may be used for monitoring the harvester 100 during unmanned operation.

The LiDAR sensor 125 illustrated in FIG. 4 is arranged at the front and rear portions of the harvester 100. The LiDAR sensor 125 may further be provided at side portions of the harvester 100. The harvester 100 may include multiple LiDAR sensors arranged at mutually different positions in different orientations. The LiDAR sensor 125 may be a 3D-LiDAR sensor, but may also be a 2D-LiDAR sensor. The LiDAR sensor 125 senses the environment around the harvester 100 and outputs sensing data. The LiDAR sensor 125 repeatedly outputs sensor data indicating the distance and direction to each measurement point of objects existing in the surrounding environment, or three-dimensional or two-dimensional coordinate values of each measurement point. The sensor data output from the LiDAR sensor 125 is processed by the controller of the harvester 100. The controller can be configured or programmed to perform self-position estimation of the harvester 100 by matching the sensor data with an environment map. The controller can be configured or programmed to further detect objects such as obstacles existing around the harvester 100 based on the sensor data. The controller can also be configured or programmed to generate or edit environment maps using algorithms such as SLAM (Simultaneous Localization and Mapping).

The obstacle sensor 127 illustrated in FIG. 4 is provided at side portions of the harvester 100. The obstacle sensor 127 may also be arranged at other locations. For example, the obstacle sensor 127 may be provided at front and rear portions of the harvester 100. The obstacle sensor 127 may include, for example, a laser scanner or ultrasonic sonar. The obstacle sensor 127 is used to detect obstacles in the surroundings during automatic travel and stop or bypass the harvester 100. The LiDAR sensor 125 may be used as one of the obstacle sensors 127.

The harvester 100 includes a positioning device 121 that detects the geographic coordinates of the position of the harvester 100. The positioning device 121 is, for example, a GNSS unit. The GNSS unit 121 includes a GNSS receiver. The GNSS receiver may include an antenna that receives signals from GNSS satellites and a processor that calculates the position of the harvester 100 based on signals received by the antenna. The GNSS unit 121 receives satellite signals transmitted from multiple GNSS satellites and performs positioning based on the satellite signals. GNSS is a general term for satellite positioning systems such as GPS (Global Positioning System), QZSS (Quasi-Zenith Satellite System, for example, Michibiki), GLONASS, Galileo, and BeiDou. The GNSS unit 121 in the present example embodiment is provided at the top of the cabin 110, but may be provided at other positions.

The controller of the harvester 100 may be configured or programmed to use sensing data acquired by sensing devices such as the camera 126 and/or the LiDAR sensor 125 for positioning in addition to positioning results by the GNSS unit 121. When landmarks that function as feature points exist in the environment where the harvester 100 travels, the position and orientation of the harvester 100 can be estimated with high accuracy based on data acquired by the camera 126 and/or the LiDAR sensor 125 and an environment map stored in advance in a storage device. By correcting or complementing position data based on satellite signals using data acquired by the camera 126 and/or the LiDAR sensor 125, the position of the harvester 100 can be specified with higher accuracy.

The prime mover 111 may be, for example, a diesel engine. An electric motor may be used instead of a diesel engine. The transmission 112 can change the propulsion force and movement speed of the harvester 100 through gear changes. The transmission 112 can also switch between forward and reverse movement of the harvester 100.

In forms where the harvester 100 includes the crawler-type traveling device 102, the traveling direction of the harvester 100 can be changed by making the rotation speeds of left and right wheels including tracks different from each other, or by making the rotation directions of the left and right wheels different from each other. In forms where the harvester 100 includes a traveling device including wheeled tires, the harvester 100 includes a power steering device, and the traveling direction of the harvester 100 can be changed by controlling the power steering device to change the turning angle (also called “steering angle”) of steered wheels.

The harvester 100 shown in FIG. 4 is capable of manned operation, but may correspond only to unmanned operation. In that case, components necessary only for manned operation, such as the cabin 110, steering device, and driver's seat, may not be provided in the harvester 100. The unmanned harvester 100 can travel by autonomous travel or remote operation by a user.

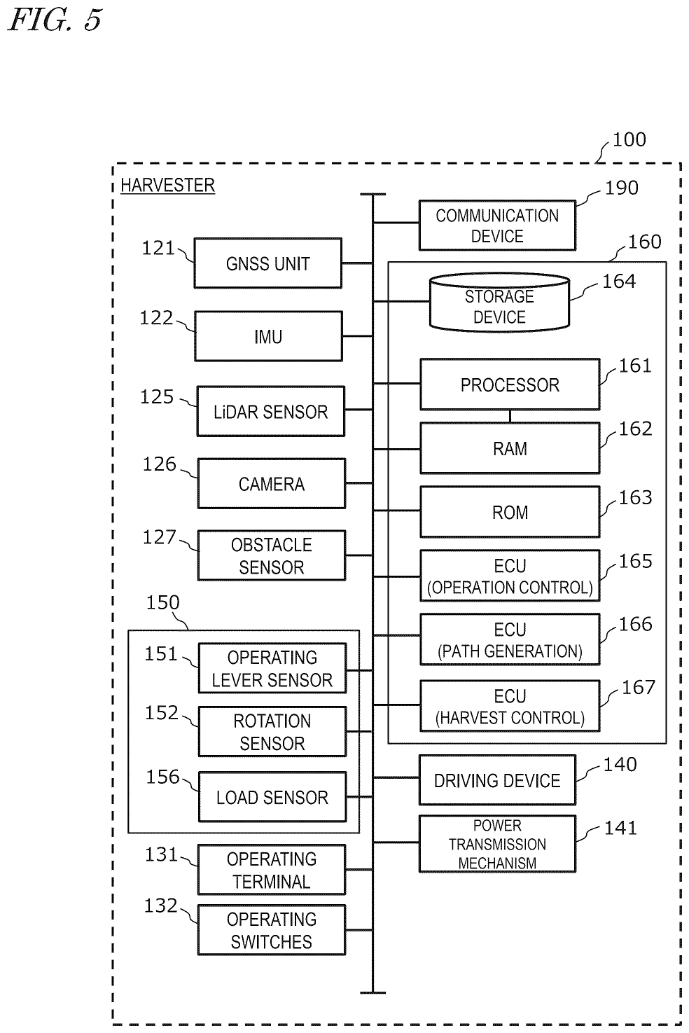

FIG. 5 is a block diagram showing a configuration example of the harvester 100. The harvester 100 can communicate with the terminal device 400 and the management device 600 via the network 80 (FIG. 3). The harvester 100 and the unmanned aerial vehicle 10 may communicate via the network 80 or may communicate directly without going through the network 80.

The harvester 100 illustrated in FIG. 5 includes a GNSS unit 121, an inertial measurement unit (IMU) 122, a LIDAR sensor 125, a camera 126, an obstacle sensor 127, an operating terminal 131, an operating switch group 132, a driving device 140, a power transmission mechanism 141, a sensor group 150, a controller 160, and a communication device 190. These components are connected to communicate with each other via a bus.

The GNSS unit 121 includes, for example, a GNSS receiver and an RTK receiver. The sensor group 150 detects various states of the harvester 100. The sensor group 150 includes an operating lever sensor 151, a rotation sensor 152, and a load sensor 156. The controller 160 includes a processor 161, RAM (Random Access Memory) 162, ROM (Read Only Memory) 163, a storage device 164, and multiple electronic control units (ECUs) 165 to 167. FIG. 5 shows components that have relatively high relevance to automatic driving operations by the harvester 100, and illustration of other components is omitted.

The GNSS unit 121 receives satellite signals transmitted from multiple GNSS satellites and generates GNSS data based on the satellite signals. The GNSS data is generated in a predetermined format such as the NMEA-0183 format. The GNSS data may include, for example, values indicating the identification numbers, elevation angles, azimuth angles, and reception strengths of each satellite from which satellite signals were received.

The GNSS unit 121 may perform positioning of the harvester 100 using RTK (Real Time Kinematic)-GNSS. In positioning using RTK-GNSS, correction signals transmitted from reference stations are used in addition to satellite signals transmitted from multiple GNSS satellites. Reference stations may be installed near fields where the harvester 100 performs work travel (for example, at positions within 10 km from the harvester 100). Reference stations generate correction signals in, for example, RTCM format based on satellite signals received from multiple GNSS satellites and transmit them to the GNSS unit 121. The RTK receiver 122 includes an antenna and a modem and receives correction signals transmitted from reference stations. The GNSS unit 121 corrects positioning results based on correction signals. By using RTK-GNSS, positioning can be performed with accuracy of, for example, an error of several centimeters. Position data including information about latitude, longitude, and altitude is acquired by high-precision positioning using RTK-GNSS. The GNSS unit 121 calculates the position of the harvester 100, for example, at a frequency of about 1 to 10 times per second.

Note that the positioning method is not limited to RTK-GNSS, and any positioning method (such as interferometric positioning or relative positioning) that can obtain position data with necessary accuracy can be used. For example, positioning using VRS (Virtual Reference Station) or DGPS (Differential Global Positioning System) may be performed. When position data with necessary accuracy can be obtained without using correction signals transmitted from reference stations, position data may be generated without using correction signals. In that case, the GNSS unit 121 may not include an RTK receiver.

Even when RTK-GNSS is used, in places where correction signals from reference stations cannot be obtained (for example, on roads far from fields), the position of the harvester 100 is estimated by other methods without relying on signals from RTK receivers. For example, the position of the harvester 100 may be estimated by matching data output from the LiDAR sensor 125 and/or the camera 126 with high-precision environment maps.

The IMU 122 may include a 3-axis acceleration sensor and a 3-axis gyroscope. The IMU 122 may include an orientation sensor such as a 3-axis geomagnetic sensor. The IMU 122 functions as a motion sensor and can output signals indicating various quantities such as acceleration, velocity, displacement, and attitude of the harvester 100.

Position data can be complemented using output signals from the IMU 122. The IMU 122 can measure the inclination and minute movements of the harvester 100. By complementing position data based on satellite signals using data acquired by the IMU 122, positioning performance can be improved.

In addition to the satellite signals and correction signals described above, the position and orientation of the harvester 100 can be estimated with higher accuracy based on signals output from the IMU 122. Signals output from the IMU 122 can be used for correction or complementation of positions calculated based on satellite signals and correction signals. The IMU 122 outputs signals at a higher frequency than position detection using satellite signals. Using those high-frequency signals, the position and orientation of the harvester 100 can be measured at a higher frequency (for example, 10 Hz or higher). Instead of the IMU 122, a 3-axis acceleration sensor and a 3-axis gyroscope may be provided separately. The IMU 122 may be included in the GNSS unit 121.

The camera 126 is an imaging device that captures the environment around the harvester 100. The camera 126 includes, for example, an image sensor such as a CCD (Charge Coupled Device) or CMOS (Complementary Metal Oxide Semiconductor). The camera 126 may also include an optical system including one or more lenses and a signal processing circuit. The camera 126 captures the environment around the harvester 100 while the harvester 100 is traveling and generates data of images (for example, moving images). The camera 126 can capture moving images at a frame rate of, for example, 3 frames per second (fps) or higher. Images generated by the camera 126 may be used, for example, when a remote monitor uses the terminal device 400 to check the environment around the harvester 100. Images generated by the camera 126 may be used for positioning or obstacle detection. Multiple cameras 126 may be provided at different positions of the harvester 100, or a single camera may be provided. A visible camera that generates visible light images and an infrared camera that generates infrared images may be provided separately. Both visible cameras and infrared cameras may be provided as cameras that generate images for monitoring. Infrared cameras can also be used for obstacle detection at night.

The obstacle sensor 127 detects objects existing around the harvester 100. The obstacle sensor 127 may include, for example, a laser scanner or ultrasonic sonar. The obstacle sensor 127 outputs a signal indicating that an obstacle exists when an object exists closer than a predetermined distance from the obstacle sensor 127. Multiple obstacle sensors 127 may be provided at different positions of the harvester 100. For example, multiple laser scanners and multiple ultrasonic sonars may be arranged at different positions of the harvester 100. By providing multiple obstacle sensors 127, blind spots in monitoring obstacles around the harvester 100 can be reduced.

The operating lever sensor 151 detects operation of operating levers by a user in the cabin 110. Output signals from the operating lever sensor 151 are used for driving control by the controller 160. The rotation sensor 152 measures the rotation speed of the axle of the traveling device 102, that is, the number of rotations per unit time. The rotation sensor 152 may be a sensor using a magnetoresistive element (MR), Hall element, or electromagnetic pickup. The rotation sensor 152 outputs, for example, a numerical value indicating the number of rotations per minute (unit: rpm) of the axle. The rotation sensor 152 is used, for example, to measure the speed of the harvester 100.

The load sensor 156 is provided at the bottom of the tank 106 and detects the weight of harvested crops in the tank 106. By detecting the weight of harvested crops in the tank 106, the controller 160 can recognize the storage state of harvested crops in the tank 106. A yield sensor and a taste sensor may be provided inside or around the tank 106. Quality data such as moisture content and protein content of harvested crops is output from the taste sensor.

The driving device 140 includes various devices necessary for driving the harvester 100 for travel, such as the prime mover 111 and the transmission 112. The prime mover 111 may include an internal combustion engine such as a diesel engine. The driving device 140 may include a traction electric motor instead of or together with the internal combustion engine.

The power transmission mechanism 141 transmits power generated by the prime mover 111 to various devices that perform harvesting operations. The devices that perform harvesting operations are the cutting device 103, the conveying device 104, the threshing device 105, the tank 106, the straw processing device 108, the reel 109, etc. The harvester 100 may include a power source (such as an electric motor) that supplies power to at least one of these devices that perform harvesting operations separately from the prime mover 111.

The processor 161 may be a semiconductor integrated circuit including, for example, a central processing unit (CPU). The processor 161 may be realized by a microprocessor or microcontroller. Alternatively, the processor 161 may be realized by an FPGA (Field Programmable Gate Array) including a CPU, GPU (Graphics Processing Unit), ASIC (Application Specific Integrated Circuit), ASSP (Application Specific Standard Product), or a combination of two or more circuits selected from these circuits. The processor 161 sequentially executes computer programs stored in the ROM 163 that describe instruction groups for executing at least one process, thus realizing desired processing.

The ROM 163 is, for example, a writable memory (for example, PROM), a rewritable memory (for example, flash memory), or a read-only memory. The ROM 163 stores programs that control the operation of the processor 161. The ROM 163 need not be a single storage medium and may be a collection of multiple storage media. A portion of the collection of multiple storage media may be removable memory.

The RAM 162 provides a work area for temporarily expanding control programs stored in the ROM 163 during boot-up. The RAM 162 need not be a single storage medium and may be a collection of multiple storage media.

The storage device 164 includes one or more storage media such as flash memory or magnetic disks. The storage device 164 stores various data generated by the GNSS unit 121, the LiDAR sensor 125, the camera 126, the obstacle sensor 127, the sensor group 150, and the controller 160. The data stored by the storage device 164 may include map data (environment maps) of environments where the harvester 100 travels, and data of target routes for automatic driving. Environment maps include information about multiple fields where the harvester 100 performs agricultural work and surrounding roads. Environment maps and target routes may be generated by a processor of the management device 600. Note that the controller 160 may have functions to generate or edit environment maps and target routes. The controller 160 can edit environment maps and target routes acquired from the management device 600 according to the traveling environment of the harvester 100. The storage device 164 also stores data of work plans that the communication device 190 receives from the management device 600.

The storage device 164 also stores computer programs that cause the processor 161 and ECUs 165-167 to execute various operations described later. Such computer programs may be provided to the harvester 100 via storage media (such as semiconductor memory or optical disks) or telecommunication lines (such as the Internet). Such computer programs may be sold as commercial software.

The controller 160 is configured or programmed to include multiple ECUs 165-167. The ECU 165 controls the traveling speed and turning operations of the harvester 100 by controlling the prime mover 111, the transmission 112, the traveling device 102, etc., included in the driving device 140.

The ECU 165 performs calculations and control for realizing automatic driving based on data output from the GNSS unit 121, the camera 126, the obstacle sensor 127, the LiDAR sensor 125, the sensor group 150, and the processor 161. For example, the ECU 165 identifies the position of the harvester 100 based on data output from at least one of the GNSS unit 121, the camera 126, and the LiDAR sensor 125. Within fields, the ECU 165 may determine the position of the harvester 100 based only on data output from the GNSS unit 121. The ECU 165 may estimate or correct the position of the harvester 100 based on data acquired by the camera 126 and/or the LiDAR sensor 125. By using data acquired by the camera 126 and/or the LiDAR sensor 125, the accuracy of positioning can be further improved. For example, the ECU 165 may estimate the position of the harvester 100 by matching data output from the LiDAR sensor 125 and/or the camera 126 with environment maps. During automatic driving, the ECU 165 performs calculations necessary for the harvester 100 to travel along target routes based on the estimated position of the harvester 100.

The ECU 166 may determine the destination of the harvester 100 based on work plans stored in the storage device 164 and determine target routes from the starting point of movement of the harvester 100 to the destination. The ECU 166 may perform processing to detect objects located around the harvester 100 based on data output from the camera 126, the obstacle sensor 127, and the LiDAR sensor 125.

The ECU 167 controls operations of the power transmission mechanism 141, etc., to cause various devices that perform the harvesting operations described above to execute desired operations.

Through the operation of these ECUs, the controller 160 realizes automatic driving and crop harvesting operations. During automatic driving, the controller 160 is configured or programmed to control the driving device 140 based on the measured or estimated position of the harvester 100 and target routes. As a result, the controller 160 can cause the harvester 100 to travel along target routes.

The multiple ECUs included in the controller 160 can communicate with each other according to vehicle bus standards such as CAN (Controller Area Network). Instead of CAN, higher-speed communication methods such as in-vehicle Ethernet (registered trademark) may be used. In FIG. 5, each of the ECUs 165 to 167 is shown as an individual block, but each of these functions may be realized by multiple ECUs. An in-vehicle computer that integrates at least some functions of the ECUs 165 to 167 may be provided. The controller 160 may include ECUs other than the ECUs 165 to 167, and any number of ECUs may be provided according to functions. Each ECU includes a processing circuit including one or more processors. The processor 161 may be integrated with any of the ECUs included in the controller 160.

The communication device 190 is a device including circuits that communicate with the unmanned aerial vehicle 10, the terminal device 400, and the management device 600. The communication device 190 includes circuits that perform wireless communication with the communication device of the unmanned aerial vehicle 10. This enables causing the unmanned aerial vehicle 10 to execute desired operations or acquiring information from the unmanned aerial vehicle 10. The communication device 190 may further include antennas and communication circuits for executing signal transmission and reception via the network 80 with each of the communication devices of the terminal device 400 and the management device 600. The network 80 may include, for example, cellular mobile communication networks such as 3G, 4G, or 5G and the Internet. The communication device 190 may have a function to communicate with portable terminals used by monitors near the harvester 100. Communication with such portable terminals may be performed according to any wireless communication standard such as Wi-Fi (registered trademark), cellular mobile communication such as 3G, 4G, or 5G, or Bluetooth (registered trademark).

The operating terminal 131 is a terminal for a user to execute operations related to travel of the harvester 100 and operations of the unmanned aerial vehicle 10, and is also called a virtual terminal (VT). The operating terminal 131 may include a display device such as a touch screen and/or one or more buttons. The display device may be a display such as liquid crystal or organic light-emitting diode (OLED). By operating the operating terminal 131, a user can execute various operations such as switching automatic driving mode on/off, recording or editing environment maps, and setting target routes. At least some of these operations may also be realized by operating the operating switch group 132. The operating terminal 131 may be configured to be removable from the harvester 100. A user at a location away from the harvester 100 may operate the detached operating terminal 131 to control the operation of the harvester 100. Instead of the operating terminal 131, a user may operate a computer such as the terminal device 400 on which necessary application software is installed to control the operation of the harvester 100.

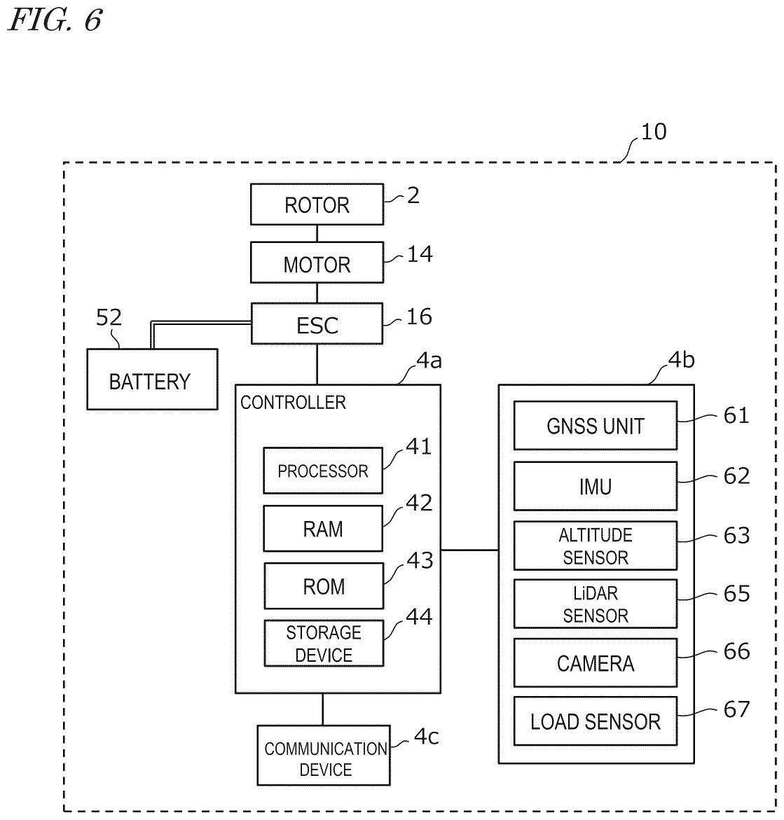

FIG. 6 is a block diagram showing a configuration example of the unmanned aerial vehicle 10. The unmanned aerial vehicle 10 shown in FIG. 6 includes components similar to the unmanned aerial vehicle 10 shown in FIG. 2A. However, in FIG. 6, illustration of the power supply device 76 and the implement 200 shown in FIG. 2A is omitted. In the example shown in FIG. 6, the controller 4a includes a processor 41, RAM 42, ROM 43, and a storage device 44. In FIG. 6, as examples of the sensor group 4b, a GNSS unit 61, an IMU 62, an altitude sensor 63, a LiDAR sensor 65, a camera 66, and a load sensor 67 are shown. Various components of the unmanned aerial vehicle 10 may be connected to communicate with each other via a bus. FIG. 6 shows components that have relatively high relevance to autonomous flight operations by the unmanned aerial vehicle 10, and illustration of other components is omitted.

In FIG. 6, for simplicity, the rotor 2, motor 14, and ESC 16 are each shown by one block, but the numbers of rotors 2, motors 14, and ESCs 16 are each multiple. Also, although not shown in FIG. 6, the unmanned aerial vehicle 10 may include the internal combustion engine 7a, the fuel tank 7b, and the power generation device 8 as shown in FIG. 2B or 2C. Furthermore, as shown in FIG. 2C, it may include at least one rotor 22 driven by the internal combustion engine 7a. The unmanned aerial vehicle 10 may adopt “series hybrid” and “parallel hybrid” drive forms.

The GNSS unit 61 is an example of a positioning device that detects the geographic coordinates of the position of the unmanned aerial vehicle 10. The GNSS receiver included in the GNSS unit 61 receives satellite signals transmitted from multiple GNSS satellites and generates GNSS data based on the satellite signals.

The GNSS unit 61 illustrated in FIG. 6 may perform positioning of the unmanned aerial vehicle 10 using RTK-GNSS. By using RTK-GNSS, positioning can be performed with accuracy of, for example, an error of several centimeters. Position data including information about latitude, longitude, and altitude is acquired by high-precision positioning using RTK-GNSS. The GNSS unit 61 calculates the position of the unmanned aerial vehicle 10, for example, at a frequency of about 1 to 10 times per second.

Note that the positioning method is not limited to RTK-GNSS, and any positioning method (such as interferometric positioning or relative positioning) that can obtain position data with necessary accuracy can be used. For example, positioning using VRS or DGPS may be performed. When position data with necessary accuracy can be obtained without using correction signals transmitted from reference stations, position data may be generated without using correction signals. In that case, the GNSS unit 61 may not include an RTK receiver.

Even when RTK-GNSS is used, in places where correction signals from reference stations cannot be obtained, the position of the unmanned aerial vehicle 10 is estimated by other methods without relying on signals from RTK receivers. For example, the position of the unmanned aerial vehicle 10 may be estimated by matching data output from the LiDAR sensor 65 and/or the camera 66 with high-precision environment maps.

The IMU 62 may include a 3-axis acceleration sensor and a 3-axis gyroscope. The IMU 62 may include an orientation sensor such as a 3-axis geomagnetic sensor. The IMU 62 functions as a motion sensor and can output signals indicating various quantities such as acceleration, velocity, displacement, and attitude of the unmanned aerial vehicle 10. In addition to the satellite signals and correction signals described above, the position and orientation of the unmanned aerial vehicle 10 can be estimated with higher accuracy based on signals output from the IMU 62. Signals output from the IMU 62 can be used for correction or complementation of positions calculated based on satellite signals and correction signals. The IMU 62 outputs signals at a higher frequency than GNSS receivers. Using those high-frequency signals, the position and orientation of the unmanned aerial vehicle 10 can be measured at a higher frequency (for example, 10 Hz or higher). Instead of the IMU 62, a 3-axis acceleration sensor and a 3-axis gyroscope may be provided separately. The IMU 62 may be included in the GNSS unit 61.

The altitude sensor 63 measures the altitude of the body of the unmanned aerial vehicle 10 and outputs a signal indicating the altitude. Altitude refers to the vertical distance between a reference surface (for example, the ground surface) and the body. The altitude sensor 63 may be realized by, for example, a barometer, a GNSS receiver, a distance measurement sensor that measures the distance from the body to the ground, or a combination thereof.

The LiDAR sensor 65 may be a 3D-LiDAR sensor, but may also be a 2D-LIDAR sensor. The LiDAR sensor 65 senses the environment around the unmanned aerial vehicle 10 and outputs sensing data. The LiDAR sensor 65 repeatedly outputs sensor data indicating the distance and direction to each measurement point of objects existing in the surrounding environment, or three-dimensional or two-dimensional coordinate values of each measurement point. Multiple LiDAR sensors 65 may be provided at multiple positions such as front, rear, left, and right of the unmanned aerial vehicle 10. The sensor data output from the LiDAR sensor 65 is processed by the controller 4a. The controller 4a can be configured or programmed to perform self-position estimation of the unmanned aerial vehicle 10 by matching the sensor data with environment maps. The controller 4a can be configured or programmed to further detect objects such as obstacles existing around the unmanned aerial vehicle 10 based on the sensor data. The controller 4a may be configured or programmed to generate or edit environment maps using algorithms such as SLAM.

The camera 66 is an imaging device that captures the environment around the unmanned aerial vehicle 10. The camera 66 includes, for example, an image sensor such as a CCD or CMOS. The camera 66 may also include an optical system including one or more lenses and a signal processing circuit. The camera 66 captures the environment around the unmanned aerial vehicle 10 during flight of the unmanned aerial vehicle 10 and generates data of images (for example, moving images). The camera 66 can capture moving images at a frame rate of, for example, 3 fps or higher. Images generated by the camera 66 may be used, for example, when a remote monitor uses the terminal device 400 to check the environment around the unmanned aerial vehicle 10. Images generated by the camera 66 may be used for positioning or obstacle detection. Multiple cameras 66 may be provided at different positions of the unmanned aerial vehicle 10, or a single camera may be provided. A visible camera that generates visible light images and an infrared camera that generates infrared images may be provided separately. Both visible cameras and infrared cameras may be provided as cameras that generate images for monitoring. Infrared cameras can also be used for obstacle detection at night.

The load sensor 67 detects the weight of objects connected to the unmanned aerial vehicle 10, such as the implement 200. The controller 4a can be configured or programmed to determine whether the weight of objects connected to the unmanned aerial vehicle 10 is appropriate by comparing, for example, the weight of objects connected to the unmanned aerial vehicle 10 with the maximum payload of the unmanned aerial vehicle 10. Also, the controller 4a can be configured or programmed to calculate the consumption of electric power and/or fuel used for flight based on the weight of objects connected to the unmanned aerial vehicle 10.

The processor 41 may be a semiconductor integrated circuit including, for example, a central processing unit (CPU). The ROM 43 is, for example, a writable memory (for example, PROM), a rewritable memory (for example, flash memory), or a read-only memory. The RAM 42 provides a work area for temporarily expanding control programs stored in the ROM 43 during boot-up. The detailed configurations of the processor 41, the RAM 42, and the ROM 43 are similar to those of the processor 161, the RAM 162, and the ROM 163, so detailed descriptions thereof are omitted here. The processor 41 may be configured or programmed to operate as the flight controller and companion computer described above.

The storage device 44 includes one or more storage media such as flash memory or magnetic disks. The storage device 44 stores various data generated by the sensor group 4b and the controller 4a. The data stored by the storage device 44 may include map data (environment maps) of environments where the unmanned aerial vehicle 10 flies, and data of target flight routes for autonomous flight. Environment maps include information about multiple fields where the unmanned aerial vehicle 10 performs work and their surroundings. Environment maps and target flight routes may be generated by a processor of the management device 600. Note that the controller 4a may have functions to generate or edit environment maps and target flight routes. The controller 4a can be configured or programmed to edit environment maps and target flight routes acquired from the management device 600 according to the flight environment of the unmanned aerial vehicle 10. The storage device 44 also stores data of work plans that the communication device 4c receives from the management device 600.

The storage device 44 also stores computer programs that cause the processor 41 to execute various operations described later. Such computer programs may be provided to the unmanned aerial vehicle 10 via storage media (such as semiconductor memory or optical disks) or telecommunication lines (such as the Internet). Such computer programs may be sold as commercial software.

The communication device 4c is a device including circuits that communicate with the harvester 100, the terminal device 400, and the management device 600. The communication device 4c includes circuits that perform wireless communication with the communication device 190 of the harvester 100. This enables causing the harvester 100 to execute desired operations or acquiring information from the harvester 100. The communication device 4c may further include antennas and communication circuits for executing signal transmission and reception via the network 80 with each of the communication devices of the terminal device 400 and the management device 600. The communication device 4c may have a function to communicate with portable terminals used by monitors near the unmanned aerial vehicle 10. Communication with such portable terminals may be performed according to any wireless communication standard such as Wi-Fi (registered trademark), cellular mobile communication such as 3G, 4G, or 5G, or Bluetooth (registered trademark).

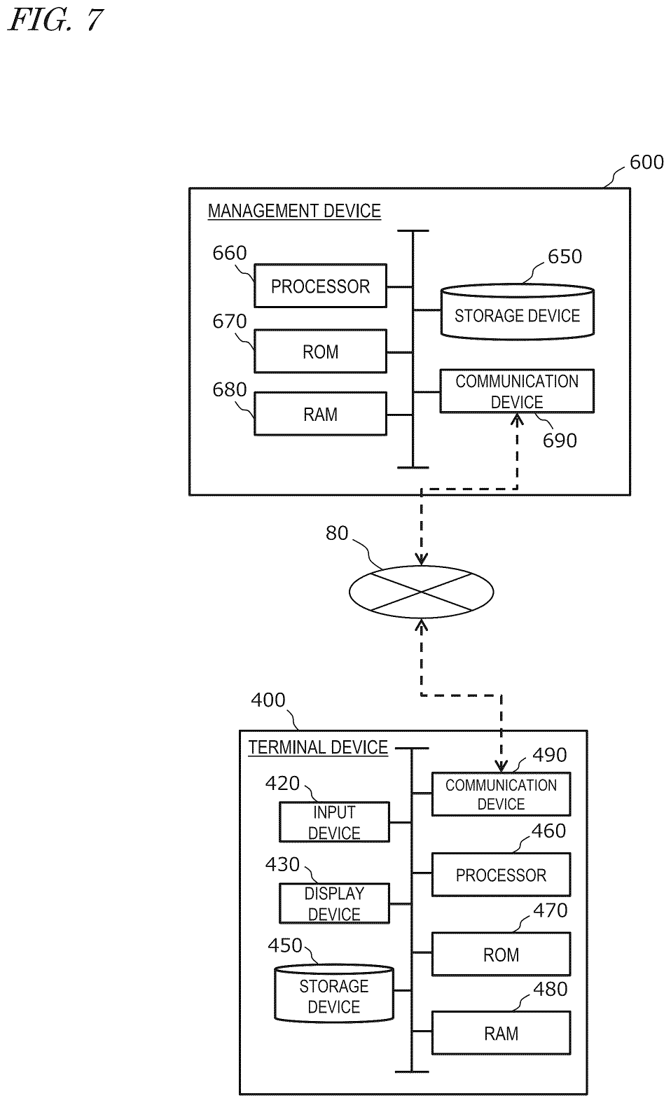

Next, the configurations of the management device 600 and the terminal device 400 will be described with reference to FIG. 7. FIG. 7 is a block diagram showing configuration examples of the management device 600 and the terminal device 400.

The management device 600 includes a storage device 650, a processor 660, ROM 670, RAM 680, and a communication device 690. These components are connected to communicate with each other via a bus. The management device 600 may be configured or programmed to function as a cloud server that performs schedule management of agricultural work executed by the harvester 100 and the unmanned aerial vehicle 10 and supports agriculture by utilizing data to be managed. A user can input information necessary for creating work plans using the terminal device 400 and upload this information to the management device 600 via the network 80. The management device 600 can be configured or programmed to create work plans, that is, schedules for agricultural work, based on this information. The management device 600 can be configured or programmed to further execute generation or editing of environment maps. Environment maps may be distributed from computers external to the management device 600.

The communication device 690 is a communication module configured or programmed to communicate with the harvester 100, the unmanned aerial vehicle 10, and the terminal device 400 via the network 80. The communication device 690 can be configured or programmed to perform wired communication according to communication standards such as IEEE 1394 (registered trademark) or Ethernet (registered trademark). The communication device 690 may be configured or programmed to perform wireless communication according to Bluetooth (registered trademark) standards or Wi-Fi standards, or cellular mobile communication such as 3G, 4G, or 5G.

The processor 660 may be a semiconductor integrated circuit including, for example, a central processing unit (CPU). The ROM 670 is, for example, a writable memory (for example, PROM), a rewritable memory (for example, flash memory), or a read-only memory. The RAM 680 provides a work area for temporarily expanding control programs stored in the ROM 670 during boot-up. The detailed configurations of the processor 660, the ROM 670, and the RAM 680 are similar to those of the processor 161, the ROM 163, and the RAM 162, so detailed descriptions are omitted here.

The storage device 650 mainly functions as database storage. The storage device 650 may be, for example, a magnetic storage device or a semiconductor storage device. The storage device 650 may be a device independent of the management device 600. For example, the storage device 650 may be a storage device connected to the management device 600 via the network 80, such as cloud storage.

The terminal device 400 includes an input device 420, a display device 430, a storage device 450, a processor 460, ROM 470, RAM 480, and a communication device 490. These components are connected to communicate with each other via a bus. The input device 420 is a device for converting instructions from a user into data and inputting them to a computer. The input device 420 may be, for example, a keyboard, mouse, or touch panel. The display device 430 may be, for example, a liquid crystal display or organic EL display. The descriptions of each of the processor 460, the ROM 470, the RAM 480, the storage device 450, and the communication device 490 are as described in the hardware configuration examples of the harvester 100, the unmanned aerial vehicle 10, and the management device 600, and those descriptions are omitted.

Next, operations for acquiring harvested crops that the harvester 100 has harvested from a field using the unmanned aerial vehicle 10 will be described.

In the present example embodiment, an acquisition device usable to acquire harvested crops is connected to the unmanned aerial vehicle 10 and is movable together with the unmanned aerial vehicle 10, and the acquisition device includes used to acquire harvested crops. The acquisition device may be an example of the implement 200.

The acquisition device may be detachable from the unmanned aerial vehicle 10 or may be configured integrally with the body of the unmanned aerial vehicle 10. The operation of the acquisition device may be controlled by the controller 4a of the unmanned aerial vehicle 10. Communication between the unmanned aerial vehicle 10 and the acquisition device may be performed by wire or wirelessly. Electric power necessary for the operation of the acquisition device may be supplied from the unmanned aerial vehicle 10 to the acquisition device via the power supply device 76, or the acquisition device may be including a battery. The acquisition device may include a controller configured or programmed to control the operation of the acquisition device, and in that case, the controller 4a controls the operation of the acquisition device by communicating with the controller of the acquisition device.

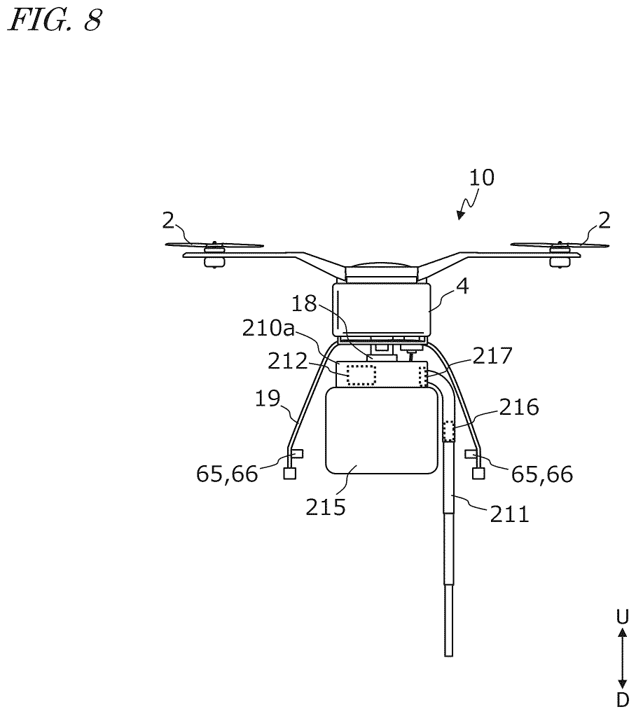

FIG. 8 is a diagram schematically showing an example of the unmanned aerial vehicle 10 to which an acquisition device includes connected. In the example shown in FIG. 8, the acquisition device includes a suction machine 210a. The suction machine 210a acquires harvested crops stored in the tank 106 of the harvester 100 by suction. The harvested crops are, for example, grains. By suctioning harvested crops, the harvested crops can be transferred from the harvester 100 to the unmanned aerial vehicle 10 side.

In the example shown in FIG. 8, the unmanned aerial vehicle 10 is provided with a connection device 18, and the suction machine 210a is connected to the connection device 18. The method of connecting the suction machine 210a to the connection device 18 is arbitrary. For example, the suction machine 210a may be connected to the connection device 18 using a link mechanism, or the suction machine 210a may be connected to the connection device 18 using fasteners such as bolts.

The suction machine 210a includes a nozzle 211, a suction blower 212, and a tank 215. The suction blower 212 is sometimes called a suction pump. The unmanned aerial vehicle 10 is flown so that the tip of the nozzle 211 is positioned inside the tank 106 of the harvester 100, and the suction blower 212 is operated to suction harvested crops inside the tank 106. Harvested crops can be acquired by storing the suctioned harvested crops in the tank 215.

The suction machine 210a is, for example, a centrifugal separation type suction machine. The centrifugal separation method is sometimes called the cyclone method. Since the technology for separating suctioned harvested crops and air by the centrifugal separation method is known, detailed description is omitted here. A suction machine adopting methods other than the centrifugal separation method may be used as the suction machine 210a.

The nozzle 211 can be extended and retracted by operating an actuator 216. Also, the orientation of the nozzle 211 can be changed by operating an actuator 217. For example, when landing the unmanned aerial vehicle 10 on the ground, by shortening the length of the nozzle 211 and directing the direction in which the nozzle 211 extends to a direction close to horizontal, interference of the nozzle 211 with the ground can be reduced or prevented.

The LiDAR sensor 65 and the camera 66 are arranged at positions where monitoring of harvested crop acquisition work using the acquisition device can be easily performed. In this example, the LiDAR sensor 65 and the camera 66 are provided on the skid 19 of the unmanned aerial vehicle 10. The LiDAR sensor 65 and the camera 66 used to control the flight of the unmanned aerial vehicle 10 may be provided separately from these. Also, the LiDAR sensor 65 and the camera 66 may be provided in the acquisition device.

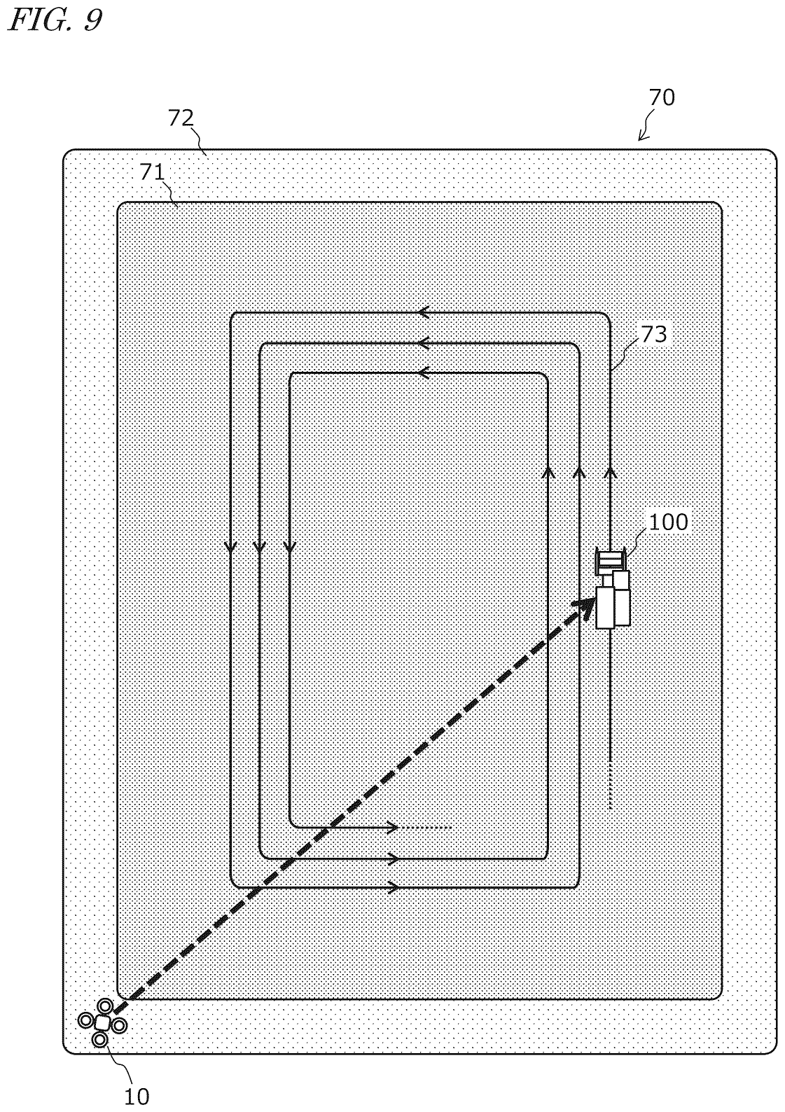

FIG. 9 is a diagram showing the field 70 where the harvester 100 harvests crops. The harvester 100 of the present example embodiment harvests crops while traveling automatically in the field 70. Within the field 70, the harvester 100 executes crop harvesting operations while traveling along a preset target route 73. Within the field 70, positioning of the harvester 100 is mainly performed based on data output from the GNSS unit 121. In addition to positioning data output from the GNSS unit 121, the position of the harvester 100 may be estimated based on data output from the LiDAR sensor 125 and/or the camera 126.

In the example shown in FIG. 9, the field 70 includes a work area 71 where the harvester 100 performs crop harvesting and a headland 72 located near the outer periphery of the field 70. Which areas of the field 70 on the map correspond to the work area 71 and the headland 72 may be set in advance by a user. The harvester 100 automatically travels from the work start point to the work end point along the target route 73 as shown in FIG. 9. Note that the target route 73 shown in FIG. 9 is merely an example, and the method of determining the target route 73 is arbitrary. The target route 73 may be created based on user operations or may be created automatically. The target route 73 may be created, for example, to cover the entire work area 71 within the field 70.

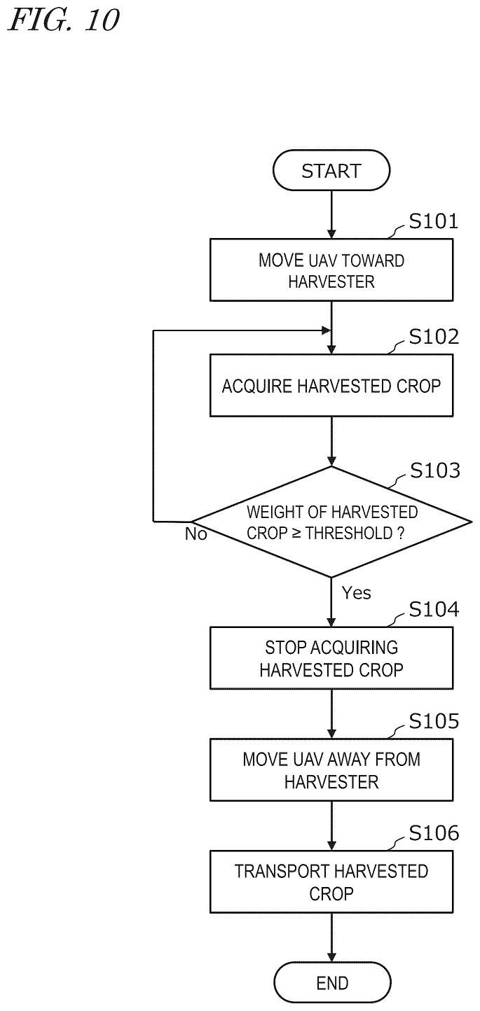

In the present example embodiment, harvested crops that the harvester 100 has harvested from the field 70 are acquired using the unmanned aerial vehicle 10. FIG. 10 is a flowchart showing an example of operations for acquiring harvested crops that the harvester 100 has harvested from the field 70 using the unmanned aerial vehicle 10.

The harvester 100 harvests crops while traveling automatically along the target route 73. The processor 161 (FIG. 5) of the harvester 100 is configured or programmed to cause the ECU 165 to execute control to cause the harvester 100 to travel automatically along the target route 73, and cause the ECU 167 to execute control of crop harvesting operations. The ECU 165 controls the operation of the driving device 140 to cause the harvester 100 to travel automatically. The ECU 167 controls the operation of the power transmission mechanism 141 to cause various devices that perform crop harvesting operations to execute desired operations. The cutting device 103 cuts crops in the field 70. The threshing device 105 performs threshing of cut crops. The tank 106 stores harvested crops obtained by threshing grains, etc. The straw processing device 108 finely cuts stem parts, etc., after grains and other harvested crops have been removed and discharges them to the outside.

The processor 41 (FIG. 6) of the unmanned aerial vehicle 10 is configured or programmed to control the operation of the flight device 1 (FIG. 1) to cause the unmanned aerial vehicle 10 to fly. The processor 41 is configured or programmed to cause the unmanned aerial vehicle 10 to fly so as to approach the harvester 100 (step S101 in FIG. 10).

The unmanned aerial vehicle 10 and the harvester 100 perform data communication with each other via the communication device 4c and the communication device 190. The processor 161 of the harvester 100 is configured or programmed to transmit information about the geographic coordinates of the position of the harvester 100 acquired from the GNSS unit 121 to the unmanned aerial vehicle 10 via the communication device 190.

The processor 41 of the unmanned aerial vehicle 10 is configured or programmed to set the geographic coordinate position of the harvester 100 as a target position. Since the position of the traveling harvester 100 changes, the target position is updated as needed. The processor 41 is configured or programmed to cause the unmanned aerial vehicle 10 to fly to reach the latest target position. The target position may be set based on the geographic coordinates of the harvester 100, the traveling direction and traveling speed of the harvester 100. The processor 41 is configured or programmed to cause the unmanned aerial vehicle 10 to fly so as to be positioned above the harvester 100.

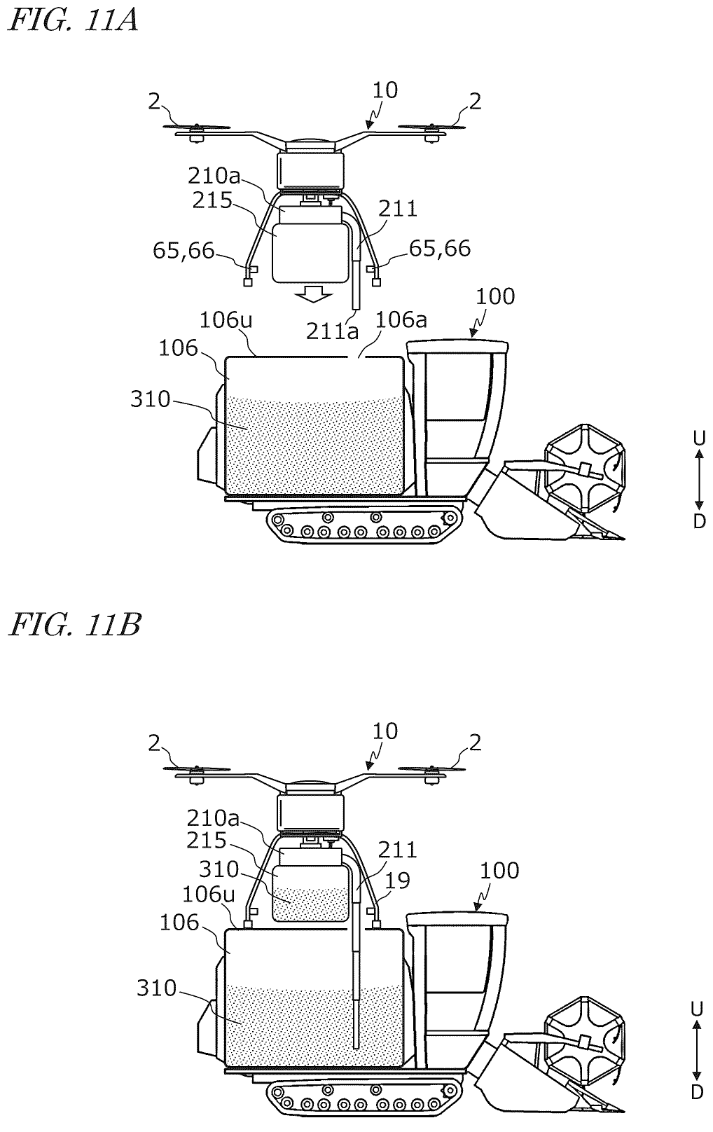

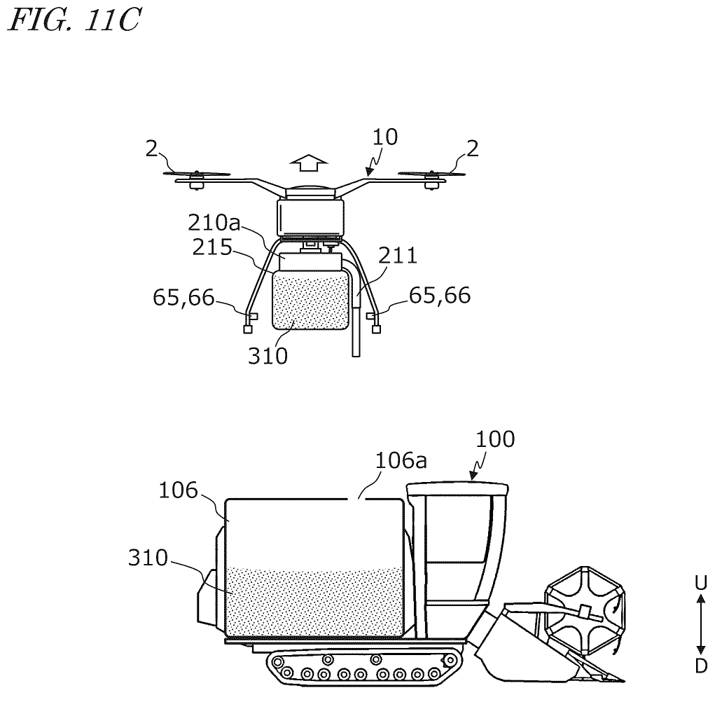

FIGS. 11A to 11C are diagrams showing examples of operations for acquiring harvested crops stored in the tank 106 of the harvester 100 using the unmanned aerial vehicle 10. For ease of explanation, in FIGS. 11A to 11C, the interiors of the tanks 106 and 215 are shown transparently.

As shown in FIG. 11A, an opening 106a is provided in the upper portion 106u of the tank 106 of the harvester 100. By inserting the nozzle 211 of the suction machine 210a into the opening 106a, harvested crops stored in the tank 106 can be suctioned. The processor 41 is configured or programmed to cause the unmanned aerial vehicle 10 to fly so that the tip (lower end) 211a of the nozzle 211 is positioned inside the tank 106. The processor 41 is configured or programmed to perform position alignment between the nozzle 211 and the opening 106a using output signals from the LiDAR sensor 65 and/or the camera 66.

The processor 41, for example, is configured or programmed to identify point cloud data representing the opening 106a and point cloud data representing the nozzle 211 from three-dimensional point cloud data output by the LiDAR sensor 65 using an estimation model generated by machine learning. The estimation model is stored in advance in the storage device 44.

The processor 41 can insert the nozzle 211 into the opening 106a by causing the unmanned aerial vehicle 10 to fly so that the tip 211a of the nozzle 211 is positioned within the range of the opening 106a in plan view from a direction along the vertical direction, while causing the unmanned aerial vehicle 10 to descend.

The processor 41 may cause the nozzle 211 to be inserted into the opening 106a using data output by the camera 66 that captures the nozzle 211 and the opening 106a. The processor 41, for example, identifies images representing the opening 106a and images representing the nozzle 211 from image data output by the camera 66 using an estimation model generated by machine learning. The processor 41 can insert the nozzle 211 into the opening 106a by causing the unmanned aerial vehicle 10 to fly so that the tip 211a of the nozzle 211 is positioned within the range of the opening 106a in plan view, while causing the unmanned aerial vehicle 10 to descend.

FIG. 11B is a diagram showing an operation where the suction machine 210a suctions harvested crops 310 stored in the tank 106 of the harvester 100.

The processor 41 can adjust the length of the nozzle 211 by operating the actuator 216 (FIG. 8). The processor 41 operates the suction blower 212 to start suctioning the harvested crops 310 inside the tank 106 (step S102 in FIG. 10). The harvested crops 310 are transferred from the tank 106 to the suction machine 210a through the nozzle 211. The suctioned harvested crops 310 are stored in the tank 215. By inserting the nozzle 211 into the tank 106 and suctioning the harvested crops 310, the harvested crops 310 can be easily transferred from the harvester 100 to the unmanned aerial vehicle 10 side.

When acquiring the harvested crops 310 inside the tank 106, the unmanned aerial vehicle 10 may be landed on the harvester 100. For example, the unmanned aerial vehicle 10 is landed on the upper portion 106u of the tank 106. This can reduce or prevent positional deviation between the unmanned aerial vehicle 10 and the harvester 100, enabling stable performance of harvested crop 310 acquisition operations. In this case, the rotors 2 may be rotated to generate lift to the extent that the unmanned aerial vehicle 10 does not rise. By generating such lift, the magnitude of the weight of the unmanned aerial vehicle 10 applied to the harvester 100 during landing can be reduced.

While operating the suction machine 210a to suction the harvested crops 310 inside the tank 106, the processor 41 may rotate the rotors 2 to generate lift according to the suction force of the suction machine 210a. Although a downward force acts on the unmanned aerial vehicle 10 due to the reaction of the suction operation of the suction machine 210a, such downward force can be offset by generating lift with the rotors 2.

The unmanned aerial vehicle 10 may include a connection device that connects the unmanned aerial vehicle 10 to the harvester 100 when acquiring the harvested crops 310 from the harvester 100. This can reduce or prevent positional deviation between the unmanned aerial vehicle 10 and the harvester 100, enabling stable harvested crop acquisition. For example, the skid 19 is used as such a connection device. For example, the upper portion 106u of the tank 106 may have a magnetic material, and the skid 19 may include an electromagnet at its lower portion. By turning on the electromagnet, the processor 41 connects the skid 19 and the tank 106. Also, each of the skid 19 and the tank 106 may include connection devices that connect to each other. Also, as a connection device, the nozzle 211 may include a “barb” that spreads approximately horizontally. For example, the barb can be opened and closed in an umbrella shape inside the tank 106, and the nozzle 211 includes an actuator that opens and closes the barb. The horizontal length of the opened barb is larger than the diameter of the opening 106a, and can prevent the nozzle 211 from coming out of the tank 106. In cases where the harvested crops 310 are acquired while flying the unmanned aerial vehicle 10, the connection between the unmanned aerial vehicle 10 and the harvester 100 can be maintained.

The processor 41 can detect the weight of the harvested crops 310 stored in the tank 215 using the load sensor 67 (FIG. 6). The load sensor 67 is provided, for example, in the connection device 18 and detects the weight of the suction machine 210a in which the tank 215 is provided. By comparing the weight of the suction machine 210a when the tank 215 is empty with the weight of the suction machine 210a when the harvested crops 310 are stored in the tank 215, the weight of the harvested crops 310 stored in the tank 215 can be calculated.

The weight of the harvested crops 310 stored in the tank 215 may be detected using a load sensor provided in the tank 215.

While the suction machine 210a is suctioning the harvested crops 310, the processor 41 determines whether the weight value of the harvested crops accumulated in the tank 215 is equal to or greater than a first predetermined value (step S103 in FIG. 10). The first predetermined value is, for example, about 80-100% of the maximum weight of the harvested crops 310 that can be stored in the tank 215, but is not limited to that value.

The first predetermined value may be set based on the weight (payload) that the unmanned aerial vehicle 10 can transport. Also, the first predetermined value may be set based on the remaining amount of energy sources for flying the unmanned aerial vehicle 10. The remaining amount of energy sources for flying the unmanned aerial vehicle 10 is, for example, the remaining amount of the battery 52 (FIG. 2A) and/or the remaining amount of fuel in the fuel tank 7b (FIG. 2B).

While the weight of harvested crops accumulated in the tank 215 is less than the first predetermined value, the processor 41 continues suctioning of the harvested crops 310 by the suction machine 210a. When the processor 41 determines that the weight of harvested crops accumulated in the tank 215 has become equal to or greater than the first predetermined value, it stops the operation of the suction blower 212 and stops suctioning of the harvested crops 310 by the suction machine 210a (step S104).

The processor 41 may be configured or programmed to control the on/off of the suction operation of the suction machine 210a by comparing the weight of the suction machine 210a in which the tank 215 is provided with the maximum payload of the unmanned aerial vehicle 10. For example, when the weight of the suction machine 210a that performs the operation of suctioning the harvested crops 310 and accumulating them in the tank 215 reaches about 80-100% of the maximum payload, suctioning of the harvested crops 310 by the suction machine 210a may be stopped.

When acquisition of the harvested crops 310 by the suction machine 210a is completed, the processor 41 causes the unmanned aerial vehicle 10 to separate from the harvester 100 (step S105). FIG. 11C is a diagram showing the unmanned aerial vehicle 10 separating from the harvester 100. The processor 41 causes the unmanned aerial vehicle 10 to separate from the harvester 100 by causing the unmanned aerial vehicle 10 to rise above the harvester 100.

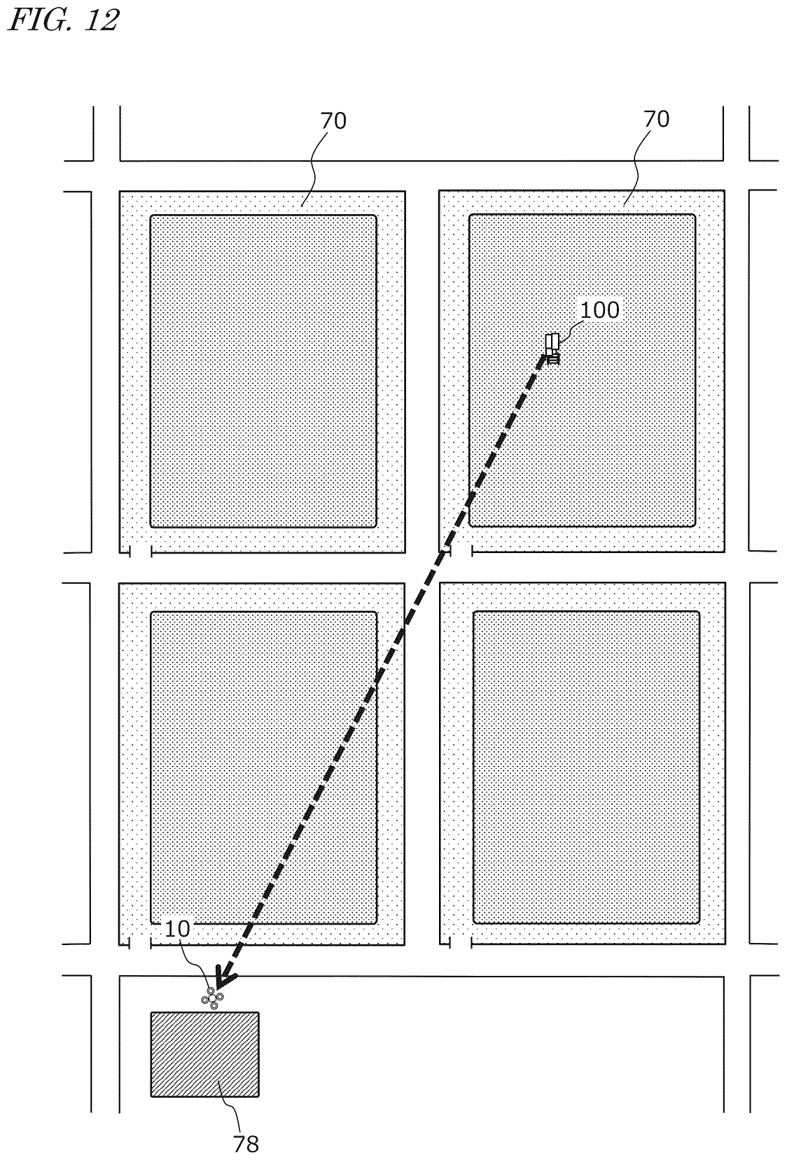

After causing the unmanned aerial vehicle 10 to separate from the harvester 100, the processor 41 causes the unmanned aerial vehicle 10 to transport the harvested crops to a predetermined location (step S106). For example, the processor 41 moves the unmanned aerial vehicle 10 to a building that stores harvested crops. FIG. 12 is a diagram showing the unmanned aerial vehicle 10 moving to a storage facility 78 that stores harvested crops. The processor 41 sets the geographic coordinate position of the storage facility 78 or its surrounding area as a target position. The processor 41 causes the unmanned aerial vehicle 10 to fly to reach the set target position. When the unmanned aerial vehicle 10 arrives at the storage facility 78 or its surrounding area, the harvested crops in the tank 215 are transferred to the storage facility 78. The unmanned aerial vehicle 10 with the empty tank 215 may return to the field 70 again to resume work of acquiring harvested crops.

The above-described operation where the unmanned aerial vehicle 10 acquires harvested crops can be performed even while the harvester 100 is moving. By having the unmanned aerial vehicle 10 acquire harvested crops from the harvester 100 that continues harvesting work while moving, work efficiency can be improved.

In the operation of acquiring harvested crops from the harvester 100, when the weight value of harvested crops accumulated in the tank 106 of the harvester 100 is less than a second predetermined value, the processor 41 may perform control to cause the unmanned aerial vehicle 10 to standby at a predetermined position.

The predetermined position where the unmanned aerial vehicle 10 stands by can be set at any position that does not interfere with harvesting work by the harvester 100. As long as it does not interfere with harvesting work by the harvester 100, the predetermined position may be set at a position within the work area 71 where harvesting work has already been completed. Also, the predetermined position may be set at a position outside the field 70.

When the harvester 100 is performing crop harvesting, the processor 161 determines whether the weight of harvested crops accumulated in the tank 106 is equal to or greater than a second predetermined value. For example, the processor 161 determines whether the weight value of harvested crops in the tank 106 detected by the load sensor 156 is equal to or greater than the second predetermined value. The second predetermined value is, for example, about 50-90% of the maximum weight of harvested crops that can be stored in the tank 106, but is not limited to that value.

While the harvested crops accumulated in the tank 106 are less than the second predetermined value, the processor 161 does not transmit a command to fly the unmanned aerial vehicle 10 to the position of the harvester 100 to the unmanned aerial vehicle 10. The processor 41 causes the unmanned aerial vehicle 10 to standby at the predetermined position while not receiving the command.

When the processor 161 determines that the weight of harvested crops accumulated in the tank 106 has become equal to or greater than the second predetermined value, it transmits a command to fly the unmanned aerial vehicle 10 to the position of the harvester 100 to the unmanned aerial vehicle 10 via the communication device 190. When the processor 41 receives the command, it causes the unmanned aerial vehicle 10 to fly to the position of the harvester 100 and performs operations to acquire harvested crops stored in the tank 106 of the harvester 100. By having the unmanned aerial vehicle 10 acquire harvested crops when a predetermined amount or more of harvested crops have accumulated in the harvester 100, work efficiency can be improved.

The unmanned aerial vehicle 10 may receive data indicating the weight of harvested crops accumulated in the tank 106 of the harvester 100, and the processor 41 of the unmanned aerial vehicle 10 may determine whether the weight of harvested crops accumulated in the tank 106 has become equal to or greater than the second predetermined value. When the processor 41 determines that the weight of harvested crops accumulated in the tank 106 has become equal to or greater than the second predetermined value, it causes the unmanned aerial vehicle 10 to fly to the position of the harvester 100 and performs operations to acquire harvested crops stored in the tank 106 of the harvester 100.

To efficiently harvest crops in the field 70, it is conceivable to run a harvester 100 that harvests crops while traveling within the field 70 in parallel with a transport vehicle, and have the transport vehicle receive harvested crops discharged by the harvester 100 and accumulate them in the cargo bed of the transport vehicle. This enables the harvester 100 to transfer harvested crops to the transport vehicle while performing crop harvesting. Since there is no need to interrupt harvesting work to transfer harvested crops accumulated in the harvester 100 to a transport vehicle waiting at the outer periphery of the field 70, crop harvesting can be performed efficiently. However, this method requires securing a ground surface within the field 70 where a transport vehicle can run in parallel with the harvester 100, and depending on the field 70, securing such a ground surface may not be easy.

According to the present example embodiment, the unmanned aerial vehicle 10 acquires harvested crops that the harvester 100 has harvested. The unmanned aerial vehicle 10 can acquire harvested crops from the harvester 100 without landing on the ground. Also, for example, the unmanned aerial vehicle 10 can acquire harvested crops from a position above the harvester 100. Since there is no need to secure a ground surface for running a transport vehicle in parallel with the harvester 100, crop harvesting can be performed easily and efficiently.

Next, another example of an acquisition device usable to acquire harvested crops will be described.

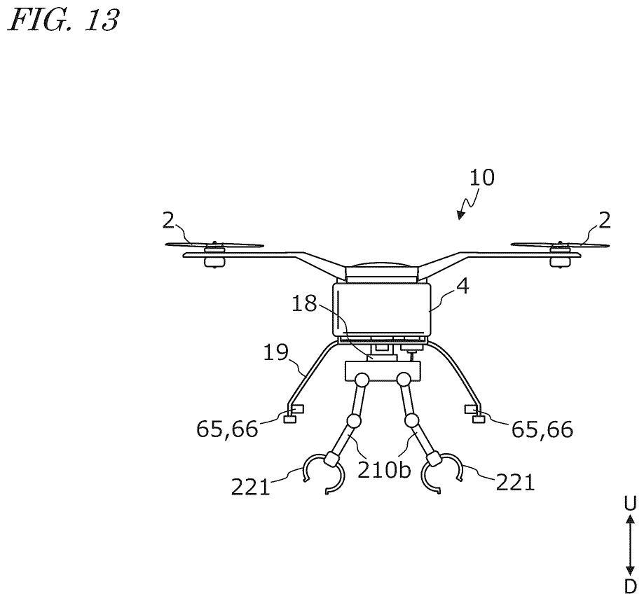

FIG. 13 is a diagram schematically showing another example of the unmanned aerial vehicle 10 to which an acquisition device includes connected. In the example shown in FIG. 13, the acquisition device includes a robot arm 210b. The robot arm 210b includes a gripper 221. The robot arm 210b includes multiple actuators, and by driving these actuators, the joint portions of the robot arm 210b can be moved and objects can be grasped by the gripper 221. The number of robot arms 210b connected to the unmanned aerial vehicle 10 is arbitrary and may be one or three or more.

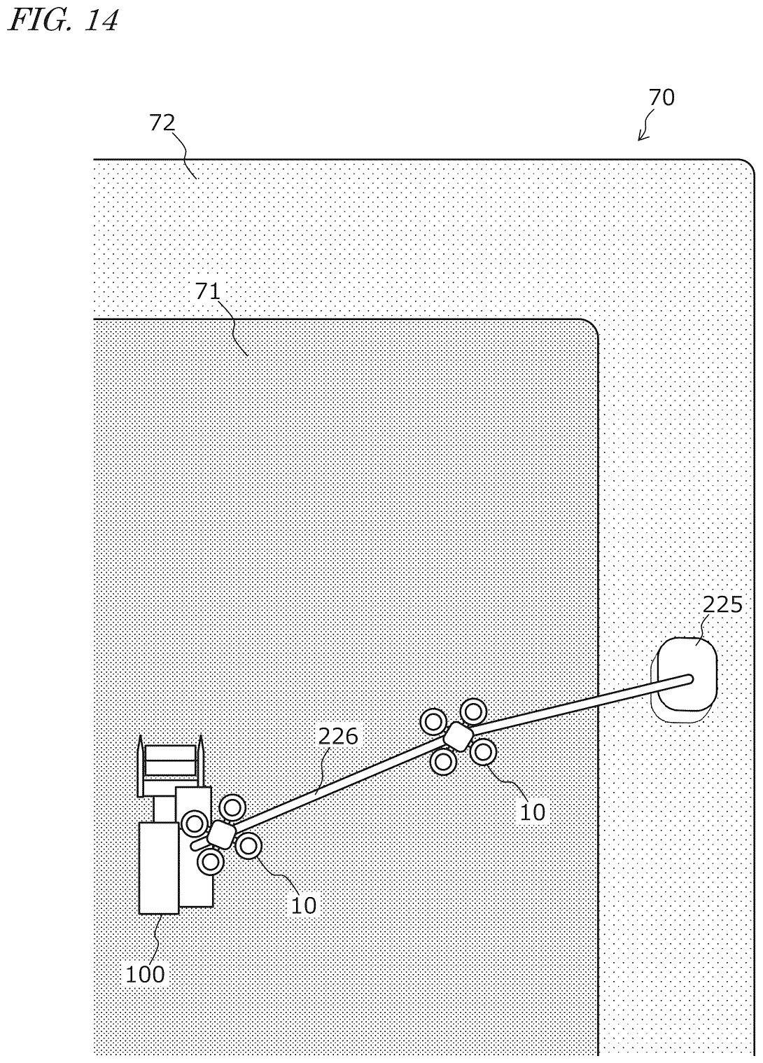

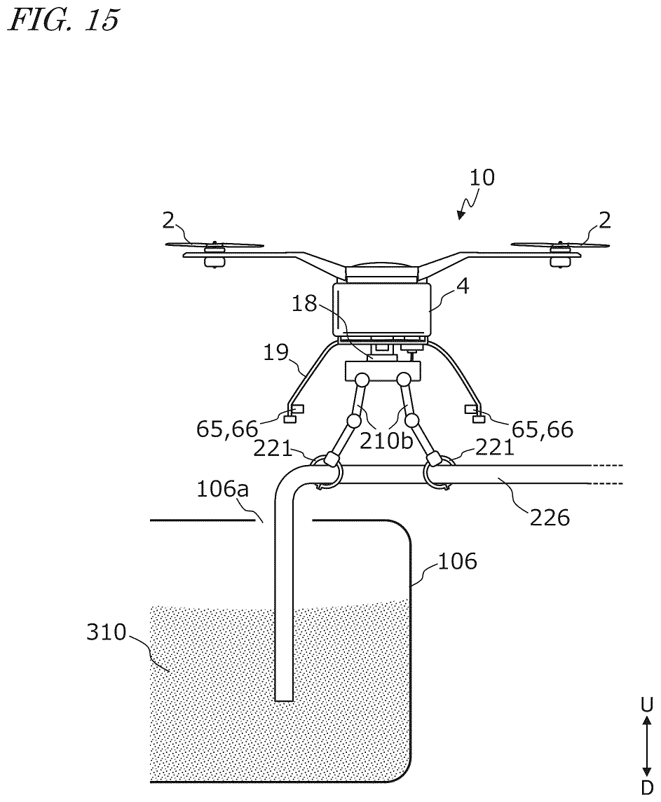

The gripper 221, for example, grips a vacuum hose extending from a suction machine placed outside the field 70 or within the field 70. FIG. 14 is a diagram showing a vacuum hose 226 extending from a suction machine 225 placed within the field 70, and the unmanned aerial vehicle 10 supporting the vacuum hose 226. FIG. 15 is a diagram showing the unmanned aerial vehicle 10 flying so that the end of the vacuum hose 226 gripped by the gripper 221 is positioned inside the tank 106 of the harvester 100.

Support of the vacuum hose 226 may be performed cooperatively by two or more unmanned aerial vehicles 10, or may be performed by one unmanned aerial vehicle 10. By having two or more unmanned aerial vehicles 10 cooperatively support the vacuum hose 226, support of the vacuum hose 226 can be performed stably.

As shown in FIG. 15, the processor 41 of the unmanned aerial vehicle 10 causes the unmanned aerial vehicle 10 to fly so that the end of the vacuum hose 226 gripped by the gripper 221 is positioned inside the tank 106 of the harvester 100. In this state, by having the suction machine 225 perform suction operations, the harvested crops 310 inside the tank 106 are suctioned and transferred from the harvester 100 to the suction machine 225 through the vacuum hose 226. In this example, harvested crops 310 can be transferred to the suction machine 225 placed at a position away from the harvester 100. By suctioning harvested crops 310 from the harvester 100 that is performing crop harvesting using the vacuum hose 226, crop harvesting can be performed efficiently.

The gripper 221 of the robot arm 210b may grip a discharge hose extending from the harvester 100.

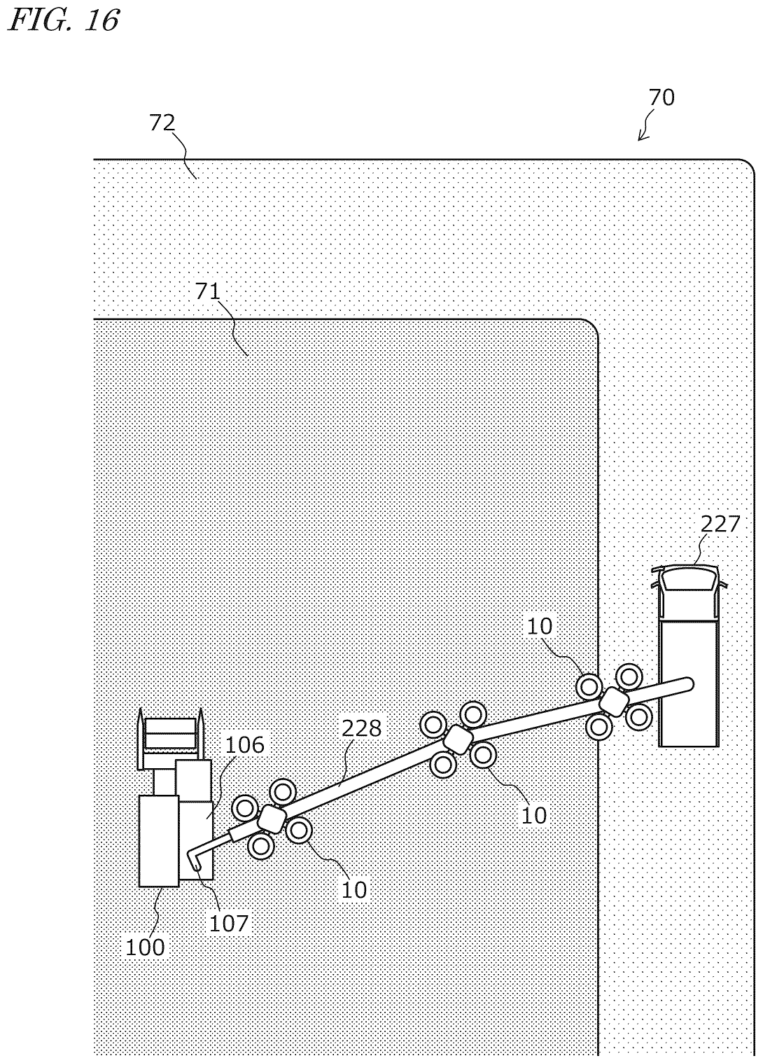

FIG. 16 is a diagram showing a discharge hose 228 extending from the harvester 100, and the unmanned aerial vehicle 10 supporting the discharge hose 228. Support of the discharge hose 228 may be performed cooperatively by two or more unmanned aerial vehicles 10, or may be performed by one unmanned aerial vehicle 10. By having two or more unmanned aerial vehicles 10 cooperatively support the discharge hose 228, support of the discharge hose 228 can be performed stably.

In the example shown in FIG. 16, the harvester 100 includes a discharge device 107 that discharges harvested crops from the tank 106. The discharge device 107 includes, for example, a conveying device such as a screw conveyor, and can move harvested crops inside the tank 106 upward and discharge the harvested crops to the outside. The discharge device 107 can perform lifting and rotating operations. Since a discharge device used in known harvesters can be adopted as the discharge device 107, detailed description thereof is omitted here. In this example, one end of the discharge hose 228 is connected to a discharge port at the tip of the discharge device 107.

The processor 41 of the unmanned aerial vehicle 10 is configured or programmed to cause the unmanned aerial vehicle 10 to fly so that the position of the other end of the discharge hose 228 gripped by the gripper 221 is at the position of the cargo bed of a transport vehicle 227 placed outside the field 70 or within the field 70.

In this state, by having the discharge device 107 perform harvested crop discharge operations, harvested crops inside the tank 106 are discharged and transferred from the harvester 100 to the transport vehicle 227 through the discharge hose 228. In this example, harvested crops can be transferred to the transport vehicle 227 placed at a position away from the harvester 100. By transferring harvested crops discharged from the harvester 100 that is performing crop harvesting using the discharge hose 228, crop harvesting can be performed efficiently.

Instead of the transport vehicle 227, a container may be placed outside the field 70 or within the field 70, and harvested crops may be transferred to that container. Also, a discharge device that discharges harvested crops from the tank 106 may be arranged adjacent to the harvester 100 as a separate body from the harvester 100.

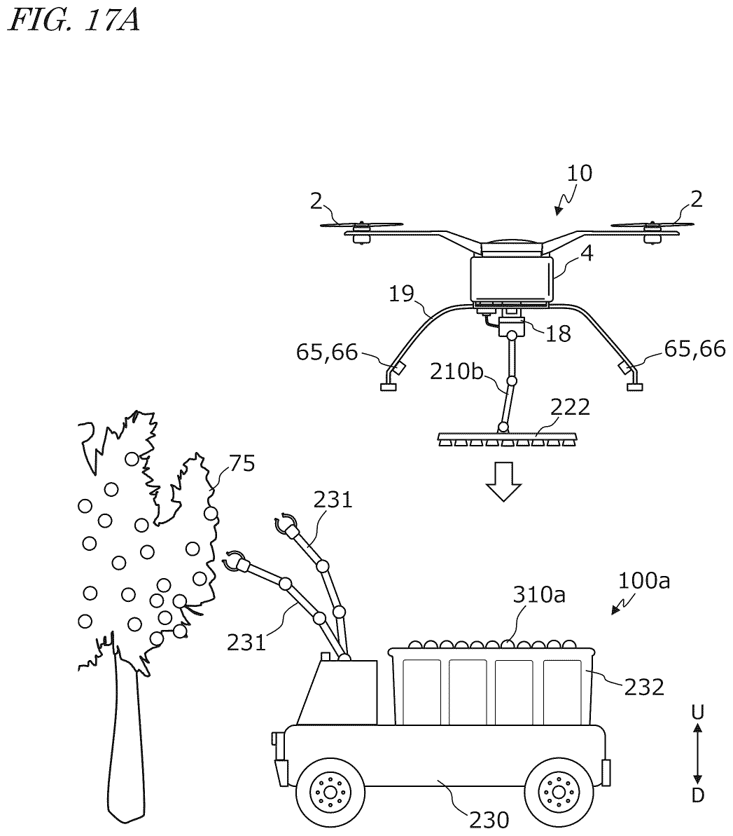

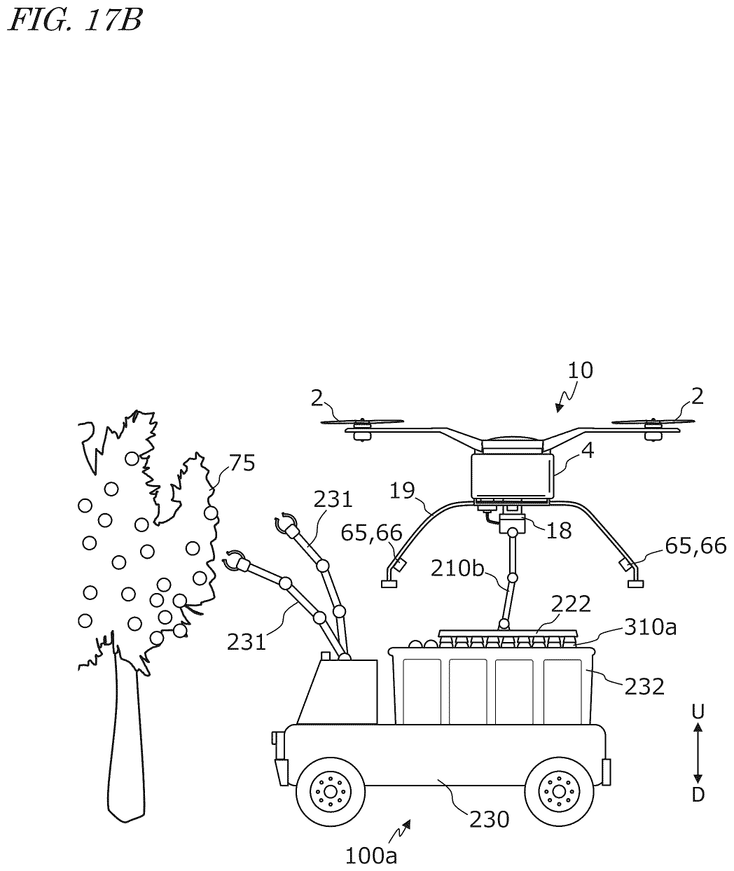

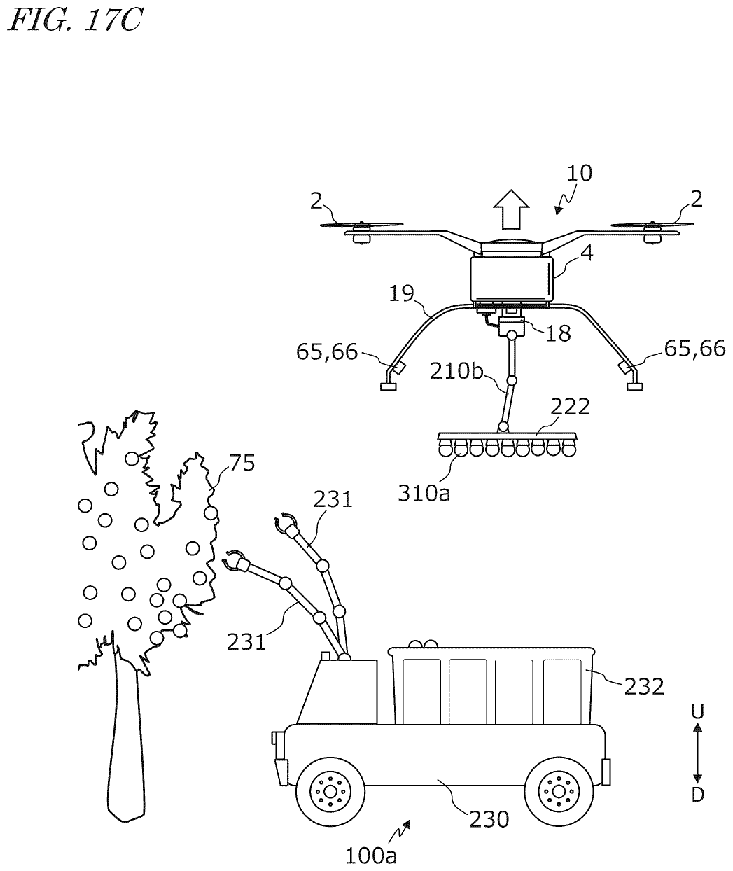

The robot arm 210b connected to the unmanned aerial vehicle 10 may include a vacuum gripper. FIGS. 17A to 17C are diagrams showing examples of operations for acquiring harvested crops 310a stored in a container 232 of a harvester 100a using the unmanned aerial vehicle 10. In this example, the robot arm 210b includes a vacuum gripper 222. Control of the operations of the robot arm 210b and the vacuum gripper 222 may be performed by the processor 41 of the unmanned aerial vehicle 10.

In this example, a robot arm 231 is provided on the vehicle body 230 of the harvester 100a, and crops are harvested using the robot arm 231. The crops in the field are, for example, vegetables, fruits, etc., but are not limited thereto. For example, crops are harvested from trees 75 within the field. A container 232 is arranged on the vehicle body 230. By putting harvested crops 310a harvested by the robot arm 231 into the container 232, the harvested crops 310a are stored in the container 232. The vacuum gripper 222 can simultaneously adsorb multiple harvested crops 310a.

The processor 41 of the unmanned aerial vehicle 10 causes the unmanned aerial vehicle 10 to fly so that the vacuum gripper 222 can adsorb and acquire the harvested crops 310a inside the container 232. The processor 41 performs position alignment between the vacuum gripper 222 and the container 232 using output signals from the LiDAR sensor 65 and/or the camera 66. As described above, for example, by detecting the positions of the vacuum gripper 222 and the container 232 from three-dimensional point cloud data and/or image data using an estimation model generated by machine learning, position alignment between the vacuum gripper 222 and the container 232 can be performed. The processor 41 can bring the vacuum gripper 222 into contact with the harvested crops 310a inside the container 232 by causing the unmanned aerial vehicle 10 to fly so that the vacuum gripper 222 is positioned within the range of the container 232 in plan view, while causing the unmanned aerial vehicle 10 to descend.

FIG. 17B is a diagram showing an operation where the vacuum gripper 222 adsorbs the harvested crops 310a inside the container 232. When the vacuum gripper 222 adsorbs the harvested crops 310a, the processor 41 causes the unmanned aerial vehicle 10 to separate from the harvester 100a. FIG. 17C is a diagram showing the unmanned aerial vehicle 10 separating from the harvester 100a. The processor 41 causes the unmanned aerial vehicle 10 to separate from the harvester 100a by causing the unmanned aerial vehicle 10 to rise above the harvester 100a.

After causing the unmanned aerial vehicle 10 to separate from the harvester 100a, the processor 41 causes the unmanned aerial vehicle 10 to transport the harvested crops to a predetermined location. For example, the processor 41 moves the unmanned aerial vehicle 10 to a building that stores harvested crops. When the unmanned aerial vehicle 10 arrives at the storage facility 78 or its surrounding area, the harvested crops are transferred to the storage facility 78. The unmanned aerial vehicle 10 that has released the harvested crops may return to the field 70 again to resume work of acquiring harvested crops.

In this way, by having the unmanned aerial vehicle 10 adsorb and extract harvested crops stored by the harvester 100a that is performing crop harvesting from the harvester 100a, crop harvesting can be performed efficiently.

In the above description, the unmanned aerial vehicle 10 is configured to acquire harvested crops from the harvester 100a, but it is not limited thereto. For example, the unmanned aerial vehicle 10 may acquire harvested crops stored in a transport vehicle.

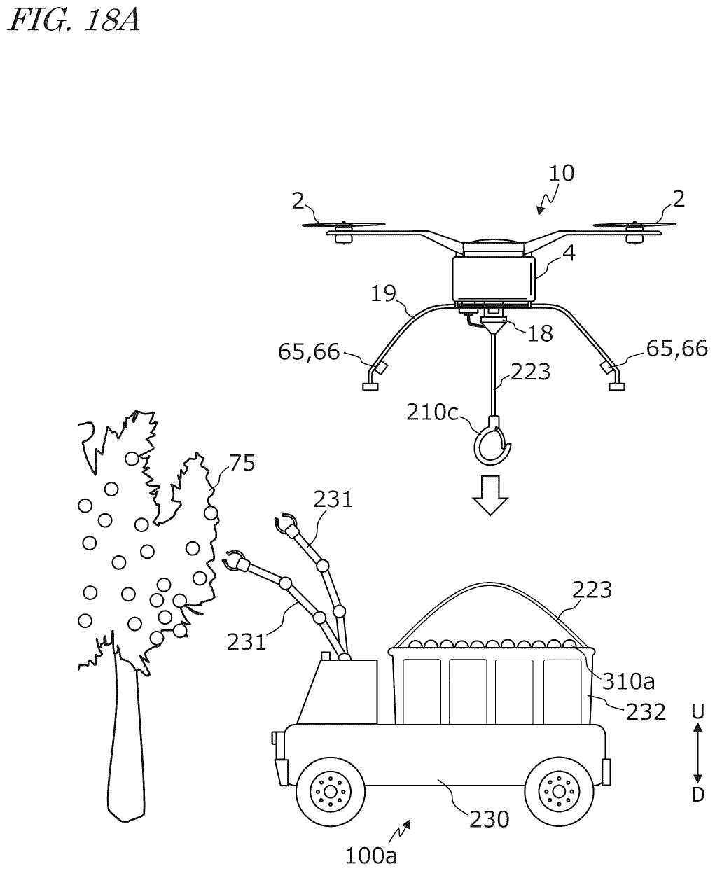

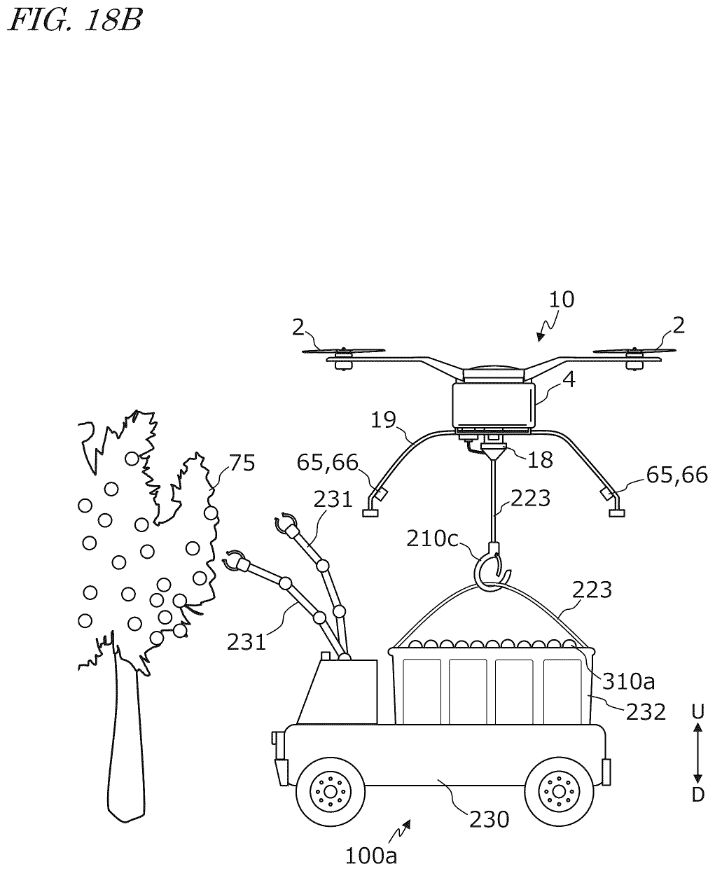

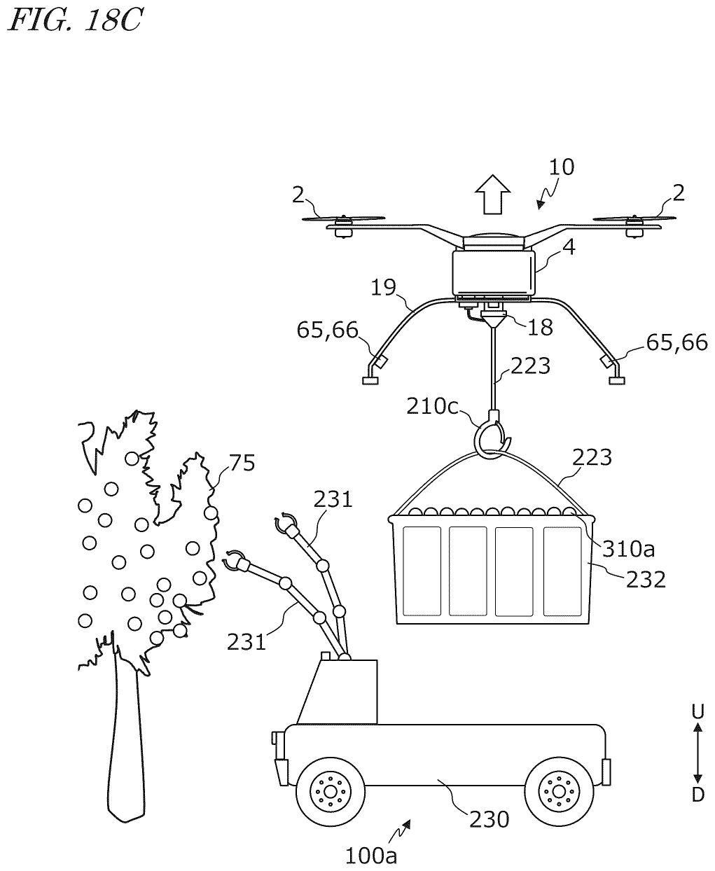

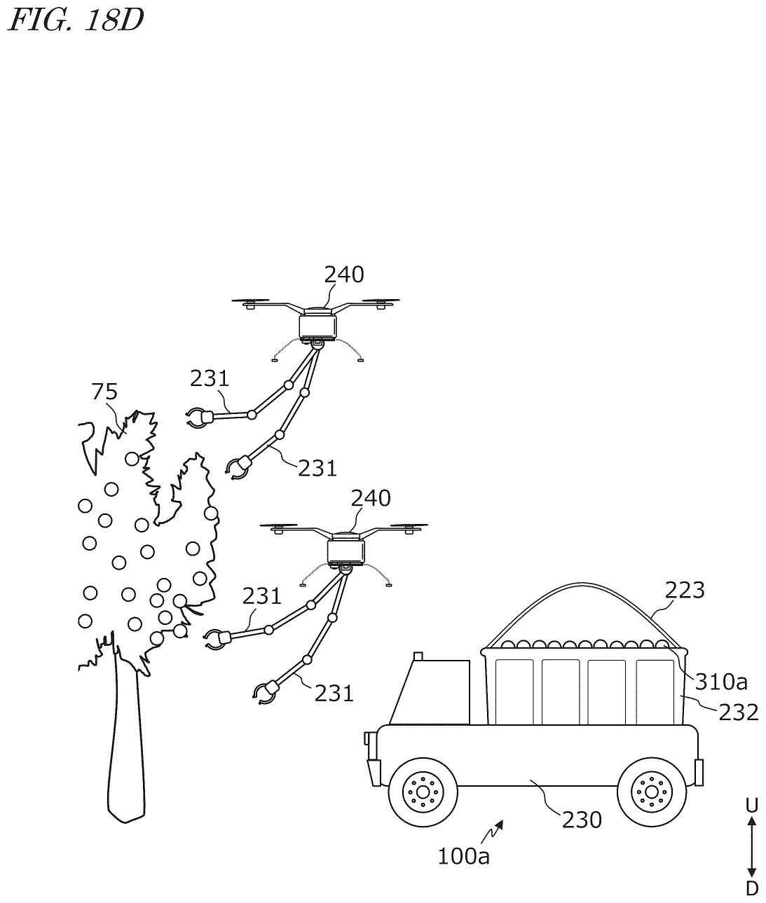

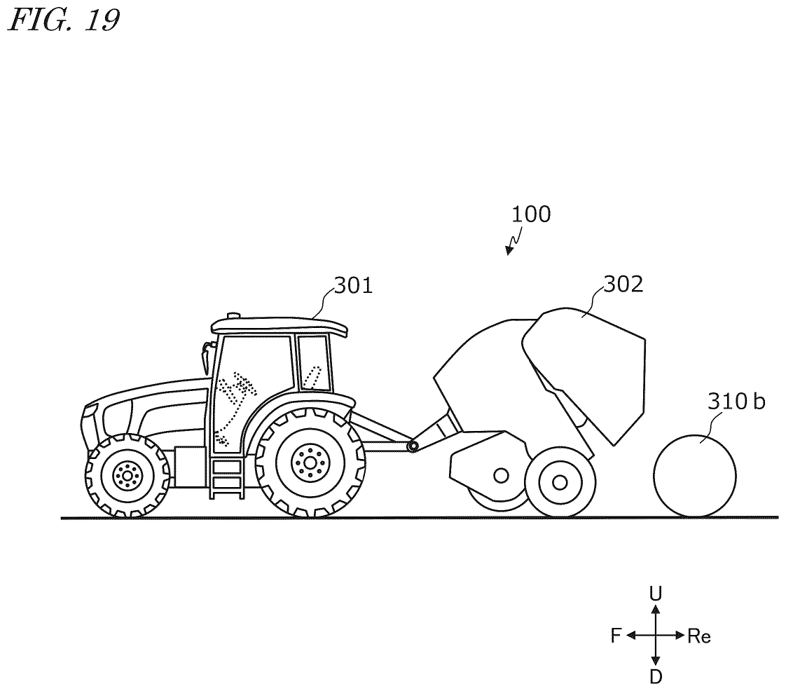

The unmanned aerial vehicle 10 may lift and transport the container 232 that is detachably provided on the harvester 100a using a hook. FIGS. 18A to 18C are diagrams showing examples of operations for acquiring the container 232 in which harvested crops 310a are stored using the unmanned aerial vehicle 10. In this example, the acquisition device includes a hook 210c. The hook 210c is connected to the connection device 18 via a wire 223. Instead of the wire 223, rods, robot arms, etc., may be used. The hook 210c may be provided with an actuator that moves a latch, and in this case, the processor 41 of the unmanned aerial vehicle 10 may control the opening and closing of the latch.

The container 232 is provided with a wire 223 that connects the ends of the container 232. The wire 223 connects, for example, the four corners of the opening of the container 232. By hooking this wire 223 onto the hook 210c, the container 232 can be lifted by the hook 210c. Instead of the wire 223, a handle may be provided on the container 232.

The processor 41 of the unmanned aerial vehicle 10 causes the unmanned aerial vehicle 10 to fly so that the container 232 can be lifted by the hook 210c. The processor 41 performs position alignment between the hook 210c and the wire 223 using output signals from the LiDAR sensor 65 and/or the camera 66. As described above, for example, by detecting the positions of the hook 210c and the wire 223 from three-dimensional point cloud data and/or image data using an estimation model generated by machine learning, position alignment between the hook 210c and the wire 223 can be performed. The processor 41 can hook the wire 223 onto the hook 210c by causing the unmanned aerial vehicle 10 to descend and bringing the hook 210c into contact with the wire 223. The work of hooking the wire 223 onto the hook 210c may be performed by a human.

FIG. 18B is a diagram showing a state where the wire 223 is hooked onto the hook 210c. When the wire 223 is hooked onto the hook 210c, the processor 41 causes the unmanned aerial vehicle 10 to separate from the harvester 100a. FIG. 18C is a diagram showing the unmanned aerial vehicle 10 separating from the harvester 100a. The processor 41 causes the unmanned aerial vehicle 10 to separate from the harvester 100a by causing the unmanned aerial vehicle 10 to rise above the harvester 100a. By causing the unmanned aerial vehicle 10 to rise above the harvester 100a, the container 232 can be lifted by the hook 210c. An empty container 232 transported by another unmanned aerial vehicle 10 may be set on the harvester 100a. This enables the harvester 100a to continue harvesting work.

After causing the unmanned aerial vehicle 10 to separate from the harvester 100a, the processor 41 causes the unmanned aerial vehicle 10 to transport the container 232 to a predetermined location. For example, the processor 41 moves the unmanned aerial vehicle 10 to a building that stores harvested crops. When the unmanned aerial vehicle 10 arrives at the storage facility 78 or its surrounding area, the harvested crops in the container 232 are transferred to the storage facility 78. The unmanned aerial vehicle 10 may suspend the empty container 232 and return to the field 70 again to set the container 232 on the harvester 100a.

In this way, by having the unmanned aerial vehicle 10 lift and transport the container 232 of the harvester 100a that is performing crop harvesting, crop harvesting can be performed efficiently.

In the above description, the unmanned aerial vehicle 10 was lifting the container 232 arranged on the harvester 100a, but it is not limited thereto. For example, the unmanned aerial vehicle 10 may lift and transport the container 232 arranged on a transport vehicle.

Also, the tank 106 of the harvester 100 (FIG. 4) may be detachable from the harvester 100, and in this case, the unmanned aerial vehicle 10 may lift and transport the tank 106 of the harvester 100.

In the above-described harvester 100a, crops were harvested using the robot arm 231 provided on the harvester 100a, but it is not limited thereto. For example, a small unmanned aerial vehicle may harvest crops and put the harvested crops into the container 232. FIG. 18D is a diagram showing an example of a small unmanned aerial vehicle 240 that harvests crops. In this example, the robot arm 231 is provided on the unmanned aerial vehicle 240, and the unmanned aerial vehicle 240 harvests crops using the robot arm 231. The unmanned aerial vehicle 240 puts the harvested crops 310a into the container 232, whereby the harvested crops 310a are stored in the container 232. In this example, a transport vehicle may be used as the harvester 100a.

Next, an example embodiment will be described where the unmanned aerial vehicle 10 scoops up harvested crops discharged from the agricultural machine 100. FIG. 19 is a diagram showing an example of the agricultural machine 100. In the example shown in FIG. 19, a baler 302, which is an example of an implement, is being towed by a tractor 301. The implement 302 towed by the tractor 301 and the tractor 301 as a whole function as one “agricultural machine.”

The baler 302 is towed by the tractor 301 to collect grass included in swaths (grass rows) formed within the field 70, and forms bales 310b by shaping the collected grass into a predetermined shape. The baler 302 discharges the formed bales 310b, for example, to the rear of the baler 302. Since the configuration of balers is known, detailed description is omitted here.

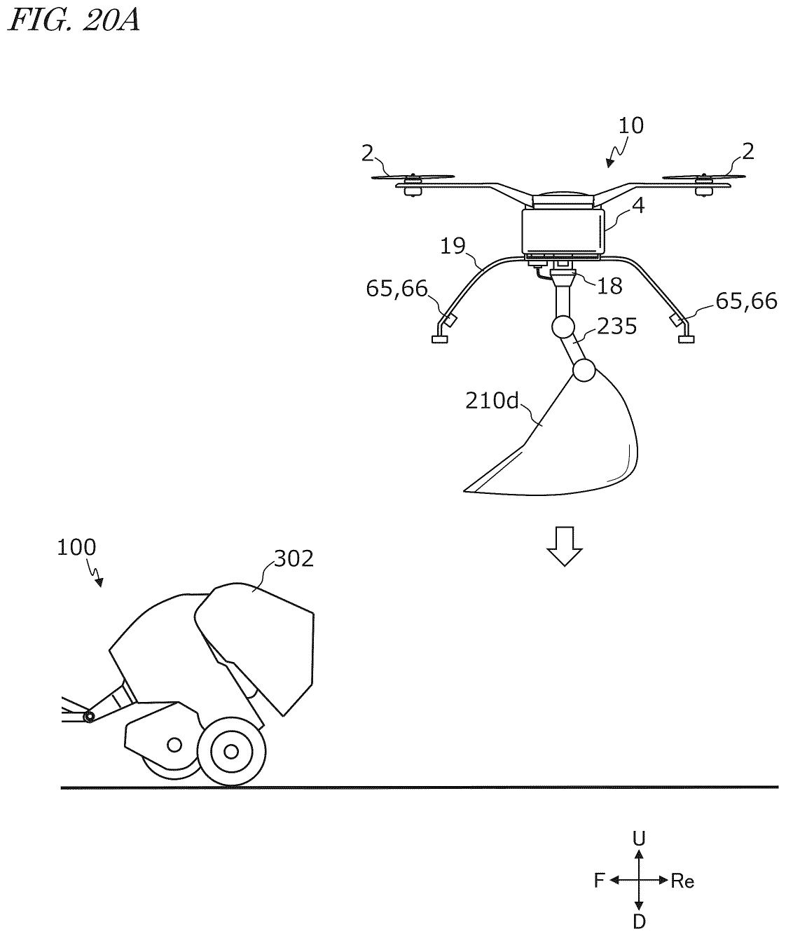

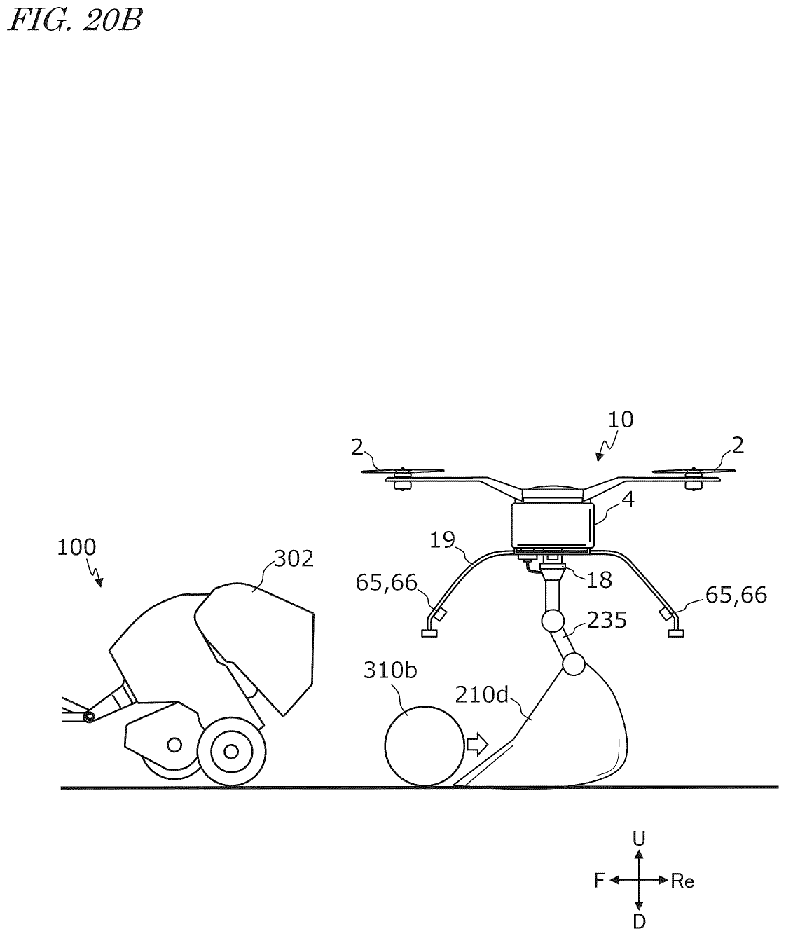

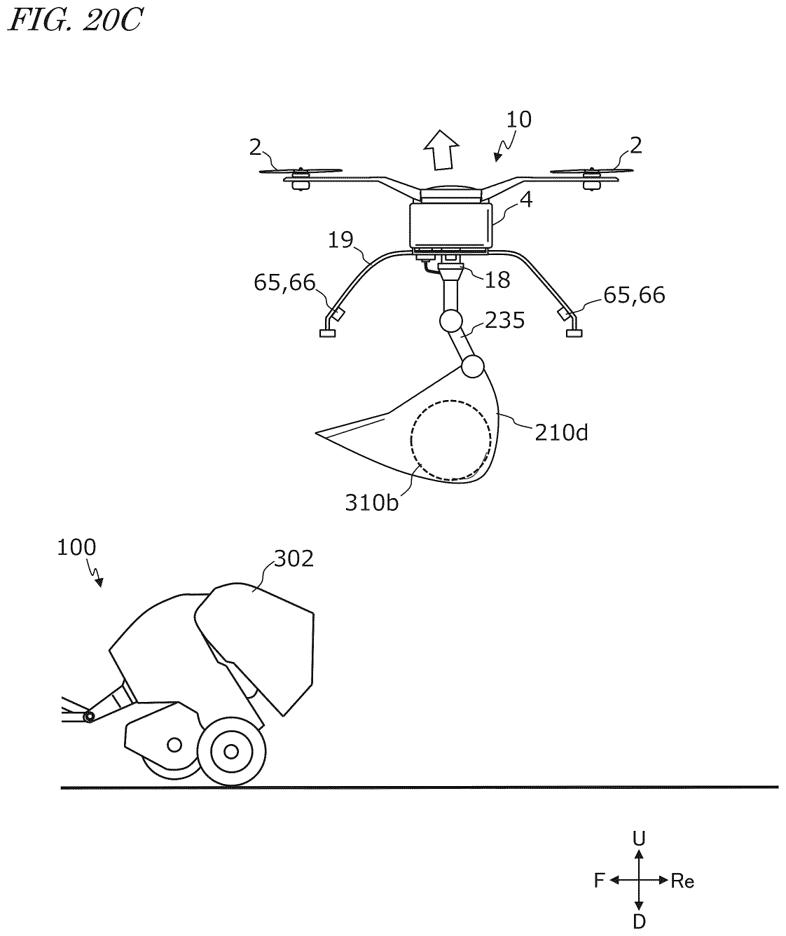

In this example, the unmanned aerial vehicle 10 scoops up and transports bales 310b discharged from the baler 302. FIGS. 20A to 20C are diagrams showing examples of operations for scooping up bales 310b discharged from the baler 302. In this example, the acquisition device includes a bucket 210d. The bucket 210d is connected to the connection device 18 via an arm 235. The arm 235 may be provided with multiple actuators that move the arm 235 itself and the bucket 210d, and in this case, the processor 41 of the unmanned aerial vehicle 10 may drive these actuators. By scooping up the bales 310b using the bucket 210d, the bales 310b can be transported.

The processor 41 of the unmanned aerial vehicle 10 causes the unmanned aerial vehicle 10 to standby near the scheduled discharge position of the bales 310b before the baler 302 discharges the bales 310b. The tractor 301 or the baler 302 transmits position information indicating the scheduled discharge position of the bales 310b to the unmanned aerial vehicle 10. The position information includes geographic coordinate information. Based on the received position information, the processor 41 causes the unmanned aerial vehicle 10 to fly to a position where bales 310b discharged from the baler 302 can be acquired and causes it to standby. For example, as shown in FIG. 20A, the unmanned aerial vehicle 10 is caused to standby at a position slightly behind the scheduled discharge position of the bales 310b on the travel route of the baler 302.

When the baler 302 discharges the bales 310b, the tractor 301 or the baler 302 transmits a signal notifying the discharge of the bales 310b to the unmanned aerial vehicle 10. When the unmanned aerial vehicle 10 receives this signal, the processor 41 causes the unmanned aerial vehicle 10 to descend and scoops up the discharged bales 310b with the bucket 210d.

FIG. 20B is a diagram showing an operation where the bucket 210d scoops up bales 310b that are discharged from the baler 302 and rolling on the ground.

The processor 41 moves the bucket 210d to a position where the bales 310b can be acquired using output signals from the LiDAR sensor 65 and/or the camera 66. As described above, for example, the positions of the bales 310b and the bucket 210d can be detected from three-dimensional point cloud data and/or image data using an estimation model generated by machine learning. By bringing the bales 310b and the bucket 210d close to each other, the bales 310b can be accommodated inside the bucket 210d.

When the bales 310b are accommodated inside the bucket 210d, the processor 41 causes the unmanned aerial vehicle 10 to rise. FIG. 20C is a diagram showing the unmanned aerial vehicle 10 rising with the bales 310b accommodated inside the bucket 210d.

After causing the unmanned aerial vehicle 10 to separate from the baler 302, the processor 41 causes the unmanned aerial vehicle 10 to transport the bales 310b to a predetermined location. For example, the processor 41 moves the unmanned aerial vehicle 10 to a building that stores harvested crops. When the unmanned aerial vehicle 10 arrives at the storage facility 78 or its surrounding area, the bales 310b are transferred to the storage facility 78. The unmanned aerial vehicle 10 may return to the field 70 again to acquire bales 310b.

Each of the above-described acquisition devices usable to acquire harvested crops was detachable from the unmanned aerial vehicle 10, but it is not limited thereto. Each of the acquisition devices may be integrally mounted on the unmanned aerial vehicle 10.

Next, processing for determining an unmanned aerial vehicle 10 that transports packages of harvested crops harvested from the field 70 from among multiple unmanned aerial vehicles 10 will be described.

In crop harvesting work in the field 70, multiple packages of harvested crops that should be transported to predetermined positions such as areas where storage facilities are located may be generated. In some cases, transportation of such multiple packages is shared among multiple unmanned aerial vehicles 10. In the present example embodiment, when a package to be transported is generated, an unmanned aerial vehicle 10 suitable for transporting that package is determined from among multiple unmanned aerial vehicles 10.

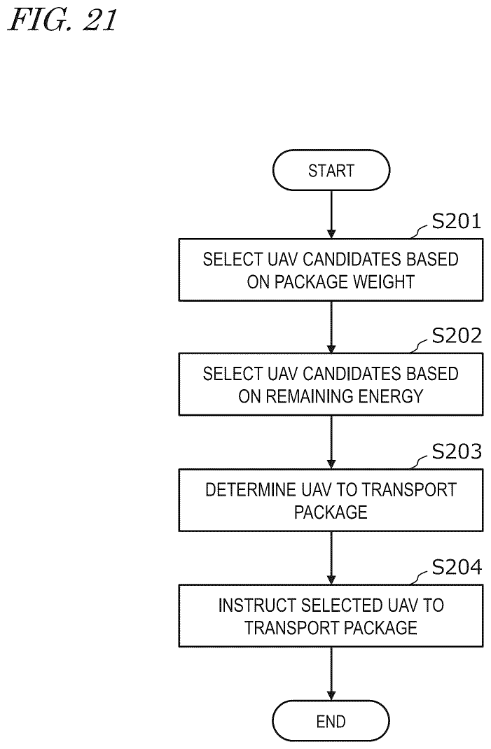

FIGS. 21, 22, and 23 are flowcharts showing examples of processing for determining an unmanned aerial vehicle 10 that transports packages of harvested crops from among multiple unmanned aerial vehicles 10. FIG. 24 is a diagram showing an example of the field 70 where the unmanned aerial vehicle 10 performs operations to acquire and transport packages.

In the example shown in FIG. 24, small unmanned aerial vehicles 240 (FIG. 18D) are harvesting crops from trees 75 within the field 70. Transport vehicles 320 for storing harvested crops are arranged within the field 70. Containers 330 are arranged on the transport vehicles 320. The unmanned aerial vehicles 240 put the harvested crops 310a into the containers 330, such that harvested crops are stored in the containers 330. The containers 330 are detachable from the transport vehicles 320. The packages of harvested crops that the unmanned aerial vehicles 10 transport are, for example, the containers 330 in which harvested crops are stored. The unmanned aerial vehicles 10 acquire and transport the containers 330 in which harvested crops are stored.

The transport vehicles 320 may be the harvesters 100a described above. The containers 330 may be the containers 232 (FIG. 18D). The transport vehicles 320 may include the components shown in FIG. 5. The transport vehicles 320 can communicate with the terminal device 400 and the management device 600 via the network 80 (FIG. 3). The transport vehicles 320 and the unmanned aerial vehicles 10 may communicate via the network 80 or may communicate directly without going through the network 80. The transport vehicles 320 may be capable of manned operation or may correspond only to unmanned operation. When the transport vehicles 320 correspond only to unmanned operation, components necessary only for manned operation, such as steering devices and driver's seats, may not be provided in the transport vehicles 320. When the transport vehicles 320 do not perform crop harvesting, components for harvesting crops may not be provided in the transport vehicles 320.

The processor 161 (FIG. 5) of the transport vehicles 320 can communicate with the unmanned aerial vehicles 10, the terminal device 400, and the management device 600 via the communication device 190. The processor 41 (FIG. 6) of the unmanned aerial vehicles 10 can communicate with the transport vehicles 320, the terminal device 400, and the management device 600 via the communication device 4c.

In the example shown in FIG. 24, transport vehicles 320a-320e are positioned within the field 70 as transport vehicles 320. Unmanned aerial vehicles 10a-10d are performing work as unmanned aerial vehicles 10.

Here, as an example, the container 330 arranged on the transport vehicle 320a will be described as a target package for transport, and processing for determining an unmanned aerial vehicle 10 that transports the target package 330 from among the multiple unmanned aerial vehicles 10a-10d will be described.

The load sensor 156 (FIG. 5) of the transport vehicle 320a detects the weight of the container 330. When harvested crops 310a (FIG. 18D) are stored in the container 330, the load sensor 156 detects the weight of the container 330 including the stored harvested crops 310a.

The processor 161 of the transport vehicle 320a determines whether the weight of the container 330 detected by the load sensor 156 is equal to or greater than a third predetermined value. The third predetermined value is, for example, the weight of the container 330 when about 50-90% of the volume of the container 330 is filled with harvested crops 310a, but is not limited to that value.

When the processor 161 determines that the weight of the container 330 is equal to or greater than the third predetermined value, it transmits to the management device 600 package weight information indicating the weight of the container 330 which is the target package, and package position information indicating the geographic coordinates of the position of the container 330. The processor 161 can acquire information about the geographic coordinates of the position of the container 330 from information output by the GNSS unit 121. Also, the processor 161 transmits a request signal requesting transportation of the container 330 to the management device 600.

Each of the unmanned aerial vehicles 10a-10d transmits availability information indicating the availability status regarding their own payload to the management device 600. The availability status represents the weight of packages that the unmanned aerial vehicle 10 can additionally load. The availability status can be obtained, for example, from the difference between the maximum payload of the unmanned aerial vehicle 10 and the weight of objects currently loaded by the unmanned aerial vehicle 10. The availability status may be calculated considering the weight of fuel carried by the unmanned aerial vehicle 10.

The processor 41 of the unmanned aerial vehicle 10 can detect the weight of currently loaded objects using the load sensor 67 (FIG. 6). The load sensor 67 is provided, for example, in the connection device 18 and detects the weight of objects connected to the connection device 18. Information about the maximum payload of the unmanned aerial vehicle 10 is stored in advance in the storage device 44. The processor 41 of each of the unmanned aerial vehicles 10a-10d transmits availability information to the management device 600.

The processor 41 of the unmanned aerial vehicle 10 further transmits energy remaining information indicating the remaining amount of energy sources for flying the unmanned aerial vehicle 10 to the management device 600. The remaining amount of energy sources for flying the unmanned aerial vehicle 10 is, for example, the remaining amount of the battery 52 (FIG. 2A) and/or the remaining amount of fuel in the fuel tank 7b (FIG. 2B). For example, the processor 41 can acquire information about the remaining amount of the battery 52 from information output by a battery management system (BMS) of the battery 52. For example, a fuel sensor that detects the remaining amount of fuel is provided in the fuel tank 7b, and the processor 41 can acquire information about the remaining amount of fuel from output signals of the fuel sensor. The processor 41 of the unmanned aerial vehicle 10 further transmits unmanned aerial vehicle position information indicating the geographic coordinates of the position of the unmanned aerial vehicle 10 to the management device 600. The processor 41 can acquire information about the geographic coordinates of the position of the unmanned aerial vehicle 10 from information output by the GNSS unit 61. The processor 41 of each of the unmanned aerial vehicles 10a-10d transmits energy remaining information and unmanned aerial vehicle position information to the management device 600.

The processor 660 (FIG. 7) of the management device 600 can communicate with the unmanned aerial vehicles 10, the transport vehicle 320a, and the terminal device 400 via the communication device 690. The communication device 690 receives the above-mentioned package weight information, package position information, request signal, availability information, energy remaining information, and unmanned aerial vehicle position information.

The processor 660 determines a transport unmanned aerial vehicle 10 that transports the target package 330 to a predetermined position from among the multiple unmanned aerial vehicles 10a-10d. In the example shown in FIG. 24, the predetermined position is the position of the storage facility 78 or its surrounding area.

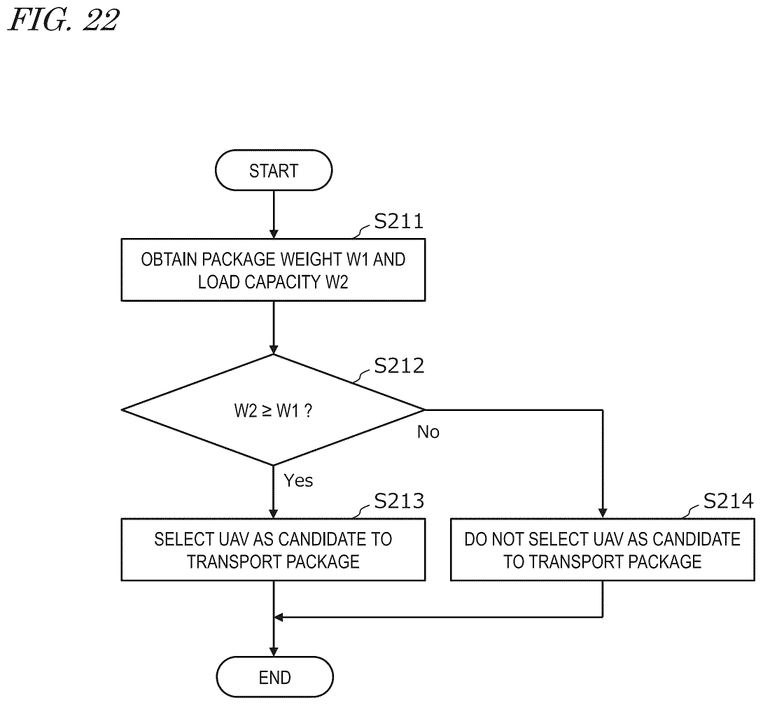

The processor 660 selects candidates for the transport unmanned aerial vehicle 10 from among the multiple unmanned aerial vehicles 10a-10d based on the package weight information and the availability information (step S201 in FIG. 21). FIG. 22 is a flowchart showing an example of details of the processing in step S201. The processor 660 selects, as candidates for the transport unmanned aerial vehicle 10, unmanned aerial vehicles whose weight of packages that can be additionally loaded obtained from the availability information is equal to or greater than the weight indicated by the package weight information.

The processor 660 acquires the package weight information and the availability information of each of the unmanned aerial vehicles 10a-10d (step S211). The package weight information indicates a weight value W1 of the target package 330. The availability information indicates a weight value W2 of packages that can be additionally loaded. The processor 660 compares the magnitude relationship between the weight value W1 and the weight value W2 for each of the unmanned aerial vehicles 10a-10d (step S212). The processor 660 selects unmanned aerial vehicles whose weight value W2 is equal to or greater than the weight value W1 as candidates for the transport unmanned aerial vehicle 10 (step S213). The processor 660 does not select unmanned aerial vehicles whose weight value W2 is less than the weight value W1 as candidates for the transport unmanned aerial vehicle 10 (step S214).

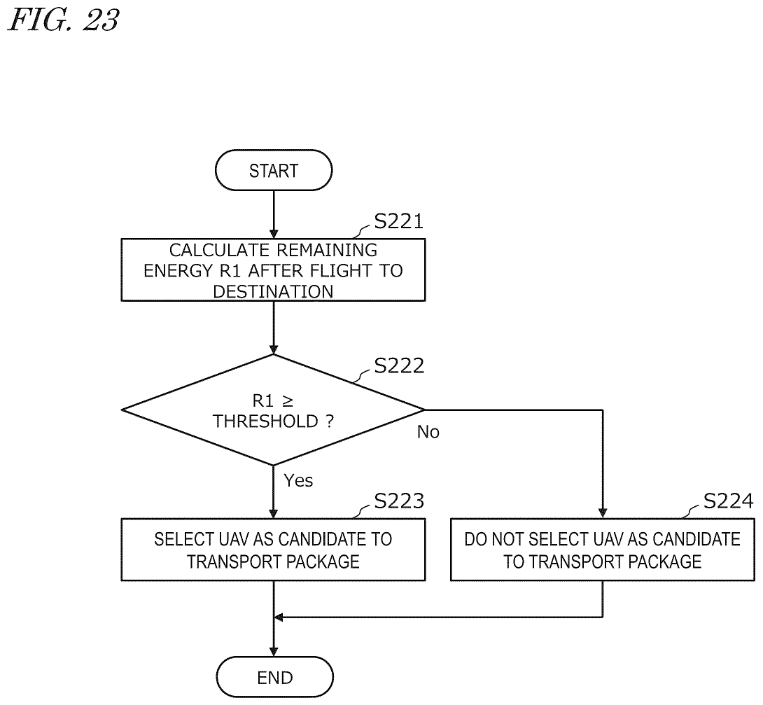

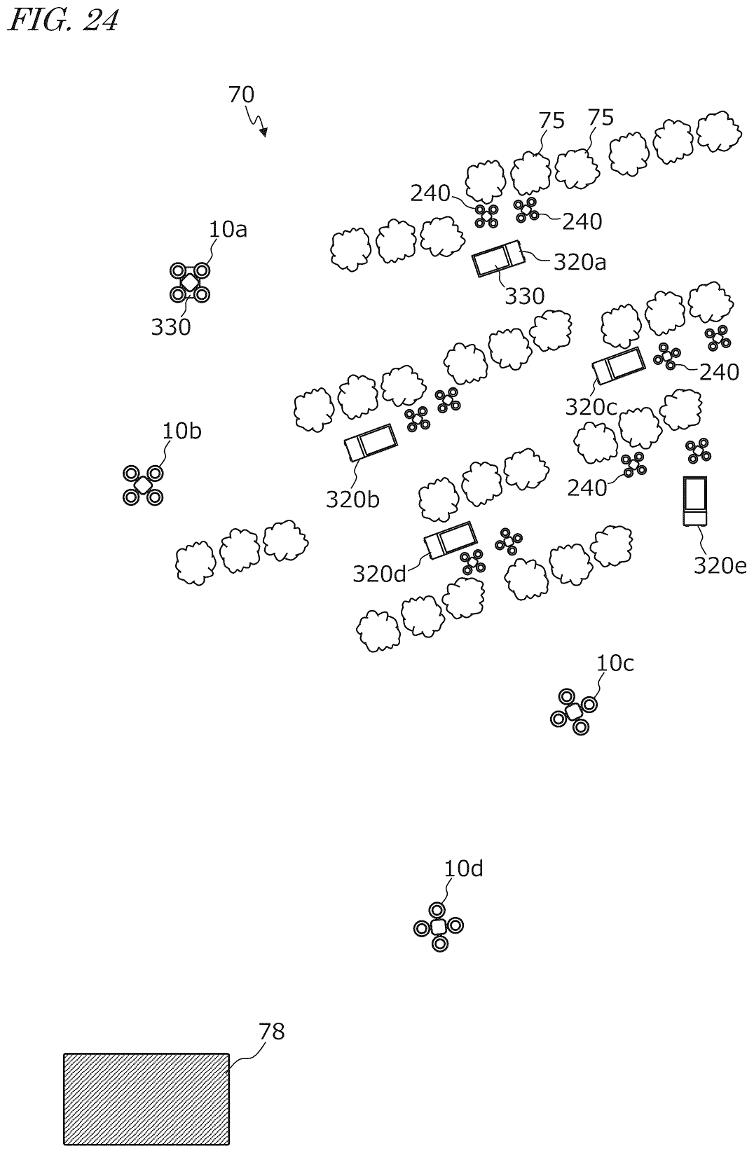

Next, the processor 660 further selects candidates from among one or more unmanned aerial vehicles 10 selected in step S213 based on the energy remaining information (step S202 in FIG. 21). FIG. 23 is a flowchart showing an example of details of the processing in step S202.

Information indicating the relationship between the energy consumption rate of the flying unmanned aerial vehicle 10 and the weight of objects loaded by the unmanned aerial vehicle 10, for example, a map showing this relationship, is stored in advance in the storage device 650. The energy consumption rate represents the consumption amount of electric power and/or fuel for flying the unmanned aerial vehicle 10 per unit distance. Information about the geographic coordinates of the transport destination position of the target package 330 (for example, the position of the storage facility 78 or its surrounding area) is stored in advance in the storage device 650.

The processor 660 calculates the distance between the current position of the unmanned aerial vehicle 10 and the position of the target package 330, and also calculates the distance between the position of the target package 330 and the transport destination position.

The processor 660 calculates the energy consumption (first energy consumption) when the unmanned aerial vehicle 10 is flown from the current position to the position of the target package 330. Also, the processor 660 calculates the energy consumption (second energy consumption) when the unmanned aerial vehicle 10 supporting the target package 330 flies from the position of the target package 330 to the transport destination position, assuming that the unmanned aerial vehicle 10 supports the target package 330. The processor 660 can calculate the energy remaining amount R1 when the unmanned aerial vehicle 10 supporting the target package 330 flies to the transport destination position based on the current energy remaining amount, the first energy consumption, and the second energy consumption.

The processor 660 calculates the energy remaining amount R1 for each of one or more unmanned aerial vehicles 10 selected in step S213 (FIG. 22) (step S221 in FIG. 23).

The processor 660 compares the magnitude relationship between the calculated energy remaining amount R1 and a fourth predetermined value (step S222). The fourth predetermined value is an arbitrary value greater than zero. The fourth predetermined value is, for example, a value corresponding to about 10-20% energy remaining amount, but is not limited thereto.

The processor 660 selects unmanned aerial vehicles whose energy remaining amount R1 is equal to or greater than the fourth predetermined value as candidates for the transport unmanned aerial vehicle 10 (step S223). The processor 660 does not select unmanned aerial vehicles whose energy remaining amount R1 is less than the fourth predetermined value as candidates for the transport unmanned aerial vehicle 10 (step S224).

The processor 660 determines a transport unmanned aerial vehicle 10 that transports the target package 330 from among one or more unmanned aerial vehicles 10 selected in step S223 (step S203 in FIG. 21). For example, the processor 660 determines the unmanned aerial vehicle 10 with the smallest distance between the current position of the unmanned aerial vehicle 10 and the position of the target package 330 as the transport unmanned aerial vehicle 10. Also, for example, the unmanned aerial vehicle 10 with the largest energy remaining amount R1 may be determined as the transport unmanned aerial vehicle 10.

As an example, the processor 660 determines the unmanned aerial vehicle 10b as the transport unmanned aerial vehicle. The processor 660 outputs an instruction to transport the target package 330 for transport to the unmanned aerial vehicle 10b. Also, the processor 660 outputs package position information indicating the geographic coordinates of the position of the target package 330 to the unmanned aerial vehicle 10b. When the processor 41 of the unmanned aerial vehicle 10b receives the transport instruction and package position information, it causes the unmanned aerial vehicle 10b to fly to the position of the target package 330. The target package 330 is, for example, the container 232 (FIGS. 18A-18D). The unmanned aerial vehicle 10b is provided with, for example, the hook 210c as a support device that supports the target package 330. The unmanned aerial vehicle 10b that has reached above the container 232 can acquire the container 232 by the method described using FIGS. 18A-18C. The unmanned aerial vehicle 10b that has acquired the container 232 flies toward the transport destination storage facility 78 or its surrounding area. When the unmanned aerial vehicle 10b arrives at the storage facility 78 or its surrounding area, the harvested crops are transferred to the storage facility 78.

In the present example embodiment, an unmanned aerial vehicle 10 suitable for transporting the target package 330 is determined from among multiple unmanned aerial vehicles 10.

The weight value W1 of the target package 330 and the weight value W2 of packages that the unmanned aerial vehicle 10 can additionally load are compared, and an unmanned aerial vehicle 10 that satisfies the condition that the weight value W2 is equal to or greater than the weight value W1 is determined as the transport unmanned aerial vehicle 10.

This can prevent unmanned aerial vehicles 10 that cannot transport the target package 330, such as those that would exceed the maximum payload when loading the target package 330, from attempting to transport the target package 330. Also, even if the unmanned aerial vehicle 10 is already supporting another package, if there is spare capacity in the transport capability of that unmanned aerial vehicle 10, by having it support the target package 330, efficient transport of harvested crops can be achieved.

Also, in the present example embodiment, the energy remaining amount R1 when the unmanned aerial vehicle 10 supports the target package 330 and flies to the transport destination position is calculated. An unmanned aerial vehicle 10 that satisfies the condition that the energy remaining amount R1 is equal to or greater than the fourth predetermined value is determined as the transport unmanned aerial vehicle 10. This can prevent the unmanned aerial vehicle 10 from becoming unable to fly during transport of the target package 330.

Note that when there is sufficient margin in the remaining amount of energy sources for each of the multiple unmanned aerial vehicles 10, the processing to determine the transport unmanned aerial vehicle 10 based on the energy remaining amount R1 may be omitted.

In the above description, the management device 600 performed the processing to determine the unmanned aerial vehicle 10 that transports the target package 330, but the terminal device 400 may perform this processing.

Also, the unmanned aerial vehicle 10 itself may determine whether it can transport the target package 330.

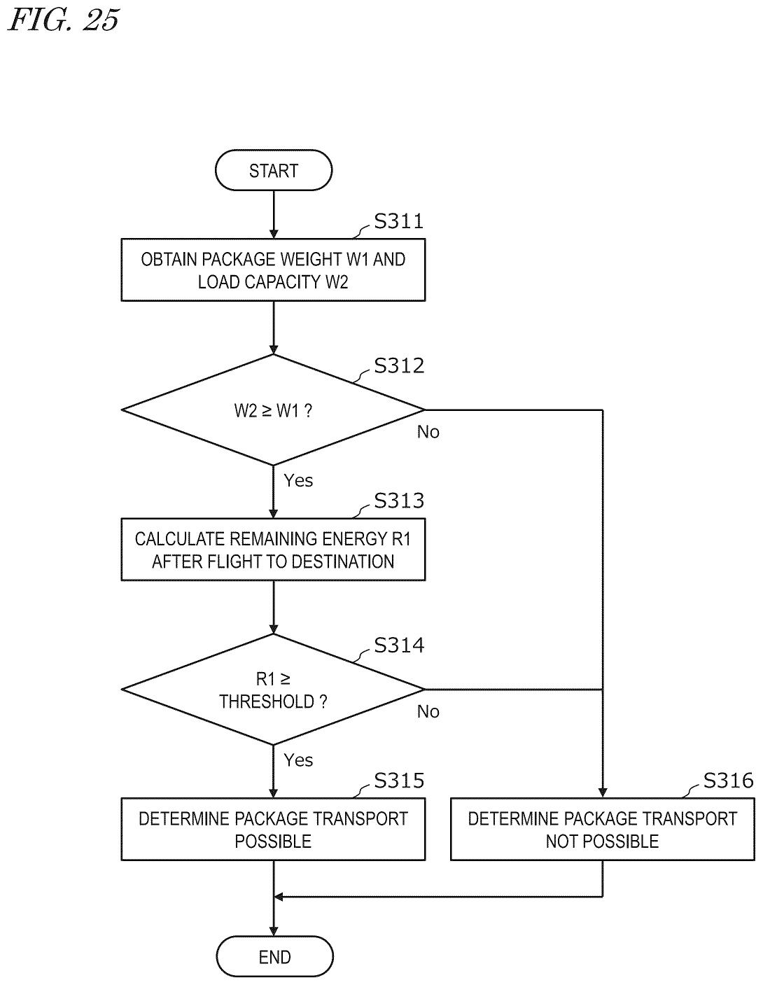

FIG. 25 is a flowchart showing an example of processing where the unmanned aerial vehicle 10 itself determines whether it can transport the target package 330.

Here, as an example, the container 330 arranged on the transport vehicle 320a will be described as a target package for transport, and processing where the unmanned aerial vehicle 10 itself determines whether the target package 330 can be transported will be described.

When the processor 161 of the transport vehicle 320a determines that the weight of the container 330 is equal to or greater than the third predetermined value, it transmits to multiple unmanned aerial vehicles 10 package weight information indicating the weight of the container 330 which is the target package, and package position information indicating the geographic coordinates of the position of the container 330. Also, the processor 161 transmits a request signal requesting transportation of the container 330 to the multiple unmanned aerial vehicles 10.

Here, processing performed by one unmanned aerial vehicle 10 among the multiple unmanned aerial vehicles 10 will be described. Other unmanned aerial vehicles 10 also perform similar processing.

The processor 41 of the unmanned aerial vehicle 10 generates availability information, energy remaining information, and unmanned aerial vehicle position information. The communication device 4c of the unmanned aerial vehicle 10 receives the above-mentioned package weight information, package position information, and request signal.

The processor 41 acquires the package weight information and availability information (step S311). The package weight information indicates the weight value W1 of the target package 330. The availability information indicates the weight value W2 of packages that can be additionally loaded. The processor 41 compares the magnitude relationship between the weight value W1 and the weight value W2 (step S312).

When the weight value W2 is less than the weight value W1, the processor 41 determines that transport of the target package 330 is impossible (step S316). In this case, transport of the target package 330 is not performed. When the weight value W2 is equal to or greater than the weight value W1, the processor 41 calculates the energy remaining amount R1 (step S313).

Information indicating the relationship between the energy consumption rate of the flying unmanned aerial vehicle 10 and the weight of objects loaded by the unmanned aerial vehicle 10, for example, a map showing this relationship, is stored in advance in the storage device 44. Information about the geographic coordinates of the transport destination position of the target package 330 (for example, the position of the storage facility 78 or its surrounding area) is stored in advance in the storage device 44.

The processor 41 calculates the distance between the current position of the unmanned aerial vehicle 10 and the position of the target package 330, and also calculates the distance between the position of the target package 330 and the transport destination position.

The processor 41 calculates the energy consumption (first energy consumption) when the unmanned aerial vehicle 10 is flown from the current position to the position of the target package 330. Also, the processor 41 calculates the energy consumption (second energy consumption) when the unmanned aerial vehicle 10 supporting the target package 330 flies from the position of the target package 330 to the transport destination position, assuming that the unmanned aerial vehicle 10 supports the target package 330. The processor 41 calculates the energy remaining amount R1 when the unmanned aerial vehicle 10 supporting the target package 330 flies to the transport destination position based on the current energy remaining amount, the first energy consumption, and the second energy consumption.

The processor 41 compares the magnitude relationship between the calculated energy remaining amount R1 and the fourth predetermined value (step S314). When the energy remaining amount R1 is less than the fourth predetermined value, the processor 41 determines that transport of the target package 330 is impossible (step S316). In this case, transport of the target package 330 is not performed. When the energy remaining amount R1 is equal to or greater than the fourth predetermined value, the processor 41 determines that the target package 330 can be transported (step S315).

The processor 41 outputs information indicating the determination result of whether the target package 330 can be transported to the outside via the communication device 4c. This enables notifying other unmanned aerial vehicles 10 and the management device 600, etc., that it can transport the target package 330, or that it cannot transport the target package 330.

When the processor 41 determines that the target package 330 can be transported, it causes the unmanned aerial vehicle 10 to fly to the position of the target package 330. The target package 330 is, for example, the container 232 (FIGS. 18A-18D). The unmanned aerial vehicle 10 is provided with, for example, the hook 210c as a support device that supports the target package 330. The unmanned aerial vehicle 10 that has reached above the container 232 can acquire the container 232 by the method described using FIGS. 18A-18C. The processor 41 causes the unmanned aerial vehicle 10 that has acquired the container 232 to fly toward the transport destination storage facility 78 or its surrounding area. When the unmanned aerial vehicle 10 arrives at the storage facility 78 or its surrounding area, the harvested crops are transferred to the storage facility 78.

Note that when there is sufficient margin in the remaining amount of energy sources of the unmanned aerial vehicle 10, the processing to determine whether the target package 330 can be transported based on the energy remaining amount R1 may be omitted.

As described above, by having an unmanned aerial vehicle 10 capable of transporting the target package 330 fly to the position where the target package 330 is located, support and transport the target package 330, efficient transport of harvested crops can be achieved.

When determining whether the target package 330 can be transported based on the weight of the target package 330, the processor 41 may determine that the target package 330 can be transported when the total weight of one or more packages that the unmanned aerial vehicle 10 will support when supporting the target package 330 is equal to or less than the maximum payload. The processor 41 determines that the target package 330 cannot be transported when the total weight exceeds the maximum payload.

When the unmanned aerial vehicle 10 is already supporting one or more other packages different from the target package 330, the processor 41 determines that the target package 330 can be transported when the total value of the weight value indicated by the package weight information and the weight values of the one or more other packages is equal to or less than the maximum payload. The processor 41 determines that the target package 330 cannot be transported when the total value of the weight value indicated by the package weight information and the weight values of the one or more other packages exceeds the maximum payload.

This can prevent unmanned aerial vehicles 10 that cannot transport the target package 330, such as those that would exceed the maximum payload when loading the target package 330, from attempting to transport the target package 330.

Even if the unmanned aerial vehicle 10 is already supporting packages, if there is spare capacity in the transport capability, by having it support additional packages, efficient transport of harvested crops can be achieved.

The harvester 100a and/or the unmanned aerial vehicle 240 illustrated in FIGS. 18A-18D operate as a package system that packages harvested crops. As described above, the container 232 in which harvested crops are stored becomes a package. The robot arm 231 provided on the harvester 100a and/or the unmanned aerial vehicle 240 operates as a packaging device that packages harvested crops. The processor of the harvester 100a and/or the unmanned aerial vehicle 240 controls the operation of the robot arm 231 which is the packaging device. Here, it is assumed that the processor 161 of the harvester 100a controls the operation of the robot arm 231.

A package is, for example, a storage section in which harvested crops are stored. A package may be, for example, the tank 106 that stores harvested crops described above. In this case, the tank 106 is separable from the harvester 100. A package may be, for example, a lump of harvested crops wrapped like the bales 310b described above.

The processor 161 of the harvester 100a may adjust the amount of crops that the robot arm 231 harvests based on the transport capability of the unmanned aerial vehicle 10 that transports packages of harvested crops, and change the weight of the container 232 containing harvested crops.

For example, the processor 41 of the unmanned aerial vehicle 10 transmits availability information indicating the weight value W2 of packages that can be additionally loaded to the harvester 100a. The processor 161 of the harvester 100a adjusts the amount of crops that the robot arm 231 harvests so that the weight value W1 of the container 232 does not exceed the weight value W2. In this way, by adjusting the weight of the container 232 containing harvested crops according to the transport capability of the unmanned aerial vehicle 10, the unmanned aerial vehicle 10 can be made to transport the container 232. Note that to adjust the weight of the container 232, the number of harvested crops put into the container 232 may be adjusted.

The processor 161 of the harvester 100a may move the harvester 100a on which the container 232 is arranged to a position where the unmanned aerial vehicle 10 can acquire the container 232. Even if the position where crops are harvested is an area where entry of the unmanned aerial vehicle 10 is difficult, by moving the position of the package, the unmanned aerial vehicle 10 can acquire the package.

The processing to change the weight of the container 232 containing harvested crops based on the transport capability of the unmanned aerial vehicle 10 may be performed by the management device 600. The processor 660 of the management device 600 transmits an instruction to change the weight of the container 232 containing harvested crops to the harvester 100a based on the availability information and energy remaining information of the unmanned aerial vehicle 10. The processor 660 can calculate the weight of the container 232 that the unmanned aerial vehicle 10 can transport to the transport destination position based on the availability information and energy remaining information by using, for example, a map showing the relationship between the energy consumption rate of the unmanned aerial vehicle 10 and the weight of objects loaded by the unmanned aerial vehicle 10. The processor 660 instructs the harvester 100a so that the weight of the container 232 does not exceed the calculated transportable weight.

In the above example, the weight of the container 232 was adjusted, but in forms where the unmanned aerial vehicle 10 supports multiple packages, the number of packages that the unmanned aerial vehicle 10 supports may be changed based on the transport capability of the unmanned aerial vehicle 10.

By changing the weight or number of packages according to the transport capability of the unmanned aerial vehicle 10, the unmanned aerial vehicle 10 can be made to transport those packages.

In the example embodiment where the baler 302 illustrated in FIG. 19 forms bales 310b, the bales 310b become packages of harvested crops. In the example of forming bales 310b, the weight or number of bales 310b may be changed according to the transport capability of the unmanned aerial vehicle 10.

In the above example, the unmanned aerial vehicle 10 was transporting packages of harvested crops, but it may transport harvested crops that are not packaged. In this case, the processor 161 of the harvester 100a may transmit harvested crop weight information indicating the weight of harvested crops and harvested crop position information indicating the geographic coordinates of the position of harvested crops to the management device 600 and/or the unmanned aerial vehicle 10. The processor 660 of the management device 600 determines a transport unmanned aerial vehicle 10 that transports harvested crops to a transport destination position (for example, the position of the storage facility 78 or its surrounding area) from among multiple unmanned aerial vehicles 10 based on the harvested crop weight information and harvested crop position information. The processor 41 of the unmanned aerial vehicle 10 determines whether harvested crops can be transported to the transport destination position based on the harvested crop weight information and harvested crop position information. When determining that harvested crops can be transported, the processor 41 causes the unmanned aerial vehicle 10 to fly to the position of the harvested crops, causes the acquisition device 210 to acquire the harvested crops, and causes the unmanned aerial vehicle 10 to fly to the transport destination position. By having an unmanned aerial vehicle 10 capable of transporting harvested crops fly to the position where harvested crops are located, acquire and transport the harvested crops, efficient transport of harvested crops can be achieved.

Next, processing for causing an unmanned aerial vehicle 10 that is performing operations other than transporting harvested crops to transport harvested crops will be described.

The unmanned aerial vehicle 10 can perform various operations in addition to transporting harvested crops. For example, the unmanned aerial vehicle 10 performs operations to support and transport arbitrary structures. Structures that the unmanned aerial vehicle 10 supports and transports are, for example, implements 200. By having the unmanned aerial vehicle 10 support the implement 200, the implement 200 can be transported to desired locations or the work of the implement 200 can be assisted.

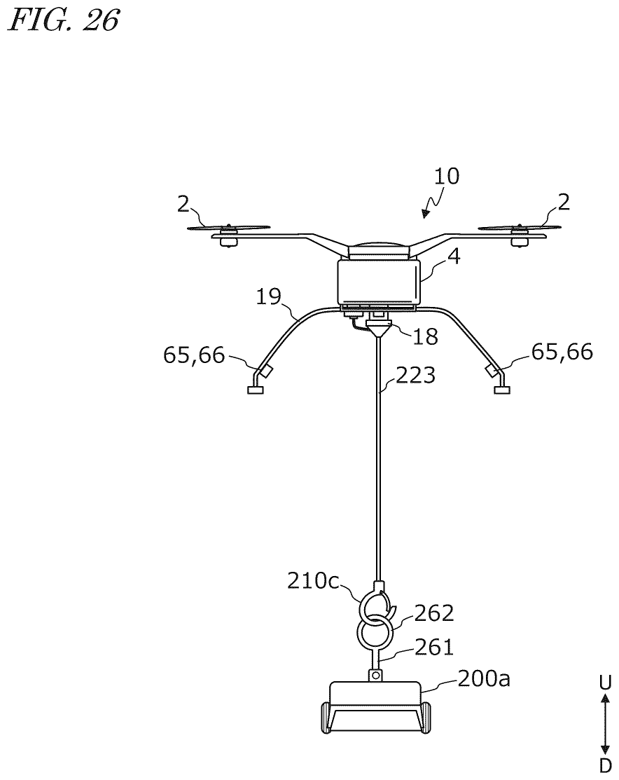

FIG. 26 is a diagram showing an example of the unmanned aerial vehicle 10 supporting an implement 200a. The type of implement 200a is arbitrary. In the example shown in FIG. 26, the implement 200a is a grass cutter. In this example, a rod 261 extends upward from the top of the main body of the implement 200a. A hook 262 is provided at the top of the rod 261. The hook 262 has a shape that can hook the hook 210c connected to the unmanned aerial vehicle 10. The hook 262 is, for example, a ring hook.

The rod 261 is rotatably provided on the main body of the implement 200a, and the angle of the rod 261 relative to the main body of the implement 200a can be freely changed. A wire, etc., may be used instead of the rod 261.

The method by which the unmanned aerial vehicle 10 supports the implement 200a is arbitrary, and mechanisms different from the above may be used. In the present example embodiment, an unmanned aerial vehicle 10 supporting the implement 200a is caused to separate the implement 200a and transport harvested crops.

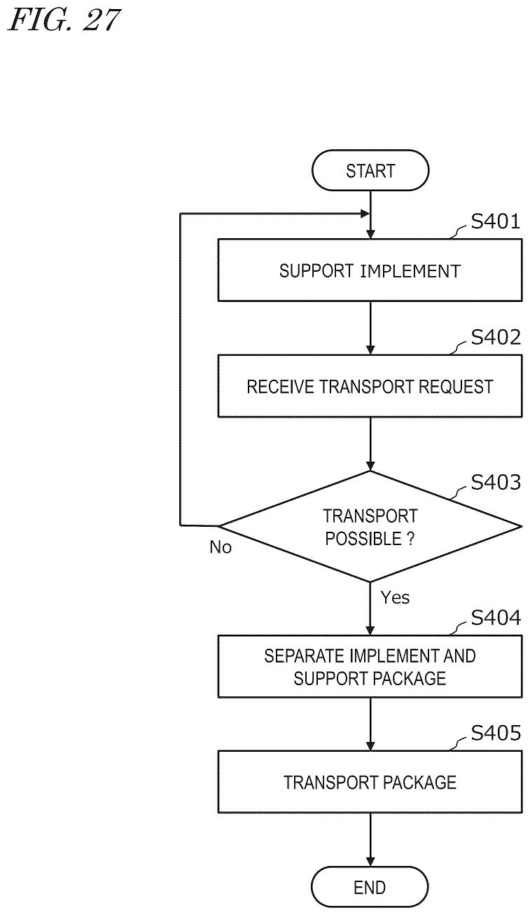

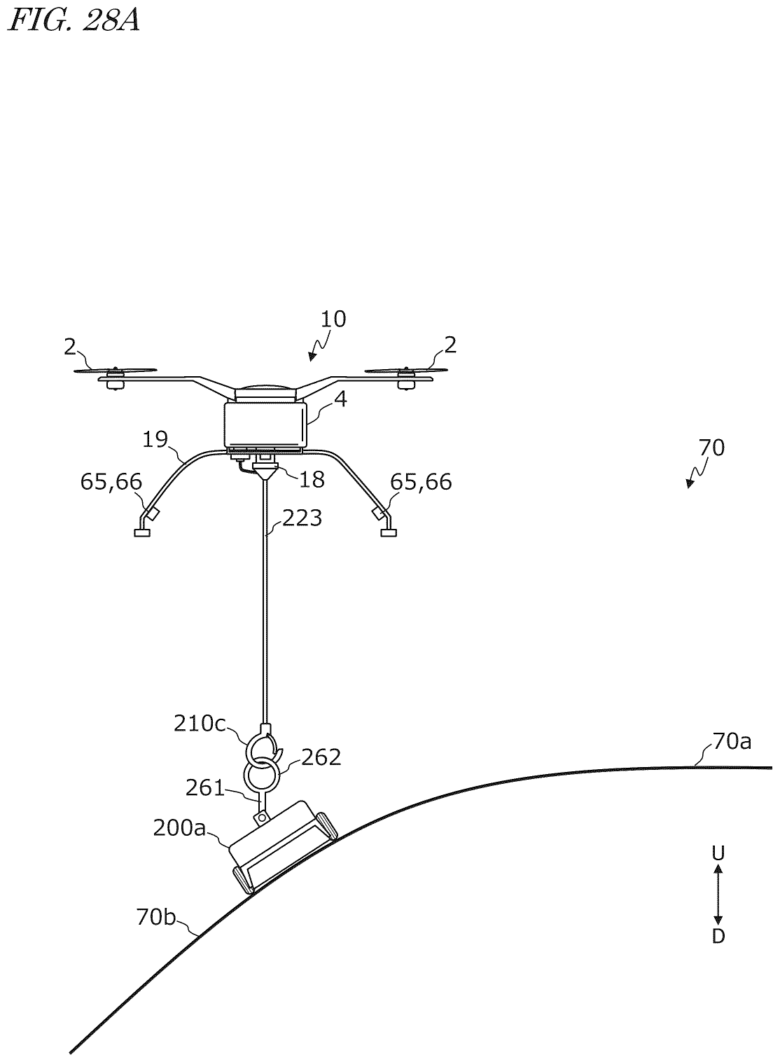

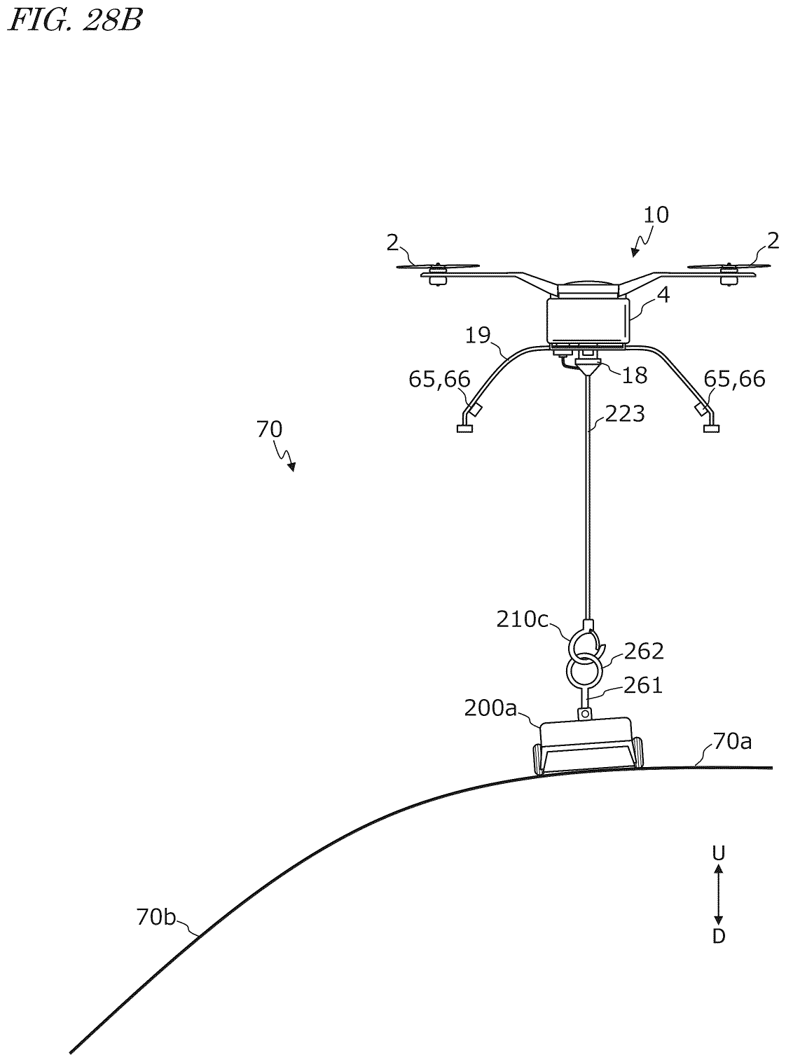

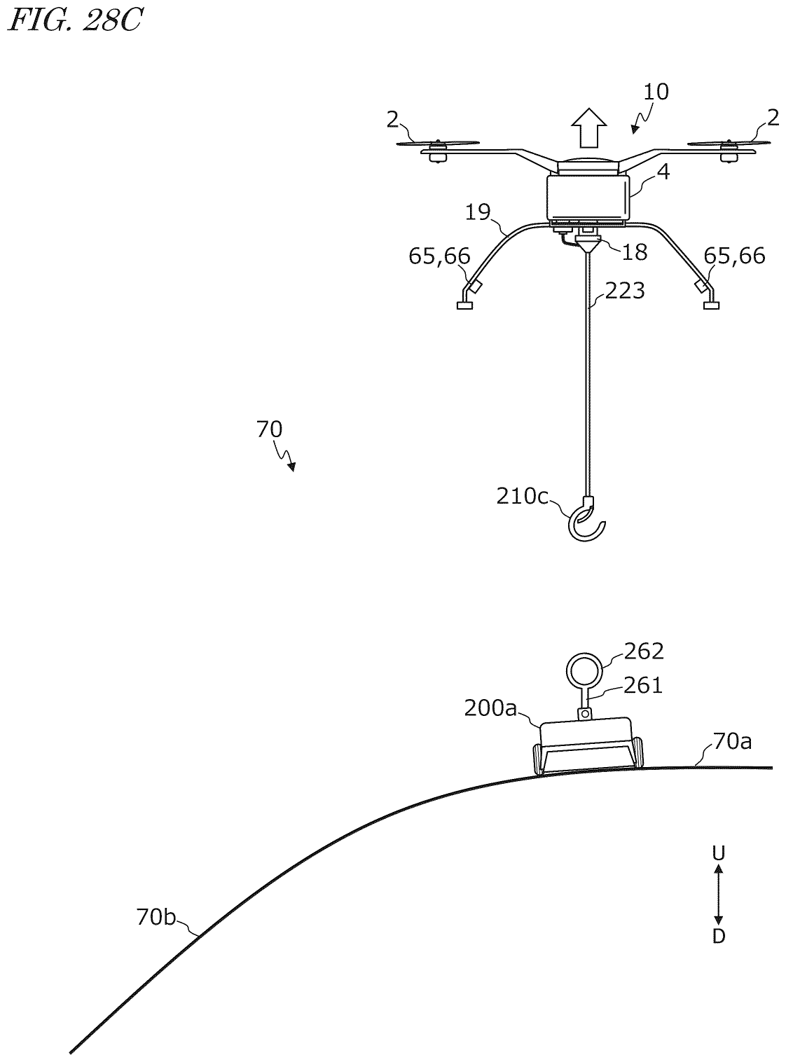

FIG. 27 is a flowchart showing an example of operations for causing an unmanned aerial vehicle 10 supporting the implement 200a to separate the implement 200a and perform transport of harvested crops. FIGS. 28A and 28B are diagrams showing the unmanned aerial vehicle 10 supporting the implement 200a performing work in the field 70. FIG. 28C is a diagram showing the unmanned aerial vehicle 10 that has separated the implement 200a.

The unmanned aerial vehicle 10, for example, supports the implement 200a at a warehouse or its surrounding area (step S401). The processor 41 of the unmanned aerial vehicle 10 causes the unmanned aerial vehicle 10 supporting the implement 200a to fly and transports the implement 200a to an area where the implement 200a performs work. The area where the implement 200a performs work is, for example, within the field 70 or an area around the field 70.

In the examples shown in FIGS. 28A and 28B, the area where the implement 200a performs work is the field 70. When the implement 200a is a grass cutter, the implement 200a performs grass cutting. FIG. 28A shows the implement 200a performing work on a slope 70b with a relatively large inclination angle. FIG. 28B shows the implement 200a performing work on relatively flat ground 70a. Even when performing work on a slope 70b with a relatively large inclination angle, by having the unmanned aerial vehicle 10 support the implement 200a, the implement 200a can perform work stably.

As described above, when the processor 161 (FIG. 5) of the transport vehicle 320 accumulates a predetermined amount or more of harvested crops in the container 330, it transmits to the unmanned aerial vehicle 10 package weight information indicating the weight of the container 330 which is the target package, and package position information indicating the geographic coordinates of the position of the container 330. Also, the processor 161 transmits a request signal requesting transportation of the container 330 to the unmanned aerial vehicle 10. The communication device 4c of the unmanned aerial vehicle 10 receives the above-mentioned package weight information, package position information, and request signal (step S402).

Upon receiving the request signal, the processor 41 of the unmanned aerial vehicle 10 determines whether it is possible to release support of the implement 200a and transport the package 330 (step S403).

When the implement 200a is positioned in an area where support by the unmanned aerial vehicle 10 is necessary, the processor 41 causes the unmanned aerial vehicle 10 to continue supporting the implement 200a that is performing work. For example, as shown in FIG. 28A, when the implement 200a is performing work on a slope 70b with a relatively large inclination angle, support of the implement 200a is continued. In this case, transport of the package 330 is not performed. This enables the implement 200a to perform work appropriately.

When the implement 200a is positioned in an area where work is possible without being supported by the unmanned aerial vehicle 10, the processor 41 causes the unmanned aerial vehicle 10 to release support of the implement 200a (step S404). For example, as shown in FIG. 28B, when the implement 200a is performing work on relatively flat ground 70a, support of the implement 200a is released. FIG. 28C shows the unmanned aerial vehicle 10 that has released support of the implement 200a and separated the implement 200a.

For example, the processor 41 controls the operation of the latch so that the latch of the hook 210c is in an open state, and causes the unmanned aerial vehicle 10 to fly so that the hook 210c moves diagonally downward relative to the hook 262 of the implement 200a, thus separating the hook 210c and the hook 262. This enables separation of the implement 200a from the unmanned aerial vehicle 10. The separated implement 200a may continue to perform work.

The processor 41 causes the unmanned aerial vehicle 10 that has released support of the implement 200a to fly to the position of the target package 330 indicated by the package position information. The target package 330 is, for example, the container 232 (FIGS. 18A-18D). The unmanned aerial vehicle 10 that has reached above the container 232 can support the container 232 by the method described using FIGS. 18A-18C. The processor 41 causes the unmanned aerial vehicle 10 supporting the container 232 to fly toward the transport destination storage facility 78 or its surrounding area (step S405). When the unmanned aerial vehicle 10 arrives at the storage facility 78 or its surrounding area, the harvested crops are transferred to the storage facility 78.

In this way, by causing an unmanned aerial vehicle 10 supporting the implement 200a to separate the implement 200a and perform transport of harvested crops, efficient transport of harvested crops can be achieved. By using an unmanned aerial vehicle 10 from which the implement 200a has been separated, the weight of packages 330 that the unmanned aerial vehicle 10 can transport can be increased.

In the processing of step S403 described above, the processor 41 may determine whether it is possible to cause the unmanned aerial vehicle 10 to release support of the implement 200a and transport the package 330 based on the degree of progress of the work of the implement 200a. For example, when the degree of progress of the work of the implement 200a is relatively low, by continuing to have the unmanned aerial vehicle 10 support the implement 200a that is performing work, the work of the implement 200a can be performed appropriately. When the degree of progress of the work of the implement 200a is relatively high, the unmanned aerial vehicle 10 is caused to release support of the implement 200a and transport the package 330.

Also, by comparing the deadline for work of the implement 200a set in the work plan with the deadline for transport of the package 330, it may be determined whether it is possible to cause the unmanned aerial vehicle 10 to release support of the implement 200a and transport the package 330. For example, when there is margin until the deadline for work of the implement 200a and the deadline for transport of the package 330 is approaching, the unmanned aerial vehicle 10 may be caused to release support of the implement 200a and transport the package 330.

Also, in the processing of step S403 described above, after determining whether the package 330 can be transported according to the state of the implement 200a, it may be further determined whether the package 330 can be transported based on the weight of the package 330 and/or the remaining amount of energy sources of the unmanned aerial vehicle 10. In this case, the processor 41 determines whether the unmanned aerial vehicle 10 can transport the package 330 to the transport destination position based on the package weight information. Also, the processor 41 determines whether the unmanned aerial vehicle 10 can transport the package 330 to the transport destination position based on the remaining amount of energy sources. For example, the processor 41 can determine whether the package 330 can be transported by performing processing similar to that described using FIG. 25.

Also, the support of the implement 200a may be released when the unmanned aerial vehicle 10 transporting the implement 200a reaches its destination, without determining whether the package 330 can be transported according to the state of the implement 200a. For example, when it is not necessary for the unmanned aerial vehicle 10 to support the implement 200a that is performing work, the support of the implement 200a may be released when the destination is reached, the unmanned aerial vehicle 10 may be flown to the position of the package 330, and the package 330 may be supported.

The processing to determine whether the package 330 can be transported described above may be performed by the processor 660 of the management device 600 and/or the processor 460 of the terminal device 400. Also, the various processes described above may be performed cooperatively by at least two of the processor 41, the processor 660, and the processor 460.

The systems that perform the various processes described above can also be retrofitted to unmanned aerial vehicles and/or agricultural machines that do not have these functions. Such systems can be manufactured and sold independently of unmanned aerial vehicles and agricultural machines. Computer programs used in such systems can also be manufactured and sold independently of unmanned aerial vehicles and agricultural machines. Computer programs may be provided stored on non-transitory computer-readable storage media, for example. Computer programs may also be provided by download via telecommunication lines (such as the Internet).

According to an example embodiment of the present disclosure, an unmanned aerial vehicle acquires harvested crops that an agricultural machine has harvested. The unmanned aerial vehicle acquires harvested crops from the agricultural machine, for example, without landing on the ground. Also, for example, the unmanned aerial vehicle acquires harvested crops from a position above the agricultural machine. Since there is no need to secure a ground surface for running a transport vehicle in parallel with the agricultural machine, crop harvesting can be performed easily and efficiently.

According to an example embodiment of the present disclosure, an unmanned aerial vehicle acquires harvested crops that an agricultural machine has harvested. The unmanned aerial vehicle acquires harvested crops from the agricultural machine, for example, without landing on the ground. Also, for example, the unmanned aerial vehicle acquires harvested crops from a position above the agricultural machine. Since there is no need to secure a ground surface for running a transport vehicle in parallel with the agricultural machine, crop harvesting can be performed easily and efficiently.

According to an example embodiment of the present disclosure, an unmanned aerial vehicle acquires harvested crops that an agricultural machine has harvested. The unmanned aerial vehicle acquires harvested crops from the agricultural machine, for example, without landing on the ground. Also, for example, the unmanned aerial vehicle acquires harvested crops from a position above the agricultural machine. Since there is no need to secure a ground surface for running a transport vehicle in parallel with the agricultural machine, crop harvesting can be performed easily and efficiently.

The technologies of example embodiments of the present disclosure are particularly useful in the agricultural field using unmanned aerial vehicles.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An unmanned aerial vehicle that transports harvested crops harvested from a field, the unmanned aerial vehicle comprising:
a flight device to cause the unmanned aerial vehicle to fly;
a controller configured or programmed to control operation of the flight device;
a communication device to receive package position information indicating a first position where a target package for transport containing the harvested crops is located, and package weight information indicating a weight of the target package; and
a support device capable of supporting the target package; wherein the controller is configured or programmed to:
determine, based on the package weight information, whether the target package can be transported to a second position different from the first position; and
when determining that the target package can be transported, control the flight device to cause the unmanned aerial vehicle to fly to the first position;
cause the support device to support the target package; and
control the flight device to cause the unmanned aerial vehicle to fly to the second position.

2. The unmanned aerial vehicle according to claim 1, wherein the controller is configured or programmed to:
determine that the target package can be transported when a weight value of packages that can be additionally loaded obtained from availability status regarding payload is equal to or greater than a weight value indicated by the package weight information; and
determine that the target package cannot be transported when the weight value of packages that can be additionally loaded is less than the weight value indicated by the package weight information.

3. The unmanned aerial vehicle according to claim 1, wherein the controller is configured or programmed to:
determine that the target package can be transported when a total value of weights of one or more packages that the unmanned aerial vehicle will support when supporting the target package is equal to or less than a predetermined weight value; and
determine that the target package cannot be transported when the total value of the weights exceeds the predetermined weight value.

4. The unmanned aerial vehicle according to claim 3, wherein when the unmanned aerial vehicle is already supporting one or more other packages different from the target package, the controller is configured or programmed to:
determine that the target package can be transported when a total value of the weight value indicated by the package weight information and weight values of the one or more other packages is equal to or less than the predetermined weight value; and
determine that the target package cannot be transported when the total value of the weight value indicated by the package weight information and the weight values of the one or more other packages exceeds the predetermined weight value.

5. The unmanned aerial vehicle according to claim 1, wherein the controller is configured or programmed to further determine whether the target package can be transported to the second position based on a remaining amount of energy sources used for flight of the unmanned aerial vehicle.

6. The unmanned aerial vehicle according to claim 5, wherein the controller is configured or programmed to:
calculate a remaining amount of the energy sources when the unmanned aerial vehicle supporting the target package reaches the second position, assuming that the unmanned aerial vehicle transports the target package; and
determine that the target package can be transported when the calculated remaining amount of the energy sources is greater than a predetermined value; and
determine that the target package cannot be transported when the calculated remaining amount of the energy sources is equal to or less than the predetermined value.

7. The unmanned aerial vehicle according to claim 6, wherein the controller is configured or programmed to:
calculate a first energy consumption when the unmanned aerial vehicle is flown from a current location to the first position, and a second energy consumption when the unmanned aerial vehicle supporting the target package is flown from the first position to the second position; and
calculate the remaining amount of the energy sources when the unmanned aerial vehicle supporting the target package reaches the second position based on the first energy consumption and the second energy consumption.

8. The unmanned aerial vehicle according to claim 1, wherein the controller is configured or programmed to output information indicating a determination result of whether the target package can be transported to the outside using the communication device.

9. A management system that determines an unmanned aerial vehicle that transports harvested crops harvested from a field from among multiple unmanned aerial vehicles, the management system comprising:
a communication device to receive package position information indicating a first position where a target package for transport containing the harvested crops is located, package weight information indicating a weight of the target package, and availability information indicating availability status regarding payload of each of the multiple unmanned aerial vehicles; and
a processor configured or programmed to determine a transport unmanned aerial vehicle that transports the target package to a second position different from the first position from among the multiple unmanned aerial vehicles based on the package weight information and the availability information; wherein the processor is configured or programmed to output an instruction to transport the target package to the determined transport unmanned aerial vehicle using the communication device.

10. The management system according to claim 9, wherein the processor is configured or programmed to determine, as the transport unmanned aerial vehicle, an unmanned aerial vehicle whose weight value of packages that can be additionally loaded obtained from the availability information is equal to or greater than a weight value indicated by the package weight information.

11. The management system according to claim 9, wherein the processor is configured or programmed to further determine the transport unmanned aerial vehicle from among the multiple unmanned aerial vehicles based on remaining amounts of energy sources used for flight of each of the multiple unmanned aerial vehicles.

12. The management system according to claim 11, wherein the processor is configured or programmed to:
calculate, for each of the multiple unmanned aerial vehicles, a remaining amount of the energy sources when the unmanned aerial vehicle flies to the second position while supporting the target package;
determines, as the transport unmanned aerial vehicle, an unmanned aerial vehicle whose calculated remaining amount of the energy sources is greater than a predetermined value;
does not determine, as the transport unmanned aerial vehicle, an unmanned aerial vehicle whose calculated remaining amount of the energy sources is equal to or less than the predetermined value.

13. The management system according to claim 12, wherein the processor is configured or programmed to:
calculate, for each of the multiple unmanned aerial vehicles, a first energy consumption when the unmanned aerial vehicle is flown from a current location to the first position, and a second energy consumption when the unmanned aerial vehicle is flown from the first position to the second position while supporting the target package; and
calculate the remaining amount of the energy sources when the unmanned aerial vehicle flies to the second position while supporting the target package based on the first energy consumption and the second energy consumption.

14. A package system that packages harvested crops harvested from a field, the package system comprising:
a packaging device to package the harvested crops; and
a controller configured or programmed to control operation of the packaging device; wherein
the controller is configured or programmed to change a weight or a number of packages of the harvested crops created by the packaging device based on a transport capability of an unmanned aerial vehicle that transports the packages of the harvested crops.

15. The package system according to claim 14, wherein the controller is configured or programmed to change the weight or the number of the packages created by the packaging device based on at least one of an availability status regarding payload of the unmanned aerial vehicle and a remaining amount of energy sources used for flight of the unmanned aerial vehicle.

16. The package system according to claim 14, wherein the controller is configured or programmed to perform control to move the package to a position where the unmanned aerial vehicle can acquire the package.
